(19) United States
(12) Patent Application Publication
(10) Pub. No.: US 2025/0274180 A1
(43) Pub. Date: Aug. 28, 2025

(54) METHOD AND APPARATUS FOR MEASURING AND REPORTING CSI FOR BEAM OPERATION IN WIRELESS COMMUNICATION SYSTEM

(71) Applicant: SAMSUNG ELECTRONICS CO., LTD., Suwon-si, Gyeonggi-do (KR)

(72) Inventors: Yeongeun LIM, Suwon-si (KR); Kyoungmin PARK, Suwon-si (KR); Hyoungju JI, Suwon-si (KR); Younsun KIM, Suwon-si (KR); Junyung YI, Suwon-si (KR); Kyungjun CHOI, Suwon-si (KR)

(21) Appl. No.: 18/863,927

(22) PCT Filed: May 9, 2023
(86) PCT No.: PCT/KR2023/006258

§ 371 Date: Nov. 7, 2024

(30) Foreign Application Priority Data
May 9, 2022 (KR) 10-2022-0056801
Jun. 2, 2022 (KR) 10-2022-0067791

(51) Int. Cl. H04B 7/06; H04W 24/10; H04W 72/23

(52) U.S. Cl. CPC H04B 7/0626; H04B 7/06968; H04W 24/10; H04W 72/23

(57) ABSTRACT

The present disclosure relates to a 5G or 6G communication system for supporting higher data transmission rates. A method performed by a terminal of a communication system according to one embodiment of the present invention may comprise the steps of: receiving, from a base station, periodic channel state information reference signal (CSI-RS) configuration information including IDs of N CSI-RSs; determining a beam set for beam measurement and reporting as a first beam set on the basis of the periodic CSI-RS configuration information; receiving, from the base station, information indicating a change in at least a part of the beam set for the beam measurement and reporting; determining the beam set for beam measurement and reporting as a second beam set on the basis of the information indicating a change in at least a part of the beam set; and receiving a physical downlink shared channel (PDSCH) from the base station on the basis of measurement and reporting based on the second beam set.

### TECHNICAL FIELD

The disclosure relates to a method and apparatus for CSI measurement and reporting for beam operation in a wireless communication system.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service.

Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE OF INVENTION

### Technical Problem

The disclosure relates to a method and apparatus for measuring and reporting channel state information (CSI) for beam operation in a wireless communication system. The disclosure aims to provide a method that enables a terminal to receive a CSI reference signal (CSI-RS) and report measured CSI in a wireless communication system. According to the disclosure, even if the amount of CSI-RS for beam operation in a wireless communication system is reduced, beam operation comparable to that of an existing system where the amount of CSI-RS is not reduced may be achieved.

### Solution to Problem

In order to achieve the aforementioned technical objectives, a method of a terminal in a communication system according to an embodiment of the disclosure may include: receiving periodic channel state information reference signal (CSI-RS) configuration information including IDs of N CSI-RSs from a base station; determining a beam set for beam measurement and reporting as a first beam set based on the periodic CSI-RS configuration information; receiving, from the base station, information indicating a change in at least a part of the beam set for beam measurement and reporting; determining the beam set for beam measurement and reporting as a second beam set based on the information indicating a change in at least a part of the beam set; and receiving a physical downlink shared channel (PDSCH) from the base station according to beam measurement and reporting based on the second beam set.

In addition, a method of a base station in a communication system according to an embodiment of the disclosure may include: determining a beam set for beam measurement and reporting as a first beam set; transmitting, to a terminal, periodic channel state information reference signal (CSI-RS) configuration information including IDs of N CSI-RSs associated with the first beam set; determining the beam set for beam measurement and reporting as a second beam set; transmitting, to the terminal, information indicating a change in at least a part of the beam set for beam measurement and reporting; and transmitting a physical downlink shared channel (PDSCH) to the terminal according to beam measurement and reporting based on the second beam set.

In addition, a terminal in a communication system according to an embodiment of the disclosure may include: a transceiver; and a controller that is configured to: receive periodic channel state information reference signal (CSI-RS) configuration information including IDs of N CSI-RSs from a base station; determine a beam set for beam measurement and reporting as a first beam set based on the periodic CSI-RS configuration information; receive, from the base station, information indicating a change in at least a part of the beam set for beam measurement and reporting; determine the beam set for beam measurement and reporting as a second beam set based on the information indicating a change in at least a part of the beam set; and receive a physical downlink shared channel (PDSCH) from the base station according to beam measurement and reporting based on the second beam set.

In addition, a base station in a communication system according to an embodiment of the disclosure may include: a transceiver; and a controller that is configured to: determine a beam set for beam measurement and reporting as a first beam set; transmit, to a terminal, periodic channel state information reference signal (CSI-RS) configuration information including IDs of N CSI-RSs associated with the first beam set; determine the beam set for beam measurement and reporting as a second beam set; transmit, to the terminal, information indicating a change in at least a part of the beam set for beam measurement and reporting; and transmit a physical downlink shared channel (PDSCH) to the terminal according to beam measurement and reporting based on the second beam set.

### Advantageous Effects of Invention

According to the disclosure, it is possible to reduce the amount of CSI-RS required for a beam operation scheme providing high beamforming gain in a wireless communication system while maintaining high-quality beam reception sensitivity, thereby increasing the data transmission rate and providing a highly reliable service.

### BRIEF DESCRIPTION OF DRAWINGS

FIG. 1 is a diagram illustrating the basic structure of the time-frequency domain, which is a radio resource region in which data or control channels are transmitted in a 5G wireless communication system.

FIG. 2 is a diagram illustrating an example of a slot structure used in a 5G wireless communication system.

FIG. 3 is a diagram illustrating an example of configuring a bandwidth part (BWP) in a 5G wireless communication system.

FIG. 4 is a diagram illustrating an example of a control resource set in which a downlink control channel is transmitted in a 5G wireless communication system.

FIG. 5 is a diagram illustrating the structure of a downlink control channel in a 5G wireless communication system.

FIG. 6 is a diagram illustrating an example of a scheme for configuring uplink and downlink resources in a 5G wireless communication system.

FIG. 7 is a diagram illustrating an example of base station beam assignment based on TCI state configuration in a wireless communication system according to an embodiment of the disclosure.

FIG. 8 is a diagram illustrating an example of TCI state assignment for the PDCCH in a wireless communication system according to an embodiment of the disclosure.

FIG. 9 is a diagram illustrating a TCI indication MAC CE signaling format for the PDCCH DMRS.

FIG. 10 is a diagram illustrating an example of beam configuration of a control resource set (CORESET) and a search space according to the above description.

FIG. 11 is a diagram for describing a method for a UE to select a control resource set that may be received in consideration of the priority when receiving a downlink control channel in a wireless communication system according to an embodiment of the disclosure.

FIG. 12 is a diagram illustrating an example of frequency domain resource assignment for a physical downlink shared channel (PDSCH) in a wireless communication system according to an embodiment of the disclosure.

FIG. 13 illustrates a process for beam configuration and activation for the PDSCH.

FIG. 14 illustrates an example of PUSCH repetition type B according to an embodiment of the disclosure.

FIG. 15 is a diagram illustrating an example of aperiodic channel state reporting according to an embodiment of the disclosure.

FIG. 16 is a diagram illustrating an example of aperiodic channel state reporting according to an embodiment of the disclosure.

FIG. 17 illustrates an example of a method for configuring a beam set of beam measurement and reporting for beam prediction according to an embodiment of the disclosure.

FIG. 18 is a flowchart of updating QCL of CSI-RS of the beam set of beam measurement and reporting for beam prediction with transmission configuration indication of the DCI according to an embodiment of the disclosure.

FIG. 19 illustrates a method for updating QCL of CSI-RS of the beam set of beam measurement and reporting for beam prediction with MAC CE according to an embodiment of the disclosure.

FIG. 20 is a block diagram illustrating the structure of a UE according to an embodiment of the disclosure.

FIG. 21 is a block diagram illustrating the structure of a base station according to an embodiment of the disclosure.

### MODE FOR THE INVENTION

Hereinafter, embodiments of the disclosure will be described in detail with reference to the accompanying drawings.

In describing the embodiments, descriptions of technical content that is well known in the art to which this disclosure belongs and is not directly related to this disclosure will be omitted. This is to convey the subject matter of the disclosure more clearly without obscuring it by omitting unnecessary explanation.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts. In addition, when describing the disclosure, if it is determined that a detailed description of a related function or configuration may unnecessarily obscure the gist of the disclosure, the detailed description will be omitted. In addition, the terms described below are defined in consideration of their functions in the disclosure, and these may vary depending on the intention of the user, the operator, or the custom. Hence, their meanings should be determined based on the overall contents of this specification.

In the following description, the base station (BS) is a main agent that performs resource allocation for terminals and may be at least one of gNode B, eNode B, Node B, wireless access unit, base station controller, or node on a network. The terminal may include a user equipment (UE), mobile station (MS), cellular phone, smartphone, computer, or multimedia system capable of performing communication functions. In the disclosure, downlink (DL) refers to a radio transmission path of a signal transmitted from a base station to a terminal, and uplink (UL) refers to a radio transmission path of a signal transmitted from a terminal to a base station. In addition, although the LTE, LTE-A or 5G system may be described below as an example, embodiments of the disclosure may also be applied to other communication systems with similar technical background or channel configurations. For example, this may include the 5th generation mobile communication technology (5G, new radio, NR) developed after LTE-A, and the term 5G below may be a concept including the existing LTE, LTE-A, and other similar services. In addition, this disclosure may be applied to other communication systems through some modifications without significantly departing from the scope of the disclosure at the discretion of a person skilled in technical knowledge.

Meanwhile, it is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

In addition, a block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order.

In the description, the word “unit”, “module”, or the like may refer to a software component or hardware component such as an FPGA or ASIC capable of carrying out a function or an operation. However, “unit” or the like is not limited to hardware or software. A unit or the like may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose large components and units. Components and units may be configured to drive a device or one or more processors in a secure multimedia card. Also, in a certain embodiment, a module or unit may include one or more processors.

Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends a data or control signal to a base station (BS or gNode B), and the downlink refers to a radio link through which a base station sends a data or control signal to a terminal. In such a multiple access scheme, time-frequency resources used to carry user data or control information are allocated so as not to overlap each other (i.e., maintain orthogonality) to thereby identify the data or control information of a specific user.

As a future communication system after LTE, that is, the 5G communication system must be able to freely reflect various requirements of users and service providers and need to support services satisfying various requirements. Services being considered for the 5G communication system include enhanced mobile broadband (eMBB), massive machine type communication (mMTC), and ultra-reliable and low-latency communication (URLLC).

eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. At the same time, the 5G communication system has to provide an increased user perceived data rate for the terminal. To meet such requirements in the 5G communication system, it is required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a transmission bandwidth of up to 20 MHz in a band of 2 GHz used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km²) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time such as 10 to 15 years may be required.

Finally, URLLC is a cellular-based wireless communication service used for a specific purpose (mission-critical). For example, it may consider services usable for remote control of robots or machinery, industrial automation, unmanned aerial vehicles, remote health care, and emergency alert. Hence, the communication provided by URLLC must provide very low latency and very high reliability. For example, a URLLC service has to support both an air interface latency of less than 0.5 ms and a packet error rate of 75 or less as a requirement. Hence, for a service supporting URLLC, the 5G system must provide a transmission time interval (TTI) shorter than that of other services, and at the same time, a design requirement for allocating a wide resource in a frequency band may be required.

The above three 5G services (i.e., eMBB, URLLC, and mMTC) can be multiplexed and transmitted in one system. Here, to satisfy different requirements of the services, different transmission and reception techniques and parameters can be used between services. However, 5G is not limited to the three services mentioned above.

### [NR Time-Frequency Resources]

Next, the frame structure of a 5G system will be described in more detail with reference to the drawing.

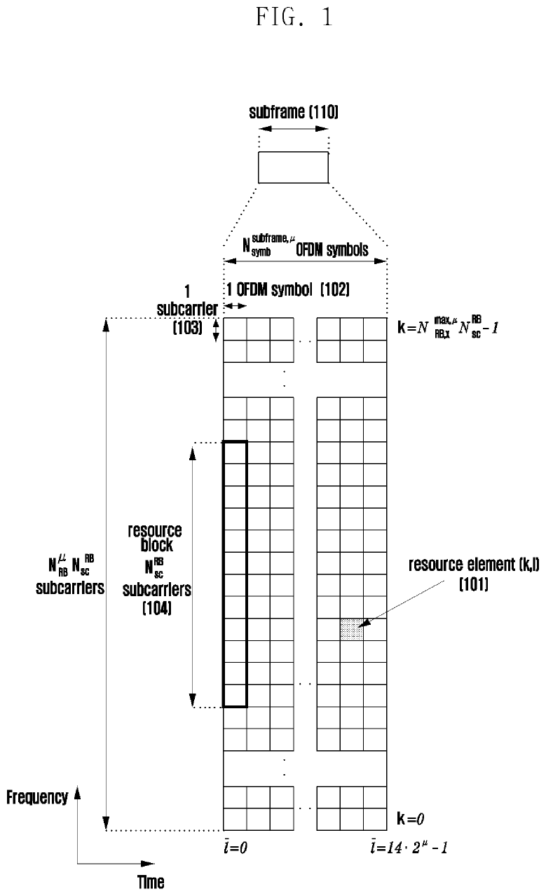

FIG. 1 is a diagram illustrating the basic structure of the time-frequency domain, which is a radio resource region in which data or control channels are transmitted in a 5G wireless communication system.

In FIG. 1, the horizontal axis represents the time domain and the vertical axis represents the frequency domain. The basic unit of resources in the time-frequency domain is a resource element (RE) 101, which may be defined as 1 OFDM (orthogonal frequency division multiplexing) symbol 102 in the time domain and 1 subcarrier 103 in the frequency domain. In the frequency domain, N_{sc}^{RB} (e.g., 12) consecutive REs may constitute one resource block (RB) 104.

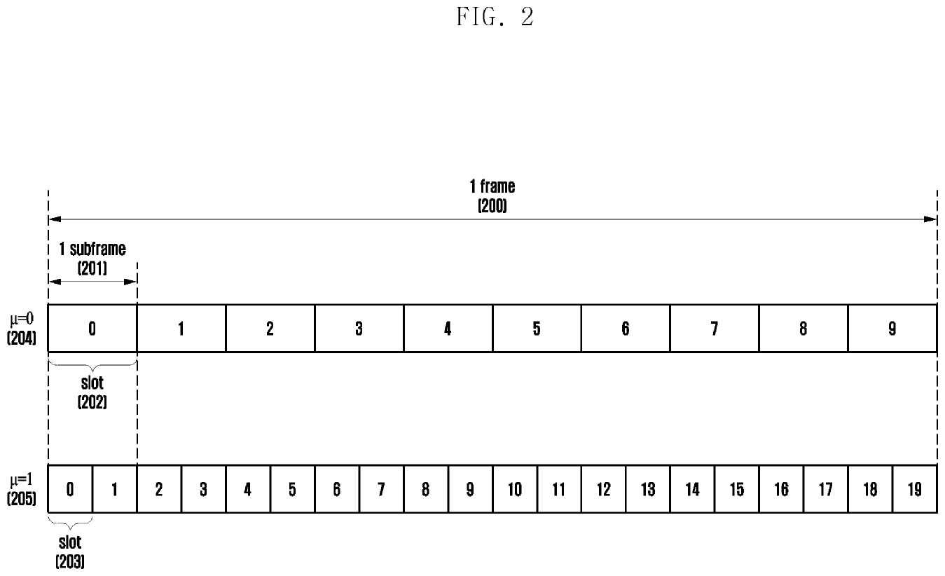

FIG. 2 is a diagram illustrating an example of a slot structure used in a 5G wireless communication system.

In FIG. 2, an example structure of a frame 200, a subframe 201, and a slot 202 is shown. One frame 200 may be defined to be 10 ms. One subframe 201 may be defined to be 1 ms, and thus one frame 200 may be composed of a total of 10 subframes 201. One slot 202 or 203 may be defined to be 14 OFDM symbols (i.e., the number of symbols per slot (N_{symb}^{slot})=14). One subframe 201 may be composed of one or multiple slots 202 or 203, and the number of slots 202 or 203 per subframe 201 may vary according to a configuration value μ (204 or 205) for the subcarrier spacing. In an example of FIG. 2, a case where μ=0 (204) and a case where μ=1 (205) are shown as a subcarrier spacing configuration value. When μ=0 (204), 1 subframe 201 may be composed of 1 slot 202, and when μ=1 (205), 1 subframe 201 may be composed of 2 slots 203. That is, according to the configuration value u for the subcarrier spacing, the number of slots per subframe (Nₛₗₒₜ^{subframe,μ}) may vary, and the number of slots per frame (Nₛₗₒₜ^{frame,μ}) may vary accordingly. According to each configuration value u for the subcarrier spacing, Nₛₗₒₜ^{subframe,μ} and Nₛₗₒₜ^{frame,μ} may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, the bandwidth part (BWP) configuration in a 5G communication system will be described in detail with reference to the drawing.

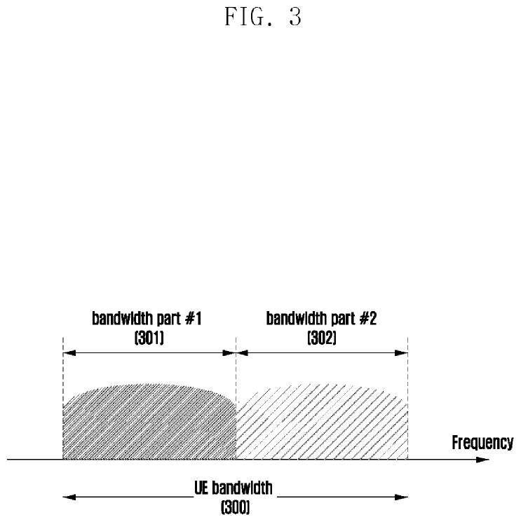

FIG. 3 is a diagram illustrating an example of configuring a bandwidth part (BWP) in a 5G wireless communication system.

In FIG. 3, an example is shown in which the UE bandwidth 300 is configured as two bandwidth parts, that is, bandwidth part #1 (BWP #1) 301 and bandwidth part #2 (BWP #2) 302. The base station may configure one or more bandwidth parts to the UE, and the following information may be set for each bandwidth part.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, n2, n3, n4, n5}, |
| cyclicPrefix | ENUMERATED { extended } |
| } | |

Without being limited to the above example, various parameters related to the bandwidth part can be configured to the UE in addition to the above configuration information. The configuration information may be transmitted from the base station to the UE through higher layer signaling, for example, radio resource control (RRC) signaling. Among one or more configured bandwidth parts, at least one bandwidth part may be activated. Whether a configured bandwidth part is activated may be transmitted from the base station to the UE semi-statically through RRC signaling or dynamically through downlink control information (DCI).

According to an embodiment, before being radio resource control (RRC) connected, a UE may be configured by the base station with an initial bandwidth part (initial BWP) for initial connection through a master information block (MIB). To be more specific, in the initial connection stage, the UE may receive, through the MIB, configuration information about a control resource set (CORESET) and search space through which a physical downlink control channel (PDCCH) for receiving system information required for initial connection (remaining system information (RMSI) or system information block 1 (SIB1) can be transmitted. The control resource set and search space configured through the MIB may each be regarded as having an identity (ID) of 0. The base station may notify the UE of configuration information such as frequency assignment information, time assignment information, and numerology for control resource set #0 through the MIB. Additionally, the base station may notify the UE of configuration information about the monitoring periodicity and occasion for control resource set #0, that is, configuration information about search space #0, through the MIB. The UE may regard the frequency domain set as control resource set #0 obtained from the MIB as the initial bandwidth part for initial connection. At this time, the identity (ID) of the initial bandwidth part may be regarded as 0.

The configuration for the bandwidth part supported by the 5G wireless communication system may be used for various purposes.

According to an embodiment, the configuration for the bandwidth part may be used when the bandwidth supported by the UE is smaller than the system bandwidth. For example, the base station may configure the frequency location of a bandwidth part (configuration information 2) to the UE, allowing the UE to transmit and receive data at a specific frequency location within the system bandwidth.

Additionally, according to an embodiment, the base station may configure a plurality of bandwidth parts to the UE for the purpose of supporting different numerologies. For example, to support data transmission and reception using both a subcarrier spacing of 15 kHz and a subcarrier spacing of 30 kHz for a UE, the base station may configure two bandwidth parts with subcarrier spacings of 15 kHz and 30 kHz, respectively. Different bandwidth parts may be frequency division multiplexed, and when the base station intends to transmit and receive data at a specific subcarrier spacing, the bandwidth part configured with the corresponding subcarrier spacing may be activated.

Additionally, according to an embodiment, for the purpose of reducing power consumption of a UE, the base station may configure bandwidth parts with different bandwidth sizes to the UE. For example, if a UE supports a very large bandwidth, for example, a bandwidth of 100 MHz, and always transmits and receives data through that bandwidth, very large power consumption may occur. In particular, monitoring unnecessarily a downlink control channel with a large bandwidth of 100 MHz in a situation where there is no traffic can be very inefficient in terms of power consumption. For the purpose of reducing the power consumption of the UE, the base station may configure a relatively small bandwidth part, for example, a bandwidth part of 20 MHz, to the UE. The UE may perform monitoring operations on the 20 MHz bandwidth part in a situation where there is no traffic, and may, when data is generated, transmit and receive data in the 100 MHz bandwidth part according to the instruction of the base station.

In a method of configuring the bandwidth part, a terminal before being RRC connected may receive configuration information for an initial bandwidth part through a master information block (MIB) in the initial connection stage. To be more specific, through the MIB of the physical broadcast channel (PBCH), the UE may be configured with a control resource set (CORESET) for the downlink control channel through which downlink control information (DCI) scheduling the system information block (SIB) can be transmitted. The bandwidth of the control resource set configured through the MIB may be considered as the initial bandwidth part, and through the configured initial bandwidth part, the UE may receive the physical downlink shared channel (PDSCH) on which the SIB is transmitted. In addition to receiving the SIB, the initial bandwidth part may also be used for other system information (OSI), paging, and random access.

### [Bandwidth Part (BWP) Switching]

When one or more bandwidth parts are configured to the UE, the base station may instruct the UE to change the bandwidth part by using a bandwidth part indicator field in the DCI. As an example, in FIG. 3, if the currently activated bandwidth part of the UE is bandwidth part #1 (301), the base station may indicate bandwidth part #2 (302) to the UE by using a bandwidth part indicator in the DCI, and the UE may switch the bandwidth part to bandwidth part #2 (302) indicated by the bandwidth part indicator in the received DCI.

As described above, since DCI-based bandwidth part switching can be indicated by the DCI scheduling the PDSCH or PUSCH, when a UE receives a bandwidth part switch request, it must be able to receive or transmit the PDSCH or PUSCH scheduled by the corresponding DCI without difficulty in the switched bandwidth part. To this end, the standard stipulates requirements for the delay time (T_{BWP}) required when switching the bandwidth part, and may be defined as follows, for example.

TABLE 3

| NR | |
|---|---|
| Slot | |
| length | BWP switch delay T_{BWP} (slots) |

| μ | (ms) | Type 1^{Note 1} | Type 2^{Note 1} |
|---|---|---|---|
| 0 | 1 | [1] | [3] |
| 1 | 0.5 | [2] | [5] |
| 2 | 0.25 | [3] | [9] |
| 3 | 0.125 | [6] | [17] |

^{Note 1}
Depends on UE capability.
Note 2:
If the BWP switch involves changing of SCS, the BWP switch delay is determined by the larger one between the SCS before BWP switch and the SCS after BWP switch.

Requirements for the bandwidth part switch delay time may support type 1 or type 2 depending on the UE's capability. The UE may report the supported bandwidth part delay time type to the base station.

According to the requirements for the bandwidth part switch delay time described above, when the UE receives a DCI including a bandwidth part switch indicator in slot n, the UE may complete switching to the new bandwidth part indicated by the bandwidth part switch indicator no later than slot n+T_{BWP}, and may perform transmission and reception on the data channel scheduled by the corresponding DCI in the newly switched bandwidth part. When the base station intends to schedule a data channel with a new bandwidth part, it may determine time domain resource assignment for the data channel by taking into consideration the bandwidth part switch delay time (T_{BWP}) of the UE. That is, when scheduling a data channel with a new bandwidth part, the base station can schedule the data channel after the bandwidth part switch delay time in determining time domain resource assignment for the data channel. Accordingly, the UE may not expect that the DCI indicating bandwidth part switching indicates a slot offset (K0 or K2) value that is smaller than the bandwidth part switch delay time (T_{BWP}).

If the UE receives a DCI (e.g., DCI format 1_1 or 0_1) indicating bandwidth part switching, the UE may not perform any transmission or reception during a time interval ranging from the third symbol of the slot in which the PDCCH containing the corresponding DCI is received to the start point of the slot indicated by a slot offset (K0 or K2) value indicated by the time domain resource assignment indicator field in the corresponding DCI. For example, if the UE receives a DCI indicating bandwidth part switching in slot n, and the slot offset value indicated by the DCI is K, the UE may not perform any transmission or reception during a time interval ranging from the third symbol of slot n to the symbol before slot n+K (i.e., last symbol of slot n+K−1).

### [SS/PBCH Block]

Next, a description will be given of the synchronization signal (SS)/PBCH block in the 5G wireless communication system.

The SS/PBCH block may indicate a physical layer channel block including a primary SS (PSS), a secondary SS (SSS), and a PBCH. The details may be as follows.
PSS: PSS is a signal that serves as a reference for downlink time/frequency synchronization and provides some information of cell ID.
SSS: SSS serves as a reference for downlink time/frequency synchronization and provides remaining cell ID information not provided by PSS. Additionally, it may serve as a reference signal (RS) for demodulation of the PBCH.
PBCH: PBCH provides essential system information required for transmission and reception of a data channel and control channel of the UE. The essential system information may include search space-related control information indicating radio resource mapping information of a control channel, scheduling control information of a separate data channel for transmitting system information, and the like.
SS/PBCH block: the SS/PBCH block is composed of a combination of PSS, SSS, and PBCH. One or multiple SS/PBCH blocks may be transmitted within 5 ms, and individual SS/PBCH blocks being transmitted may be distinguished by an index.

The UE may detect the PSS and SSS in the initial connection stage, and may decode the PBCH. The UE may obtain the MIB from the PBCH, and may be configured with control resource set (CORESET) #0 (which may correspond to a control resource set having a control resource set index of 0) therefrom. The UE may assume that a selected SS/PBCH block and a demodulation reference signal (DMRS) transmitted in control resource set #0 are in a quasi-colocated (QCL) relationship, and may perform monitoring of control resource set #0. The UE may obtain system information through downlink control information transmitted in control resource set #0. The UE may obtain random access channel (RACH)-related configuration information required for initial connection from the received system information. The UE may transmit a physical RACH (PRACH) to the base station in consideration of the selected SS/PBCH block index, and the base station having received the PRACH may obtain information about the SS/PBCH block index selected by the UE. The base station may know that the UE has selected a specific block among individual SS/PBCH blocks and monitors control resource set #0 related thereto.

### [PDCCH: DCI-Related]

Next, the downlink control information (DCI) in the 5G wireless communication system will be described in detail.

In the 5G system, scheduling information regarding uplink data (or, physical uplink shared channel (PUSCH)) or downlink data (or, physical downlink shared channel (PDSCH)) may be delivered from the base station to the UE through DCI. The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), which is a physical downlink control channel, through a channel coding and modulation process. A cyclic redundancy check (CRC) is attached to the payload of a DCI message, and the CRC may be scrambled with a radio network temporary identifier (RNTI) corresponding to the identity of the UE. Different RNTIs may be used according to the purpose of the DCI message, for example, UE-specific data transmission, power control command, or random access response. That is, the RNTI is not explicitly transmitted, but is transmitted by being included in the CRC calculation process. Upon receiving a DCI message transmitted over the PDCCH, the UE may perform a CRC check by using the assigned RNTI, and if the CRC check result is correct, the UE may know that the corresponding message has been transmitted to it.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with C-RNTI (cell RNTI), MCS-C-RNTI (modulation coding scheme C-RNTI), or CS-RNTI (configured scheduling RNTI). DCI format 0_0 may be used as fallback DCI for scheduling a PUSCH, where the CRC may be scrambled with a C-RNTI. DCI format 0_0 having a CRC scrambled with a C-RNTI may include, for example, the following information.

```
TABLE 4
  Identifier for DCI formats - 1 bit
      The value of this bit field is always set to 0, indicating an UL DCI format
    Frequency domain resource assignment - ┌log₂(N_{RB}^{UL, BWP}(N_{RB}^{UL, BWP} + 1)/2)┐ bits where
    N_{RB}^{UL, BWP} is defined in subclause 7.3.1.0
      For PUSCH hopping with resource allocation type 1:
        N_{UL} [symbol]  MSB bits are used to indicate the frequency offset according to Subclause
        6.3 of [6, TS 38.214], where N_{UL} [symbol]  = 1 if the higher layer parameter
        frequencyHoppingOffsetLists contains two offset values and N_{UL} [symbol]  = 2 if the higher
        layer parameter frequencyHoppingOffsetLists contains four offset values
        ┌log₂(N_{RB}^{UL, BWP}(N_{RB}^{UL, BWP} + 1)/2)┐ − N_{UL} [symbol]  bits provides the frequency domain resource
        allocation according to Subclause 6.1.2.2.2 of [6, TS 38.214]
      For non-PUSCH hopping with resource allocation type 1:
        ┌log₂(N_{RB}^{UL, BWP}(N_{RB}^{UL, BWP} + 1)/2)┐ bits provides the frequency domain resource allocation
        according to Subclause 6.1.2.2.2 of [6, TS 38.214]
    Time domain resource assignment - 4 bits as defined in Subclause 6.1.2.1 of [6, TS
    38.214]
    Frequency hopping flag - 1 bit according to Table 7.3.1.1.1-3, as defined in Subclause 6.3
    of [6, TS 38.214]
    Modulation and coding scheme - 5 bits as defined in Subclause 6.1.4.1 of [6, TS 38.214]
    New data indicator - 1 bit
Redundancy version - 2 bits as defined in Table 7.3.1.1.1-2
HARQ process number - 4 bits
TPC command for scheduled PUSCH - 2 bits as defined in Subclause 7.1.1 of [5, TS
38.213]
Padding bits, if required.
UL/SUL indicator - 1 bit for UEs configured with supplementaryUplink in
ServingCellConfig in the cell as defined in Table 7.3.1.1.1-1 and the number of bits for
DCI format 1_0 before padding is larger than the number of bits for DCI format 0_0
before padding: 0 bit otherwise. The UL/SUL indicator, if present, locates in the last bit
position of DCI format 0_0, after the padding bit(s).
  If the UL/SUL indicator is present in DCI format 0_0 and the higher layer parameter
  pusch-Config is not configured on both UL and SUL the UE ignores the UL/SUL
  indicator field in DCI format 0_0, and the corresponding PUSCH scheduled by the DCI
  format 0_0 is for the UL or SUL for which high layer parameter pucch-Config is
  configured;
  If the UL/SUL indicator is not present in DCI format 0_0 and pucch-Config is
  configured, the corresponding PUSCH scheduled by the DCI format 0_0 is for the UL
  or SUL for which high layer parameter pucch-Config is configured.
  If the UL/SUL indicator is not present in DCI format 0_0 and pucch-Config is not
  configured, the corresponding PUSCH scheduled by the DCI format 0_0 is for the
  uplink on which the latest PRACH is transmitted. [symbol]
indicates data missing or illegible when filed
```

DCI format 0_1 may be used as non-fallback DCI for scheduling a PUSCH, where the CRC may be scrambled with a C-RNTI. DCI format 0_1 having a CRC scrambled with a C-RNTI may include, for example, the following information.

```
TABLE 5
Identifier for DCI formats - 1 bit
  The value of this bit field is always set to 0, indicating an UL DCI format
Carrier indicator - 0 or 3 bits, as defined in Subclause 10.1 of [5, TS38.213].
UL/SUL indicator - 0 bit for UEs not configured with supplementaryUplink in ServingCellConfig in the cell
or UEs configured with supplementaryUplink in ServingCellConfig in the cell but only PUCCH carrier in
the cell is configured for PUSCH transmission; otherwise, 1 bit as defined in Table 7.3.1.1.1-1.
Bandwidth part indicator - 0, 1 or 2 bits as determined by the number of UL BWPs n [symbol]  configured by
higher layers, excluding the initial UL bandwidth part. The bitwidth for this field is determined as
┌log₂(n_{BWP})┐ bits, where
  n_{BWP} = n [symbol]  + 1 if n [symbol]  ≤ 3, in which case the bandwidth part indicator is equivalent to the
  ascending order of the higher layer parameter BWP-Id;
  otherwise n_{BWP} = n_{B} [symbol] , in which case the bandwidth part indicator is defined in Table 7.3.1.1.2-1;
If a UE does not support active BWP change via DCI, the UE ignores this bit field.
Frequency domain resource assignment - number of bits determined by the following, where N_{RB}^{UL,BWP} is the
size of the active UL bandwidth part:
  N_{REG} bits if only resource allocation type 0 is configured, where N_{REG} is defined in Subclause
  6.1.2.2.1 of [6. TS 38.214],
  ┌log₂(N_{RB}^{UL,BWP}(N_{RB}^{UL,BWP} + 1)/2)┐ bits if only resource allocation type 1 is configured, or
max (┌log₂(N_{RB}^{UL,BWP}(N_{RB}^{UL,BWP} + 1)/2)┐, N_{REG})₊₁ bits if both resource allocation type 0 and 1 are configured.
  If both resource allocation type 0 and 1 are configured, the MSB bit is used to indicate resource
  allocation type 0 or resource allocation type 1, where the bit value of 0 indicates resource allocation type
0 and the bit value of I indicates resource allocation type 1.
  For resource allocation type 0, the N_{REG} LSBs provide the resource allocation as defined in Subclause
  6.1.2.2.1 of [6, TS 38.214].
  For resource allocation type 1, the ┌log₂(N_{RB}^{UL,BWP}(N_{RB}^{UL,BWP} + 1)/2)┐ LSBs provide the resource allocation
  as follows:
    For PUSCH hopping with resource allocation type 1:
      N_{UL} [symbol]  MSB bits are used to indicate the frequency offset according to Subclause 6.3 of [6, TS
      38.214], where N_{UL} [symbol]  = 1 if the higher layer parameter frequencyHoppingOffsetLists contains
      two offset values and N_{UL} [symbol]  = 2 if the higher layer parameter frequencyHoppingOffsetLists
      contains four offset values
      ┌log₂(N_{RB}^{UL,BWP}(N_{RB}^{UL,BWP} + 1)/2)┐ − bits provides the frequency domain resource allocation
      according to Subclause 6.1.2.2.2 of [6, TS 38.214]
    For non-PUSCH hopping with resource allocation type 1:
      ┌log₂(N_{RB}^{UL,BWP}(N_{RB}^{UL,BWP} + 1)/2)┐ bits provides the frequency domain resource allocation according
      to Subclause 6.1.2.2.2 of [6, TS 38.214]
  If “Bandwidth part indicator” field indicates a bandwidth part other than the active bandwidth part and if
  both resource allocation type 0 and 1 are configured for the indicated bandwidth pact, the UE assumes
  resource allocation type 0 for the indicated bandwidth part if the bitwidth of the “Frequency domain
  resource assignment” field of the active bandwidth part is smaller than the bitwidth of the “Frequency
  domain resource assignment” field of the indicated bandwidth part.
Time domain resource assignment - 0, 1, 2, 3, or 4 bits as defined in Subclause 6.1.2.1 of [6, TS38.214].
The bitwidth for this field is determined as ┌log₂(I)┐ bits, where I is the number of entries in the higher
layer parameter pusch-TimeDomainAllocationList if the higher laver parameter is configured; otherwise I is
the number of entries in the default table.
Frequency hopping flag - 0 or 1 bit:
  0 hit if only resource allocation type 0 is configured or if the higher laver parameter frequencyHopping is
  not configured;
  1 bit according to Table 7.3.1.1.1-3 otherwise, only applicable to resource allocation type 1, as defined in
  Subclause 6.3 of [6, TS 38.214].
Modulation and coding scheme - 5 bits as defined in Subclause 6.1.4.1 of [6, TS 38.214]
  New data indicator - 1 bit
  Redundancy version - 2 bits as defined in Table 7.3.1.1.1-2
  HARQ process number - 4 bits
  1^{st} downlink assignment index - 1 or 2 bits:
    1 bit for semi-static HARQ-ACK codebook;
    2 bits for dynamic HARQ-ACK codebook.
  2^{nd} downlink assignment index - 0 or 2 bits:
    2 bits for dynamic HARQ-ACK codebook with two HARQ-ACK sub-codebooks;
    0 bit otherwise.
  TPC command for scheduled PUSCH - 2 bits as defined in Subclause 7.1.1 of [S, TS38.213]
  $SRS resource indicator - ⌈ {log}_{2} ( {\sum }_{k = 1}^{min ( {L}_{max} , {N}_{SRS} )} ( \begin{matrix}{N}_{SRS} \\ k\end{matrix} ) ) ⌉ or ⌈ {log}_{2} ( {N}_{SRS} ) ⌉ bits , where {N}_{SRS} is the number of$
  configured SRS resources in the SRS resource set associated with the higher layer parameter usage of value
  ′codeBook′ or ′nonCodeBook′,
  $⌈ {log}_{2} ( {\sum }_{k = 1}^{min ( {L}_{max} , {N}_{SRS} )} ( \begin{matrix}{N}_{SRS} \\ k\end{matrix} ) ) ⌉ bits according to Tables 7.3 \text{.1} \text{.1} \text{.2} - 28 / 29 / 30 / 31 if the higher layer parameter$
    txConfig = nonCodebook, where N_{SRS} is the number of configured SRS resources in the SRS resource
    set associated with the higher layer parameter usage of value ′nonCodeBook′ and
      if UE supports operation with maxMIMO-Layers and the higher layer parameter maxMIMO-Layers of
      PUSCH-ServingCellConfig of the serving cell is configured, Lₘₐₓ is given by that parameter
      otherwise, Lₘₐₓ is given by the maximum number of layers for PUSCH supported by the UE for the
      serving cell for non-codebook based operation.
    ┌log₂(N_{SRS})┐ bits according to Tables 7.3.1.1.2-32 if the higher layer parameter ixConfig = codebook.
    where N_{SRS} is the number of configured SRS resources in the SRS resource set associated with the
    higher layer parameter usage of value ′codeBook′.
  Precoding information and number of layers - number of bits determined by the following:
    0 bits if the higher layer parameter txConfig = nonCodeBook:
    0 bits for 1 antenna port and if the higher laver parameter ixConfig = codebook;
    4, 5, or 6 bits according to Table 7.3.1.1.2-2 for 4 antenna ports, if txConfig = codebook, and according
    to whether transform precoder is enabled or disabled, and the values of higher layer parameters
    maxRank, and codebookSubset;
    2, 4, or 5 bits according to Table 7.3.1.1.2-3 for 4 antenna ports, if txConfig = codebook, and according
    to whether transform precoder is enabled or disabled, and the values of higher layer parameters
    maxRank, and codebookSubset;
    2 or 4 bits according to Table7.3.1.1.2-4 for 2 antenna ports, if txConfig = codebook, and according to
    whether transform precoder is enabled or disabled, and the values of higher layer parameters maxRank
    and codebookSubset;
    1 or 3 bits according to Table7.3.1.1.2-5 for 2 antenna ports, if txConfig = codebook, and according to
    whether transform precoder is enabled or disabled, and the values of higher layer parameters maxRank
    and codebookSubset.
  Antenna ports - number of bits determined by the following
    2 bits as defined by Tables 7.3.1.1.2-6, if transform precoder is enabled, dmrs-Type=1, and
    maxLength=1;
    4 bits as defined by Tables 7.3.1.1.2-7, if transform precoder is enabled, dmrs-Type=1, and
    maxLength=2;
    3 bits as defined by Tables 7.3.1.1.2-8/9/10/11, if transform precoder is disabled, dmrs-Type=1, and
    maxLength=1, and the value of rank is determined according to the SRS resource indicator field if the
    higher layer parameter txConfig = nonCodebook and according to the Precoding information and number
    of layers field if the higher layer parameter txConfig = codebook;
    4 bits as defined by Tables 7.3.1.1.2-12/13/14/15, if transform precoder is disabled, dmrs-Type=1, and
    maxLength=2, and the value of rank is determined according to the SRS resource indicator field if the
    higher layer parameter txConfig = nonCodebook and according to the Precoding information and number
    of layers field if the higher layer parameter txConfig = codebook;
    4 bits as defined by Tables 7.3.1.1.2-16/17/18/19, if transform precoder is disabled, dmrs-Type=2, and
    maxLength=1, and the value of rank is determined according to the SRS resource indicator field if the
    higher layer parameter txConfig = nonCodebook and according to the Precoding information and number
    of layers field if the higher layer parameter txConfig = codebook;
    5 bits as defined by Tables 7.3.1.1.2-20/21/22/23, if transform precoder is disabled, dmrs-Type=2, and
    maxLength=2, and the value of rank is determined according to the SRS resource indicator field if the
    higher layer parameter txConfig = nonCodebook and according to the Precoding information and number
    of layers field if the higher layer parameter txConfig = codebook.
  where the number of CDM groups without data of values 1, 2. and 3 in Tables 7.3.1.1.2-6 to 7.3.1.1.2-23
  refers to CDM groups {0}, {0, 1}, and {0, 1, 2} respectively.
  If a UE is configured with both dmrs-UplinkForPUSCH-MappingTypeA and
  dmrs-UplinkForPUSCH-MappingTypeB, the bitwidth of this field equals max {x_{A}, x_{S}}, where x_{A} is the
  ″Antenna ports″ bitwidth derived according to dmrs-UplinkForPUSCH-MappingTyped and x_{B} is the
  ″Antenna ports″ bitwidth derived according to dmrs-UplinkForPUSCH-MappingTypeB. A number of
  |x_{A}, x_{S}| zeros are padded in the MSB of this field, if the mapping type of the PUSCH corresponds to the
  smaller value of x_{A} and x_{B}.
  SRS request - 2 bits as defined by Table 7.3.1.1.2-24 for UEs not configured with supplementary Uplink in
  ServingCellConfig in the cell; 3 bits for UEs configured with supplementary Uplink in ServingCellConfig in
  the cell where the first bit is the non-SUL/SUL indicator as defined in Table 7.3.1.1.1-1 and the second and
  third bits are defined by Table 7.3.1.1.2-24. This bit field may also indicate the associated CSI-RS according
  to Subclause 6.1.1.2 of [6, TS 38.214].
  CSI request - 0, 1. 2, 3, 4, 5, or 6 bits determined by higher layer parameter reportTriggerSize.
  CBG transmission information (CBGTI) - 0 bit if higher layer parameter codeBlockGroupTransmission for
  PDSCH is not configured, otherwise, 2, 4, 6, or 8 bits determined by higher layer parameter
  maxCodeBlockGroupsPerTransportBlock for PUSCH.
  PTRS-DMRS association - number of bits determined as follows
    0 bit if PTRS-UplinkConfig is not configured and transform precoder is disabled, or if transform precoder
    is enabled, or if maxRank=1;
    2 bits otherwise, where Table 7.3.1.1.2-25 and 7.3.1.1.2-26 are used to indicate the association between
    PTRS port(s) and DMRS port(s) for transmission of one PT-RS port and two PT-RS ports respectively,
    and the DMRS ports are indicated by the Antenna ports field.
  If ″Bandwidth part indicator″ field indicates a bandwidth part other than the active bandwidth part and the
  ″PTRS-DMRS association″ field is present for the indicated bandwidth part but not present for the active
  bandwidth part, the UE assumes the ″PTRS-DMRS association″ field is not present for the indicated.
  bandwidth part.
  beta_offset indicator - 0 if the higher layer parameter betaOffsets = semiStatic; otherwise 2 bits as defined
  by Table 9.3-3 in [S, TS 38.213].
  DMRS sequence initialization - 0 bit if transform precoder is enabled; 1 bit if transform precoder is
  disabled.
  UL-SCH indicator - 1 bit. A value of ″1″ indicates UL-SCH shall be transmitted on the PUSCH and a value
  of ″0″ indicates UL-SCH shall not be transmitted on the PUSCH. Except for DCI format 0_1 with CRC
  scrambled by SP-CSI-RNTI, a UE is not expected to receive a DCI format 0_1 with UL-SCH indicator of
  ″0″ and C′SI request of all zero(s). [symbol]
indicates data missing or illegible when filed
```

DCI format 1_0 may be used as fallback DCI for scheduling a PDSCH, where the CRC may be scrambled with a C-RNTI. DCI format 1_0 having a CRC scrambled with a C-RNTI may include, for example, the following information.

```
TABLE 6
  Identifier for DCI formats - 1 bits
    The value of this bit field is always set to 1, indicating a DL DCI format
  Frequency domain resource assignment - ┌log₂(N_{RB}^{DL, BWP}(N_{RB}^{DL, BWP} + 1)/2)┐ bits where N_{RB}^{DL, BWP}
  is given by subclause 7.3.1.0
If the CRC of the DCI format 1_0 is scrambled by C-RNTI and the “Frequency domain
resource assignment” field are of all ones, the DCI format 1_0 is for random access
procedure initiated by a PDCCH order, with all remaining fields set as follows:
  Random Access Preamble index - 6 bits according to ra-PreambleIndex in Subclause
  5.1.2 of [8, TS38.321]
  UL/SUL indicator - 1 bit. If the value of the “Random Access Preamble index” is not all
  zeros and if the UE is configured with supplementaryUplink in ServingCellConfig in the
  cell, this field indicates which UL carrier in the cell to transmit the PRACH according to
  Table 7.3.1.1.1-1; otherwise, this field is reserved
  SS/PBCH index - 6 bits. If the value of the “Random Access Preamble index” is not all
  zeros, this field indicates the SS/PBCH that shall be used to determine the RACH
  occasion for the PRACH transmission; otherwise, this field is reserved.
  PRACH Mask index - 4 bits. If the value of the “Random Access Preamble index” is not
  all zeros, this field indicates the RACH occasion associated with the SS/PBCH indicated
  by “SS/PBCH index” for the PRACH transmission, according to Subclause 5.1.1 of [8,
  TS38.321]; otherwise, this field is reserved
  Reserved bits - 10 bits
Otherwise, all remaining fields are set as follows:
  Time domain resource assignment - 4 bits as defined in Subclause 5.1.2.1 of [6, TS
  38.214]
  VRB-to-PRB mapping - 1 bit according to Table 7.3.1.2.2-5
  Modulation and coding scheme - 5 bits as defined in Subclause 5.1.3 of [6, TS 38.214]
  New data indicator - 1 bit
  Redundancy version - 2 bits as defined in Table 7.3.1.1.1-2
  HARQ process number - 4 bits
  Downlink assignment index - 2 bits as defined in Subclause 9.1.3 of [5, TS 38.213], as
  counter DAI
  TPC command for scheduled PUCCH - 2 bits as defined in Subclause 7.2.1 of [5, TS
  38.213]
  PUCCH resource indicator - 3 bits as defined in Subclause 9.2.3 of [5, TS 38.213]
  PDSCH-to-HARQ_feedback timing indicator - 3 bits as defined in Subclause 9.2.3 of [5,
  TS38.213]
```

DCI format 1_1 may be used as non-fallback DCI for scheduling a PDSCH, where the CRC may be scrambled with a C-RNTI. DCI format 1_1 having a CRC scrambled with a C-RNTI may include, for example, the following information.

```
TABLE 7
  Identifier for DCI formats - 1 bits
    The value of this bit field is always set to 1, indicating a DL DCI format
  Carrier indicator - 0 or 3 bits as defined in Subclause 10.1 of [5, TS 38.213].
  Bandwidth part indicator - 0, 1 or 2 bits as determined by the number of DL BWPs n [symbol]
  configured by higher layers, excluding the initial DL bandwidth part. The bitwidth for this field is
  determined as ┌log₂ ( [symbol] _{BWP})┐ bits, where
    n_{BWP} = n_{BWP} [symbol]  + 1 if n_{BWP} [symbol]  ≤ 3, in which case the bandwidth part indicator is equivalent to
    the ascending order of the higher layer parameter BWP-Id;
    otherwise n_{BWP} = n_{BWP} [symbol]  in which case the bandwidth part indicator is defined in Table
    7.3.1.1.2-1;
  If a UE does not support active BWP change via DCI, the UE ignores this bit field.
  Frequency domain resource assignment - number of bits determined by the following, where
  N_{RB}^{DL, BWP} is the size of the active DL bandwidth part:
    N_{RBG} bits if only resource allocation type 0 is configured, where N_{RBG} is defined in
    Subclause 5.1.2.2.1 of [6, TS38.214],
    ┌log₂(N_{RB}^{DL, BWP}(N_{RB}^{DL, BWP} + 1)/2)┐ bits if only resource allocation type 1 is configured, or
    max (┌log₂(N_{RB}^{DL, BWP}(N_{RB}^{DL, BWP} + 1)/2)┐, N_{RBG}) + 1 bits if both resource allocation type 0 and 1
    are configured.
    If both resource allocation type 0 and 1 are configured, the MSB bit is used to indicate resource
    allocation type 0 or resource allocation type 1, where the bit value of 0 indicates resource
    allocation type 0 and the bit value of 1 indicates resource allocation type 1.
    For resource allocation type 0, the N [symbol]  LSBs provide the resource allocation as defined in
    Subclause 5.1.2.2.1 of [6, TS 38.214].
    For resource allocation type 1, the ┌log₂(N_{RB}^{DL, BWP} (N_{RB}^{DL, BWP} + 1)/2)┐ LSBs provide the resource
    allocation as defined in Subclause 5.1.2.2.2 of [6, TS 38.214]
  If “Bandwidth part indicator” field indicates a bandwidth part other than the active bandwidth part
  and if both resource allocation type 0 and 1 are configured for the indicated bandwidth part, the
  UE assumes resource allocation type 0 for the indicated bandwidth part if the bitwidth of the
  “Frequency domain resource assignment” field of the active bandwidth part is smaller than the
  bitwidth of the “Frequency domain resource assignment” field of the indicated bandwidth part.
  Time domain resource assignment - 0, 1, 2, 3, or 4 bits as defined in Subclause 5.1.2.1 of [6, TS
  38.214]. The bitwidth for this field is determined as fog ┌log₂(I)┐ bits, where I is the number of entries
  in the higher layer parameter pdsch-TimeDomainAllocationList if the higher layer parameter is
  configured; otherwise I is the number of entries in the default table.
  VRB-to-PRB mapping - 0 or 1 bit:
    0 bit if only resource allocation type 0 is configured or if interleaved VRB-to-PRB mapping is
    not configured by high layers;
    1 bit according to Table 7.3.1.2.2-5 otherwise, only applicable to resource allocation type 1, as
    defined in Subclause 7.3.1.6 of [4, TS 38.211].
  PRB bundling size indicator - 0 bit if the higher layer parameter prb-BundlingType is not
  configured or is set to ‘static’, or 1 bit if the higher layer parameter prb-BundlingType is set to
  ‘dynamic’ according to Subclause 5.1.2.3 of [6, TS 38.214].
  Rate matching indicator - 0, 1, or 2 bits according to higher layer parameters
  rateMatchPatternGroup1 and rateMatchPatternGroup2, where the MSB is used to indicate
  rateMatchPatternGroup1 and the LSB is used to indicate rateMatchPatternGroup2 when there
  are two groups.
  ZP CSI-RS trigger - 0, 1, or 2 bits as defined in Subclause 5.1.4.2 of [6, TS 38.214]. The bitwidth
  for this field is determined as ┌log₂(n [symbol]  + 1)┐ bits, where n_{ZP} is the number of aperiodic ZP
  CSI-RS resource sets configured by higher layer.
For transport block 1:
    Modulation and coding scheme - 5 bits as defined in Subclause 5.1.3.1 of [6, TS 38.214]
    New data indicator - 1 bit
    Redundancy version - 2 bits as defined in Table 7.3.1.1.1-2
For transport block 2 (only present if maxNrofCodeWordsScheduledByDCI equals 2):
    Modulation and coding scheme - 5 bits as defined in Subclause 5.1.3.1 of [6, TS 38.214]
    New data indicator - 1 bit
    Redundancy version - 2 bits as defined in Table 7.3.1.1.1-2
  If “Bandwidth part indicator” field indicates a bandwidth part other than the active bandwidth part
  and the value of maxNrofCodeWordsScheduledByDCI for the indicated bandwidth part equals 2
  and the value of maxNrofCodeWordsScheduledByDCI for the active bandwidth part equals 1, the
  UE assumes zeros are padded when interpreting the “Modulation and coding scheme”, “New data
  indicator”, and “Redundancy version” fields of transport block 2 according to Subclause 12 of [5,
  TS38.213], and the UE ignores the “Modulation and coding scheme”, “New data indicator”, and
  “Redundancy version” fields of transport block 2 for the indicated bandwidth part.
  HARQ process number - 4 bits
  Downlink assignment index - number of bits as defined in the following
    4 bits if more than one serving cell are configured in the DL and the higher layer parameter
    pdsch-HARQ-ACK-Codebook = dynamic, where the 2 MSB bits are the counter DAI and the 2
    LSB bits are the total DAI;
    2 bits if only one serving cell is configured in the DL and the higher layer parameter
    pdsch-HARQ-ACK-Codebook = dynamic, where the 2 bits are the counter DAI;
    0 bits otherwise.
  TPC command for scheduled PUCCH - 2 bits as defined in Subclause 7.2.1 of [5, TS 38.213]
  PUCCH resource indicator - 3 bits as defined in Subclause 9.2.3 of [5, TS 38.213]
  PDSCH-to-HARQ_feedback timing indicator - 0, 1, 2, or 3 bits as defined in Subclause 9.2.3 of
  [5, TS 38.213]. The bitwidth for this field is determined as ┌log₂(I)┐ bits, where I is the number of
  entries in the higher layer parameter dl-DataToUL-ACK.
  Antenna port(s) - 4, 5, or 6 bits as defined by Tables 7.3.1.2.2-1/2/3/4, where the number of CDM
  groups without data of values 1, 2, and 3 refers to CDM groups {0 [symbol] , {0, 1}, and {0, 1.2}
  respectively. The antenna ports [symbol] p₀, . . . , p₀₋₁ [symbol]  shall be determined according to the ordering of
  DMRS port(s) given by Tables 7.3.1.2.2-1/2/3/4.
  If a UE is configured with both dmrs-DownlinkForPDSCH-MappingTypeA and
  dmrs-DownlinkForPDSCH-MappingTypeB, the bitwidth of this field equals max [symbol]  where
  x_{A} is the “Antenna ports” bitwidth derived according to
  dmrs-DownlinkForPDSCH-MappingTypeA and x_{B} is the “Antenna ports” bitwidth derived
  according to dmrs-DownlinkForPDSCH-MappingTypeB. A number of |x_{A} − x_{B}| zeros are padded
  in the MSB of this field, if the mapping type of the PDSCH corresponds to the smaller value of x_{A}
  and x_{B}.
  Transmission configuration indication - 0 bit if higher layer parameter tci-PresentInDCI is not
  enabled; otherwise 3 bits as defined in Subclause 5.1.5 of [6, TS38.214].
  If “Bandwidth part indicator” field indicates a bandwidth part other than the active bandwidth part,
    if the higher layer parameter tci-PresentInDCI is not enabled for the CORESET used for the
    PDCCH carrying the DCI format 1_1,
      the UE assumes tci-PresentInDCI is not enabled for all CORESETs in the indicated
      bandwidth part;
    otherwise,
      the UE assumes tci-PresentInDCI is enabled for all CORESETs in the indicated bandwidth
      part.
  SRS request - 2 bits as defined by Table 7.3.1.1.2-24 for UEs not configured with
  supplementaryUplink in ServingCellConfig in the cell; 3 bits for UEs configured with
  supplementaryUplink in ServingCellConfig in the cell where the first bit is the non-SUL/SUL
  indicator as defined in Table 7.3.1.1.1-1 and the second and third bits are defined by Table
  7.3.1.1.2-24. This bit field may also indicate the associated CSI-RS according to Subclause 6.1.1.2
  of [6, TS 38.214].
  CBG transmission information (CBGTI) - 0 bit if higher layer parameter
  codeBlockGroupTransmission for PDSCH is not configured, otherwise, 2, 4, 6, or 8 bits as defined
  in Subclause 5.1.7 of [6, TS38.214], determined by the higher layer parameters
  maxCodeBlockGroupsPerTransportBlock and maxNrofCodeWordsScheduledByDCI for the
  PDSCH.
  CBG flushing out information (CBGFI) - 1 bit if higher layer parameter
  codeBlockGroupFlushIndicator is configured as “TRUE”, 0 bit otherwise.
  DMRS sequence initialization - 1 bit. [symbol]
indicates data missing or illegible when filed
```

### [PDCCH: CORESET, REG, CCE, Search Space]

Next, a detailed description will be given of a downlink control channel in the 5G wireless communication system with reference to the drawings.

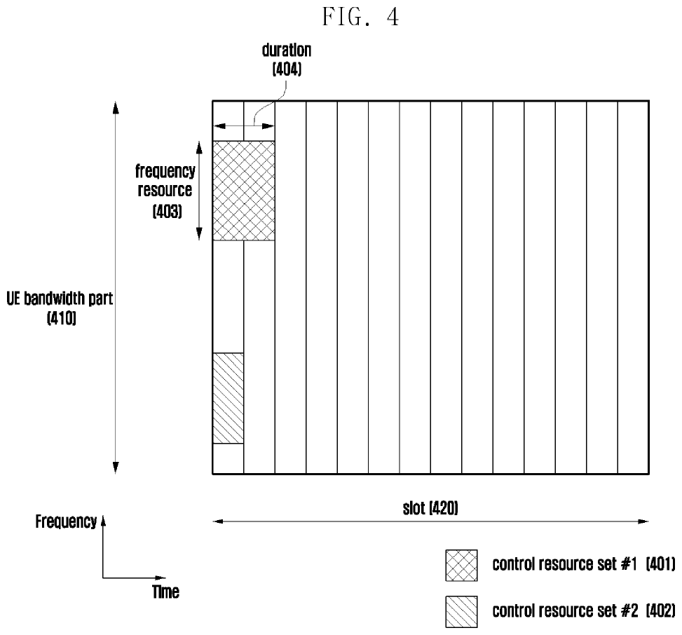

FIG. 4 is a diagram illustrating an example of a control resource set (CORESET) in which a downlink control channel is transmitted in the 5G wireless communication system.

With reference to FIG. 4, two control resource sets (control resource set #1 (401), control resource set #2 (402)) may be configured within one slot 420 in the time domain and the UE bandwidth part 410 in the frequency domain. Control resource sets 401 and 402 may be configured on a specific frequency resource 403 within the entire UE bandwidth part 410 in the frequency domain. The control resource sets 401 and 402 may be configured as one or multiple OFDM symbols in the time domain, and this may be defined as a control resource set duration 404. In the example shown in FIG. 4, control resource set #1 (401) is configured with a control resource set duration of two symbols, and control resource set #2 (402) is configured with a control resource set duration of one symbol.

The control resource set in the 5G wireless communication system described above may be configured to the UE by the base station through higher layer signaling (e.g., system information, master information block (MIB), and radio resource control (RRC) signaling). Configuring a control resource set to the UE may mean providing information such as a control resource set identity, a frequency location of the control resource set, a symbol duration of the control resource set, and the like. For example, the following information may be included.

TABLE 8

| ControlResourceSet ::= | SEQUENCE { |
|---|---|
| -- Corresponds to L1 parameter ‘CORESET-ID’ | |
| controlResourceSetId | ControlResourceSetId, |
| frequencyDomainResources | BIT STRING (SIZE (45)), |
| duration | INTEGER |
| (1..maxCoReSetDuration), | |
| cce-REG-MappingType | CHOICE { |
| interleaved | SEQUENCE { |
| reg-BundleSize | ENUMERATED {n2, |
| n3, n6}, | |
| precoderGranularity | ENUMERATED |
| {sameAsREG-bundle, allContiguousRBs}, | |
| interleaverSize | ENUMERATED {n2, |
| n3, n6} | |
| shiftIndex | |
| INTEGER(0..maxNrofPhysicalResourceBlocks-1) | |
| OPTIONAL | |
| }, | |
| nonInterleaved | NULL |
| }, | |
| tci-StatesPDCCH | SEQUENCE(SIZE |
| (1..maxNrofTCI-StatesPDCCH)) OF TCI-StateId | |
| OPTIONAL, | |
| tci-PresentInDCI | ENUMERATED {enabled} |
| | OPTIONAL, -- Need S |

}

In Table 8, tci-StatesPDCCH (simply referred to as transmission configuration indication (TCI) state) configuration information may include information about one or more synchronization signal (SS)/physical broadcast channel (PBCH) block indexes or channel state information reference signal (CSI-RS) indexes in a quasi-co-located (QCLed) relationship with a demodulation reference signal (DMRS) transmitted in the corresponding control resource set.

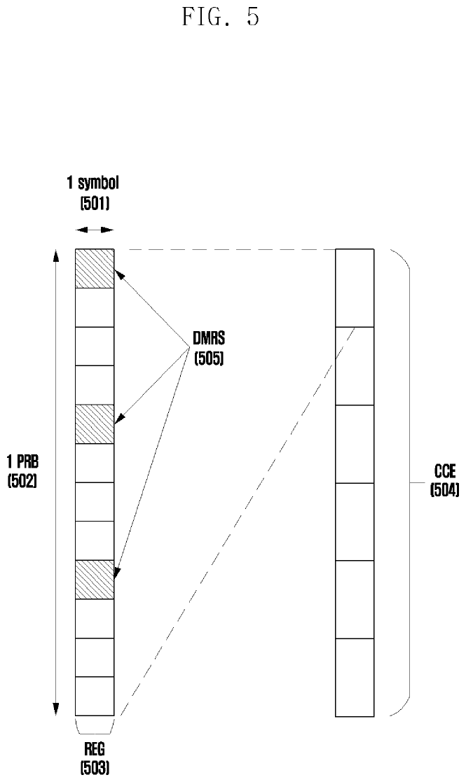

FIG. 5 is a diagram illustrating the structure of a downlink control channel in the 5G wireless communication system.

That is, FIG. 5 is a diagram showing an example of the basic unit of time-frequency resources constituting a downlink control channel that may be used in the 5G wireless communication system.

With reference to FIG. 5, the basic unit of time-frequency resources constituting a control channel may be referred to as a resource element group (REG) 503, and the REG 503 may be defined as one OFDM symbol 501 in the time domain and one physical resource block (PRB) 502, that is, 12 subcarriers, in the frequency domain. The base station may concatenate REGs 503 to compose a downlink control channel allocation unit.

As illustrated in FIG. 5, when the basic unit to which the downlink control channel is assigned in the 5G wireless communication system is a control channel element (CCE) 504, one CCE 504 may be composed of plural REGs 503. Taking the REG 503 shown in FIG. 5 as an example, when the REG 503 includes 12 REs and one CCE 504 includes 6 REGs 503, one CCE 504 may include 72 REs. When a downlink control resource set is configured, the corresponding region may be composed of multiple CCEs 504, and a specific downlink control channel may be transmitted after being mapped to one or multiple CCEs 504 according to an aggregation level (AL) in the control resource set. The CCEs 504 in a control resource set may be identified by numbers, in which case the numbers may be assigned to the CCEs 504 according to a logical mapping scheme.

The basic unit of the downlink control channel illustrated in FIG. 5, that is, the REG 503, may include both REs to which the DCI is mapped and a region to which a DMRS 505 being a reference signal for decoding the DCI is mapped. As illustrated in FIG. 5, three DMRSs 505 may be transmitted in one REG 503. The number of CCEs required to transmit the PDCCH may be 1, 2, 4, 8, or 16 according to the aggregation level (AL), and different number of CCEs may be used to implement link adaptation of the downlink control channel. For example, when AL=L, one downlink control channel may be transmitted through L CCEs. The UE has to detect a signal without having information about the downlink control channel, and a search space representing a set of CCEs is defined for blind decoding. The search space may refer to a set of downlink control channel candidates composed of CCEs to which the UE has to attempt decoding on a given aggregation level. Because there are various aggregation levels that groups 1, 2, 4, 8, or 16 CCEs into one bundle, the UE may have plural search spaces. The search space set may be defined as a set of search spaces at all configured aggregation levels. Search spaces may be classified as a common search space and a UE-specific search space. A group of UEs or all UEs may search for a common search space of the PDCCH to receive cell-common control information such as dynamic scheduling of system information or a paging message. For example, PDSCH scheduling allocation information for transmitting an SIB including cell operator information or the like may be received by searching for the common search space of the PDCCH. Since a group of UEs or all UEs need to receive the PDCCH, a common search space may be defined as a set of CCEs agreed upon in advance. Scheduling allocation information for a UE-specific PDSCH or PUSCH may be received by searching for a UE-specific search space of the PDCCH. A UE-specific search space may be defined in a UE-specific way as a function of UE identity and various system parameters.

In the 5G wireless communication system, parameters for a search space for the PDCCH may be configured by the base station to the UE via higher layer signaling (e.g., SIB, MIB, or RRC signaling). For example, the base station may configure, to the UE, the number of PDCCH candidates at each aggregation level L, a periodicity of monitoring the search space, a search space monitoring occasion in units of symbols within a slot, a search space type (common search space or UE-specific search space), a DCI format-RNTI combination to be monitored in a corresponding search space, a control resource set index at which a search space is to be monitored, and the like. For example, parameters for the search space as to the PDCCH may include the following information.

TABLE 9

| | |
|---|---|
| SearchSpace ::= | SEQUENCE { |

```
      -- Identity of the search space. SearchSpaceId = 0 identifies the
    SearchSpace configured via PBCH (MIB) or ServingCellConfigCommon.
```

| | |
|---|---|
| searchSpaceId | SearchSpaceId, |
| controlResourceSetId | ControlResourceSetId, |
| monitoringSlotPeriodicityAndOffset | CHOICE { |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| | OPTIONAL, |
| duration | INTEGER (2..2559) |
| monitoringSymbolsWithinSlot | BIT STRING (SIZE (14)) |
| | OPTIONAL, |
| nrofCandidates | SEQUENCE { |
| aggregationLevel1 | ENUMERATED {n0, n1, n2, n3, n4, n5, |

n6, n8},

| | |
|---|---|
| aggregationLevel2 | ENUMERATED {n0, n1, n2, n3, n4, n5, |

n6, n8},

| | |
|---|---|
| aggregationLevel4 | ENUMERATED {n0, n1, n2, n3, n4, n5, |

n6, n8},

| | |
|---|---|
| aggregationLevel8 | ENUMERATED {n0, n1, n2, n3, n4, n5, |

n6, n8},

| | |
|---|---|
| aggregationLevel16 | ENUMERATED {n0, n1, n2, n3, n4, n5, |

n6, n8}
},

| | |
|---|---|
| searchSpaceType | CHOICE { |

-- Configures this search space as common search space (CSS) and DCI
formats to monitor.

| | |
|---|---|
| common | SEQUENCE { |

}

| | |
|---|---|
| ue-Specific | SEQUENCE { |

-- Indicates whether the UE monitors in this USS for DCI formats 0-
0 and 1-0 or for formats 0-1 and 1-1.

| | |
|---|---|
| formats | ENUMERATED {formats0-0-And-1-0, |

```
formats0-1-And-1-1},
      ...
    }
```

Based on the configuration information, the base station may configure one or multiple search space sets to the UE. According to an embodiment, the base station may configure the UE with search space set 1 and search space set 2 so as to monitor DCI format A scrambled with X-RNTI in a common search space of search space set 1, and monitor DCI format B scrambled with Y-RNTI in a UE-specific search space of search space set 2.

According to the configuration information, one or multiple search space sets may be present in a common search space or a UE-specific search space. For example, search space set #1 and search space set #2 may be configured as a common search space, and search space set #3 and search space set #4 may be configured as a UE-specific search space.

In a common search space, the following combination of a DCI format and an RNTI may be monitored. However, it is not limited to the examples below.
DCI format 0_0/1_0 with CRC scrambled by C-RNTI, CS-RNTI, MCS-C-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the following combination of a DCI format and an RNTI may be monitored. However, it is not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above-mentioned RNTIs may follow the definition and usage described below. C-RNTI (cell RNTI): used for scheduling UE-specific PDSCH
MCS-C-RNTI (modulation coding scheme C-RNTI): used for scheduling UE-specific PDSCH
TC-RNTI (temporary cell RNTI): used for scheduling UE-specific PDSCH CS-RNTI (configured scheduling RNTI): used for scheduling semi-statically configured UE-specific PDSCH
RA-RNTI (random access RNTI): used for scheduling PDSCH at random access stage
P-RNTI (paging RNTI): used for scheduling PDSCH in which paging is transmitted
SI-RNTI (system information RNTI): used for scheduling PDSCH in which system information is transmitted
INT-RNTI (interruption RNTI): used for indicating whether to perform puncturing on PDSCH
TPC-PUSCH-RNTI (transmit power control for PUSCH RNTI): used for issuing a power control command for PUSCH
TPC-PUCCH-RNTI (transmit power control for PUCCH RNTI): used for issuing a power control command for PUCCH
TPC-SRS-RNTI (transmit power control for SRS RNTI): used for issuing a power control command for SRS

The DCI formats specified above may follow the definitions below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot |
| | format |
| 2_1 | Notifying a group of UEs of the PRB(s) |
| | and OFDM symbol(s) where UE may assume |
| | no transmission is intended for the UE |
| 2_2 | Transmission of TPC commands for PUCCH |
| | and PUSCH |
| 2_3 | Transmission of a group of TPC commands |
| | for SRS transmissions by one or more |
| | UEs |

With control resource set p and search space set s in the 5G wireless communication system, the search space at aggregation level L may be represented as the following equation.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{CCE , p} / L ⌋ \} + i \qquad [ Equation 1 ]$$

L: aggregation level
n_{CI}: carrier index
N_{CCE,p}: total number of CCEs present in control resource set p
n^{μ}_{s,f}: slot index
M^{(L)}_{p,s,max}: number of PDCCH candidates at aggregation level L
m_{snCI}=0, . . . , M^{(L)}_{p,s,max}−1: PDCCH candidate index at aggregation level L
i=0, . . . , L−1
Y_{p,n}_{_{s,f}}_{^{μ}}=(Aₚ·Y_{p,n}_{_{s,f}}_{^{μ}})mod D, Y_{p,-1}=n_{RNTI}≠0, A₀=39827,
A₁=39829, A₂=39839, D=65537
n_{RNTI}: UE identity

The value of Y_(p,n^{μ}_{s,f}) may correspond to 0 for the common search space.

For the UE-specific search space, the value of Y_(p,n^{μ}_{s,f}) may correspond to a value that changes according to the UE identity (C-RNTI or ID configured by the base station to the UE) and the time index.

### [Uplink-Downlink Configuration Related]

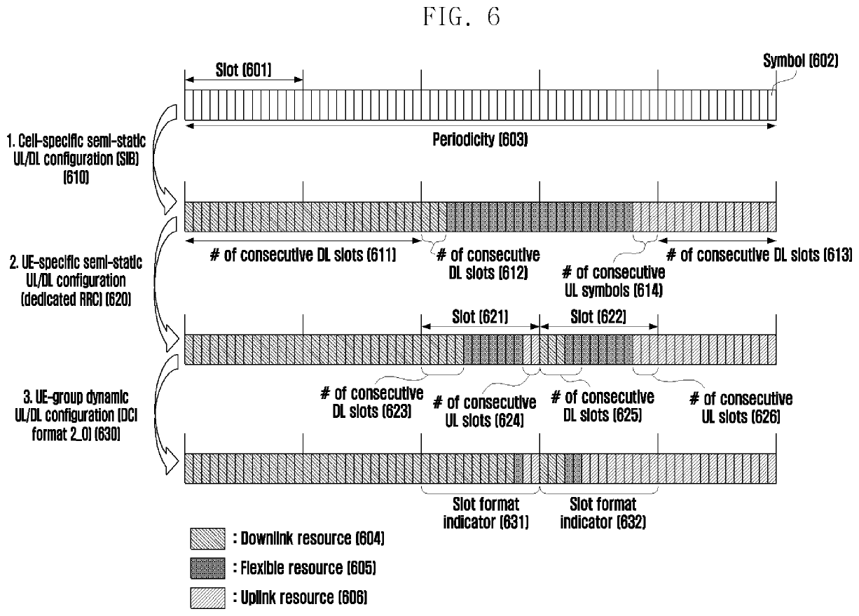

FIG. 6 is a diagram illustrating an example of an uplink-downlink configuration considered in the 5G communication system according to an embodiment of the disclosure.

With reference to FIG. 6, one slot 601 may include 14 symbols 602. In the 5G communication system, the uplink-downlink configuration for symbols/slots may be set in three stages. First, the uplink-downlink of symbols/slots may be configured on a symbol basis in a semi-static manner through cell-specific configuration information 610 using system information. Specifically, the cell-specific uplink-downlink configuration information using the system information may include uplink-downlink pattern information and reference subcarrier information. The uplink-downlink pattern information may indicate a pattern periodicity 603, the number of consecutive downlink slots 611 from the start of the pattern and the number of symbols 612 in the next slot, the number of consecutive uplink slots 613 from the end of the pattern and the number of symbols 614 in the next slot. At this time, slots and symbols that are not designated as uplink slots/symbols 606 or downlink slots/symbols 604 may be determined as flexible slots/symbols 605.

Second, through UE-specific configuration information 620 using dedicated higher layer signaling, a flexible slot or slot 621 or 622 containing flexible symbols may be indicated by the number of consecutive downlink symbols 623 or 625 from the start symbol of the slot and the number of consecutive uplink symbols 624 or 626 from the end of the slot, or may be indicated as a full downlink slot or a full uplink slot. In addition, finally, to dynamically change the downlink and uplink signal transmission sections, symbols indicated as flexible symbols in a slot (i.e., symbols not indicated as downlink or uplink) may be indicated as a downlink symbol, uplink symbol, or flexible symbol through a slot format indicator (SFI) 631 or 632 included in the downlink control channel 630. The slot format indicator may be selected as an index from a table in which uplink-downlink configurations of 14 symbols in one slot are preset as shown in Table 11 below.

TABLE 11

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on TDD-UL-DL-ConfigurationCommon, |
| | or TDD-UL-DL-ConfigDedicated and, if any, on detected DCI formats |

### [QCL, TCI State]

In a wireless communication system, one or more different antenna ports (these may be replaced with one or more channels, signals, or a combination thereof, but will be collectively referred to as “different antenna ports” in the following description of the disclosure for convenience) may be associated with each other according to quasi co-location (QCL) configuration as shown in Table 12 below. The TCI state is intended to notify a QCL relationship between a PDCCH (or PDCCH DMRS) and another RS or channel; when a specific reference antenna port A (reference RS #A) and another target antenna port B (target RS #B) are quasi co-located (QCLed), this indicates that the UE is allowed to apply some or all of large-scale channel parameters estimated from the antenna port A to channel measurement from the antenna port B. QCL may be required to associate different parameters depending on the situation, such as 1) time tracking affected by average delay and delay spread, 2) frequency tracking affected by Doppler shift and Doppler spread, 3) radio resource management (RRM) affected by average gain, 4) beam management (BM) affected by spatial parameters, and the like. Accordingly, NR supports four types of QCL relationships as shown in Table 12 below.

TABLE 12

| QCL type | Large-scale characteristics |
|---|---|
| A | Doppler shift, Doppler spread, average delay, |
| | delay spread |
| B | Doppler shift, Doppler spread |
| C | Doppler shift, average delay |
| D | Spatial Rx parameter |

Spatial RX parameters may collectively refer to some or all of various parameters such as angle of arrival (AoA), power angular spectrum (PAS) of AoA, angle of departure (AoD), PAS of AoD, transmit/receive channel correlation, transmit/receive beamforming, spatial channel correlation, and the like.

The QCL relationship may be configured to the UE through RRC parameters TCI-State and QCL-Info as shown in Table 13 below. Referring to Table 13, the base station may configure one or more TCI states for the UE and notify the UE of up to two QCL relationships (qcl-Type1 and qcl-Type2) about the RS referring to the ID of a TCI state, that is, the target RS. Here, each piece of QCL information (QCL-Info) included in each TCI state includes a serving cell index and a BWP index associated with the reference RS indicated by the corresponding QCL information, the type and ID of the reference RS, and the QCL type as shown in Table 13 above.

TABLE 13

| TCI-State ::= | SEQUENCE { | |
|---|---|---|
| tci-StateId | TCI-StateId, | |
| qcl-Type1 | QCL-Info, | |
| qcl-Type2 | QCL-Info | OPTIONAL, -- |
| Need R | | |
| ... | | |
| } | | |
| QCL-Info ::= | SEQUENCE { | |
| cell | ServCellIndex | OPTIONAL, -- Need R |
| bwp-Id | BWP-Id | OPTIONAL, -- |

| Cond CSI-RS-Indicated | |
|---|---|
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, |

typeD},
...
}

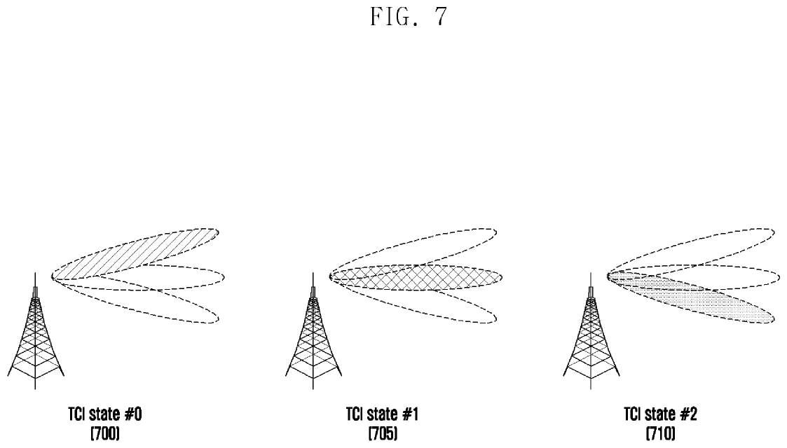

FIG. 7 is a diagram showing an example of base station beam allocation according to the TCI state configuration. With reference to FIG. 7, the base station may transmit information about N different beams to the UE through N different TCI states. For example, in the case of N=3 as shown in FIG. 7, the base station may configure parameter “qcl-Type2” included in three TCI states 700, 705 and 710 as being associated with CSI-RSs or SSBs corresponding to different beams and as being QCL type D, thereby notifying that the antenna ports referring to the different TCI states 700, 705 and 710 are associated with different spatial Rx parameters, that is, different beams. Tables 14-1 to 14-5 below illustrate valid TCI state configurations according to target antenna port types.

Table 14-1 illustrates valid TCI state configurations when the target antenna port is a CSI-RS for tracking (TRS). The TRS indicates an NZP CSI-RS whose repetition parameter is not configured and trs-Info is set to “true” among the CSI-RSs. Configuration 3 in Table 14-1 may be used for aperiodic TRS.

TABLE 14-1
Valid TCI state configurations when target
antenna port is CSI-RS for tracking (TRS)

| | | | DL RS 2 | qcl-Type2 |
|---|---|---|---|---|
| Valid TCI state | | | (if | (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same | QCL-TypeD |
| | (periodic) | | as DL RS 1) | |

Table 14-2 illustrates valid TCI state configurations when the target antenna port is a CSI-RS for CSI. The CSI-RS for CSI indicates an NZP CSI-RS whose parameter indicating repetition (e.g., repetition parameter) is not configured and trs-Info is not set to “true” among the CSI-RSs.

TABLE 14-2
Valid TCI state configurations when
target antenna port is CSI-RS for CSI

| | | | DL RS 2 | qcl-Type2 |
|---|---|---|---|---|
| Valid TCI state | | | (if | (if |
| Configuration | DL RS 1 | qcl-Type1 | configured) | configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same as | QCL-TypeD |
| | | | DL RS 1) | |
| 4 | TRS | QCL-TypeB | | |

Table 14-3 illustrates valid TCI state configurations when the target antenna port is a CSI-RS for beam management (BM, same meaning as a CSI-RS for L1 RSRP reporting). The CSI-RS for BM indicates an NZP CSI-RS whose repetition parameter is configured to have a value of On or Off and trs-Info is not set to “true” among the CSI-RSs.

TABLE 14-3
Valid TCI state configurations when target antenna
port is CSI-RS for BM (for L1 RSRP reporting)

| | | | DL RS 2 | qcl-Type2 |
|---|---|---|---|---|
| Valid TCI state | | | (if | (if |
| Configuration | DL RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 14-4 illustrates valid TCI state configurations when the target antenna port is a PDCCH DMRS.

TABLE 14-4
Valid TCI state configurations when
target antenna port is PDCCH DMRS

| Valid | | | DL RS 2 | qcl-Type2 |
|---|---|---|---|---|
| TCI state | DL | | (if | (if |
| Configuration | RS 1 | qcl-Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same as | QCL-TypeD |
| | (CSI) | | DL RS 1) | |

Table 14-5 illustrates valid TCI state configurations when the target antenna port is a PDSCH DMRS.

TABLE 14-5
Valid TCI state configurations when
target antenna port is PDSCH DMRS

| Valid | | | DL RS 2 | qcl-Type2 |
|---|---|---|---|---|
| TCI state | | | (if | (if |
| Configuration | DL RS 1 | qcl-Type1 | configured) | configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS | QCL-TypeD |
| | (CSI) | | (CSI) | |

A typical QCL configuration method according to Tables 14-1 to 14-5 is configuring the target antenna port and the reference antenna port for respective steps as “SSB”-> “TRS”-> “CSI-RS for CSI, CSI-RS for BM, PDCCH DMRS, or PDSCH DMRS” for operation. Through this, the statistical characteristics being measurable from the SSB and the TRS may be associated with the respective antenna ports, thereby assisting the reception operation of the UE.

[PDCCH: TCI State Related]

Specifically, combinations of TCI states applicable to the PDCCH DMRS antenna port are shown in Table 15 below. The fourth row in Table 15 is a combination assumed by the UE before RRC configuration, and configuring it after RRC is not allowed.

TABLE 15

| Valid | | | DL RS 2 | qcl-Type2 |
|---|---|---|---|---|
| TCI state | DL | | (if | (if |
| Configuration | RS 1 | qcl-Type1 | configured) | configured) |
| 1 | TRS | QCL- | TRS | QCL-TypeD |
| | | TypeA | | |
| 2 | TRS | QCL- | CSI-RS (BM) | QCL-TypeD |
| | | TypeA | | |
| 3 | CSI-RS | QCL- | | |
| | (CSI) | TypeA | | |
| 4 | SS/PBCH | QCL- | SS/PBCH | QCL-TypeD |
| | Block | TypeA | Block | |

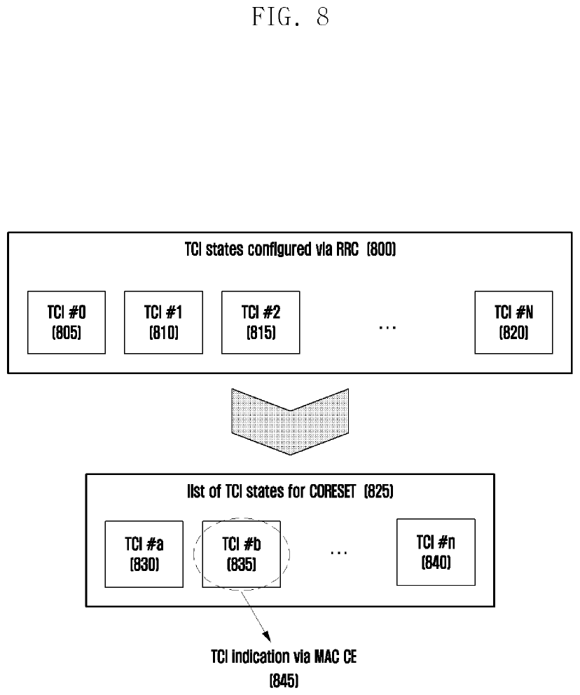

NR supports a hierarchical signaling method illustrated in FIG. 8 for dynamic allocation as to a PDCCH beam. Referring to FIG. 8, the base station may configure N TCI states 805, 810, 815, . . . , 820 for the UE through RRC signaling 800, and some of them may be configured as TCI states for CORESET (825). Thereafter, the base station may indicate one of the TCI states 830, 835 and 840 for CORESET to the UE through MAC CE signaling (845). Then, the UE receives a PDCCH based on beam information included in the TCI state indicated by the MAC CE signaling.

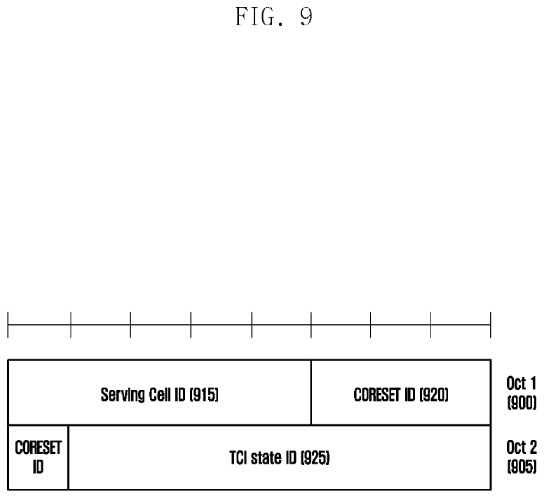

FIG. 9 is a diagram illustrating a structure for TCI indication MAC CE signaling as to PDCCH DMRS. Referring to FIG. 9, TCI indication MAC CE signaling for PDCCH DMRS is composed of 2 bytes (16 bits) and includes a serving cell ID (915) of 5 bits, a CORESET ID (920) of 4 bits, and a TCI state ID (925) of 7 bits.

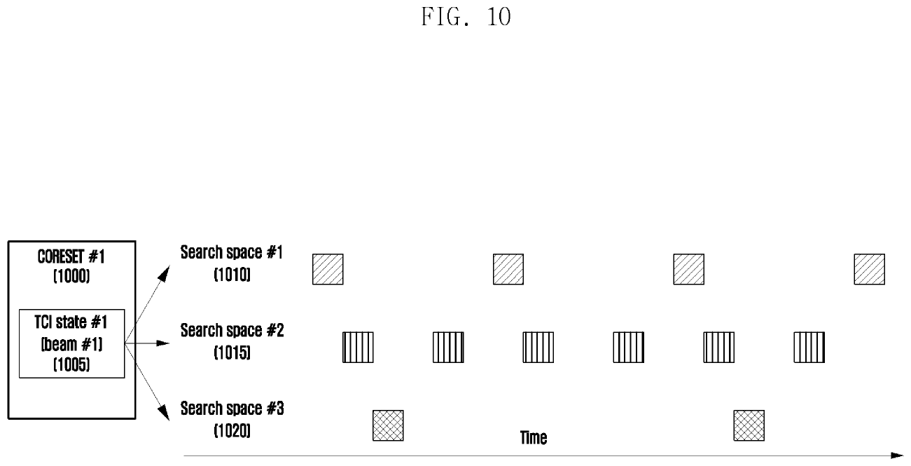

FIG. 10 is a diagram illustrating an example of a control resource set (CORESET) and beam configuration of search spaces according to the above description. Referring to FIG. 10, the base station may indicate one TCI state among the TCI state list included in the configuration of CORESET 1000 through MAC CE signaling (1005). Thereafter, the UE considers that the same QCL information (beam #1, 1005) is applied to one or more search spaces 1010, 1015 and 1020 associated to the CORESET until another TCI state is indicated to the corresponding CORESET through another MAC CE signaling. The above-described PDCCH beam allocation method has a difficulty in indicating a beam change faster than the MAC CE signaling delay and has a disadvantage of collectively applying the same beam per CORESET irrespective of search space characteristics, making flexible PDCCH beam operation difficult. Hereinafter, embodiments of the disclosure provide a more flexible PDCCH beam configuration and operation method. Although several distinct examples will be provided for convenience of describing the embodiments of the disclosure, these are not mutually exclusive and may be applied in appropriate combination depending on the situation.

The base station may configure one or more TCI states to the UE as to a specific control resource set, and may activate one of the configured TCI states through a MAC CE activation command. For example, when {TCI state #0, TCI state #1, TCI state #2} are configured as TCI states for control resource set #1, the base station may transmit an activation command to the UE to assume TCI state #0 as the TCI state for control resource set #1 through MAC CE. According to the activation command for the TCI state received through the MAC CE, the UE may correctly receive a DMRS of the corresponding control resource set based on QCL information in the activated TCI state. For a control resource set with an index of zero (control resource set #0), if the UE fails to receive a MAC CE activation command for the TCI state of control resource set #0, the UE may assume that the DMRS transmitted in control resource set #0 is QCLed with the SS/PBCH block that is identified in the initial access procedure or in the non-contention-based random access procedure that is not triggered by a PDCCH command. For a control resource set with an index of a non-zero value (control resource set #X), if the UE is not configured with a TCI state for control resource set #X, or if the UE is configured with one or more TCI states but fails to receive a MAC CE activation command for activating one of them, the UE may assume that the DMRS transmitted in control resource set #X is QCLed with the SS/PBCH block that is identified in the initial access process.

### [PDCCH: QCL Prioritization Rule Related]

Next, QCL prioritization operation for the PDCCH will be described in detail. In the case where the UE operates on carrier aggregation in a single cell or band and where plural control resource sets present in activated bandwidth parts of a single or multiple cells have the same or different QCL-TypeD characteristics in a specific PDCCH monitoring occasion and overlap in time, the UE may select a specific control resource set according to QCL prioritization operation and monitor control resource sets having the same QCL-TypeD characteristic as the selected control resource set. That is, when multiple control resource sets overlap in time, only one QCL-TypeD characteristic may be received. In this case, the criteria for QCL prioritization may be as follows.
Criterion 1. The control resource set associated to a common search space having the lowest index in a cell corresponding to the lowest index among the cells including common search spaces
Criterion 2. The control resource set associated to a UE-specific search space having the lowest index in a cell corresponding to the lowest index among the cells including UE-specific search spaces

As described above, if each of the above criteria is not met, the next criterion may be applied. For example, when control resource sets overlap in time in a specific PDCCH monitoring period, if all the control resource sets are associated to a UE-specific search space but not to a common search space, that is, if criterion 1 is not met, the UE may omit application of criterion 1 and apply criterion 2.

When selecting control resource sets according to the above-described criteria, the UE may further consider the following two items in relation to QCL information configured in the control resource set. First, if control resource set 1 has CSI-RS 1 as a reference signal having a QCL-TypeD relationship, and a reference signal having a QCL-TypeD relationship with CSI-RS 1 is SSB 1, and if a reference signal with which control resource set 2 has a QCL-TypeD relationship is SSB 1, the UE may consider that two control resource sets 1 and 2 have different QCL-TypeD characteristics. Second, if control resource set 1 has CSI-RS 1 configured in cell 1 as a reference signal having a QCL-TypeD relationship, and a reference signal with which CSI-RS 1 has a QCL-TypeD relationship is SSB 1, and if control resource set 2 has CSI-RS 2 configured in cell 2 as a reference signal having a QCL-TypeD relationship, and a reference signal with which CSI-RS 2 has a QCL-TypeD relationship is SSB 1, the UE may consider that the two control resource sets have the same QCL-TypeD characteristic.

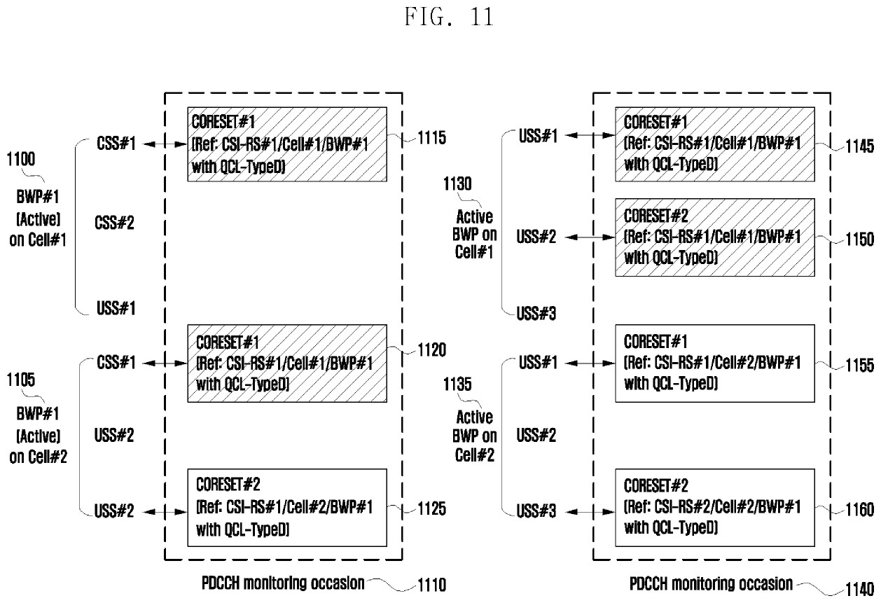

FIG. 11 is a diagram illustrating a method for a UE to select a control resource set that can be received by considering priority when receiving a downlink control channel in a wireless communication system according to an embodiment of the disclosure. For example, the UE may be configured with plural control resource sets (CORESETs) overlapping in time in a specific PDCCH monitoring occasion 1110, and these plural control resource sets may be associated to common search spaces (CSS) or UE-specific search spaces (USS) for a plurality of cells. In the corresponding PDCCH monitoring occasion, a first control resource set 1115 associated to a first common search space may be present in a first bandwidth part 1100 of a first cell, and a first control resource set 1120 associated to a first common search space and a second control resource set 1125 associated to a second UE-specific search space may be present in a first bandwidth part 1105 of a second cell. The control resource sets 1115 and 1120 may have a QCL-TypeD relationship with a first CSI-RS resource configured in the first bandwidth part of the first cell, and the control resource set 1125 may have a QCL-TypeD relationship with a first CSI-RS resource configured in the first bandwidth part of the second cell. Hence, if criterion 1 is applied to the corresponding PDCCH monitoring occasion 1110, all other control resource sets having a reference signal of the same QCL-TypeD as the first control resource set 1115 may be received. So, the UE may receive the control resource sets 1115 and 1120 in the corresponding PDCCH monitoring occasion 1110. As another example, the UE may be configured to receive plural control resource sets overlapping in time in a specific PDCCH monitoring occasion 1140, and these plural control resource sets may be associated to common search spaces or UE-specific search spaces for a plurality of cells. In the corresponding PDCCH monitoring occasion, a first control resource set 1145 associated to a first UE-specific search space and a second control resource set 1150 associated to a second UE-specific search space may be present in a first bandwidth part 1130 of a first cell, and a first control resource set 1155 associated to a first UE-specific search space and a second control resource set 1160 associated to a third UE-specific search space may exist in a first bandwidth part 1135 of a second cell. The control resource sets 1145 and 1150 may have a QCL-TypeD relationship with a first CSI-RS resource configured in the first bandwidth part of the first cell, the control resource set 1155 may have a QCL-TypeD relationship with a first CSI-RS resource configured in the first bandwidth part of the second cell, and the control resource set 1160 may have a QCL-TypeD relationship with a second CSI-RS resource configured in the first bandwidth part of the second cell. However, if criterion 1 is applied to the corresponding PDCCH monitoring occasion 1140, as there is no common search space, so criterion 2 being the next criterion may be applied. If criterion 2 is applied to the corresponding PDCCH monitoring occasion 1140, all other control resource sets having a reference signal of the same QCL-TypeD as the control resource set 1145 may be received. Consequently, the UE may receive the control resource sets 1145 and 1150 in the corresponding PDCCH monitoring occasion 1140.

### [PDSCH: Frequency Resource Allocation Related]

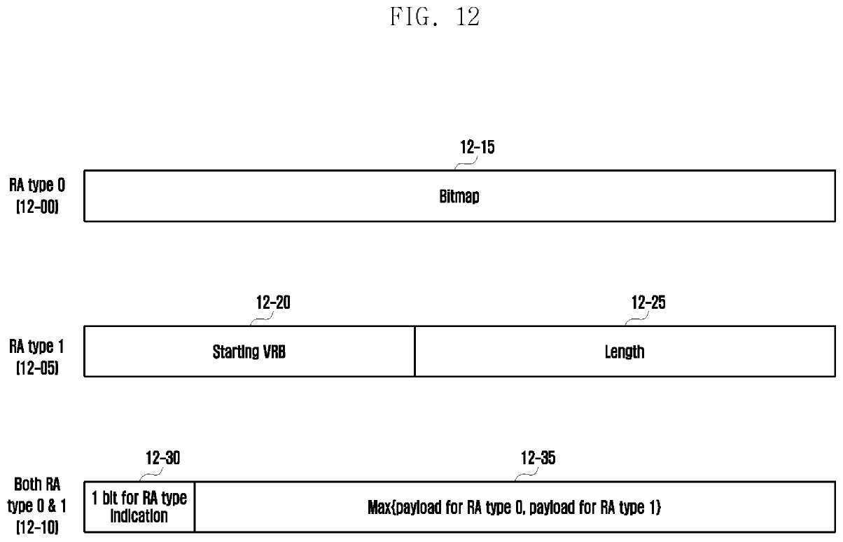

FIG. 12 is a diagram illustrating an example of frequency domain resource assignment of the physical downlink shared channel (PDSCH) in a wireless communication system according to an embodiment of the disclosure.

FIG. 12 is a diagram showing three frequency domain resource assignment methods of type 0 (12-00), type 1 (12-05), and dynamic switch (12-10) that may be configured through a higher layer in an NR wireless communication system.

With reference to FIG. 12, if the UE is configured to use only resource type 0 through higher layer signaling (12-00), some of downlink control information (DCI) allocating the PDSCH to the UE includes a bitmap of NRBG bits. The conditions for this will be described later. Here, NRBG indicates the number of RBGs (resource block groups) determined as shown in Table 16 below according to the BWP size allocated by a BWP indicator and higher layer parameter rbg-Size, and data is transmitted on the RBG indicated to be ‘1’ by the bitmap.

TABLE 16

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 through higher layer signaling (12-05), some DCI for allocating the PDSCH to the UE includes frequency domain resource assignment information composed of ┌log₂(N_{RB}^{DL,BWP}(N_{RB}^{DL,BWP}+1)/2┐ bits. The conditions for this will be described later. Thereby, the base station may configure a starting VRB 12-20 and a length 12-25 of frequency domain resources assigned successively therefrom.

If the UE is configured to use both resource type 0 and resource type 1 through higher layer signaling (12-10), some DCI allocating the PDSCH to the UE includes frequency domain resource assignment information composed of bits corresponding to a larger value 12-35 among a payload 12-15 for configuring resource type 0 and a payload 12-20 and 12-25 for configuring resource type 1. The conditions for this will be described later. In this case, one bit may be prepended to the front part (MSB) of the frequency domain resource assignment information in DCI; if the bit has a value of ‘0’, it may indicate that resource type 0 is used, and if the bit has a value of ‘l’, it may indicate that resource type 1 is used.

### [PDSCH/PUSCH: Time Resource Allocation Related]

Next, a time domain resource assignment method for a data channel in the 5G wireless communication system will be described.

The base station may configure the UE with a table for time domain resource assignment information about a downlink data channel (physical downlink shared channel, PDSCH) and an uplink data channel (physical uplink shared channel, PUSCH) by using higher layer signaling (e.g., RRC signaling). A table composed of up to maxNrofDL-Allocations=16 entries may be configured for the PDSCH, and a table composed of up to maxNrofUL-Allocations=16 entries may be configured for the PUSCH. The time domain resource assignment information may include, for example, PDCCH-to-PDSCH slot timing (corresponding to the time gap in slots between the time at which the PDCCH is received and the time at which the PDSCH scheduled by the received PDCCH is transmitted, denoted by K0), PDCCH-to-PUSCH slot timing (corresponding to the time gap in slots between the time at which the PDCCH is received and the time at which the PUSCH scheduled by the received PDCCH is transmitted, denoted by K2), information about the start position and length of symbols in the slot at which the PDSCH or PUSCH is scheduled, a mapping type for the PDSCH or PUSCH, and the like. For example, information as shown in Table 17 or Table 18 below may be transmitted from the base station to the UE.

TABLE 17
PDSCH-TimeDomainResourceAllocationList information element

PDSCH-TimeDomainResourceAllocationList ::= SEQUENCE (SIZE(1..maxNrofDL-
Allocations)) OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S

| | |
|---|---|
| mappingType | ENUMERATED {typeA, typeB}, |
| startSymbolAndLength | INTEGER (0..127) |
| } | |

TABLE 18
PUSCH-TimeDomainResourceAllocation information element

PUSCH-TimeDomainResourceAllocationList ::= SEQUENCE (SIZE(1..maxNrofUL-
Allocations)) OF PUSCH-TimeDomainResourceAllocation
PUSCH-TimeDomainResourceAllocation ::= SEQUENCE {

| | |
|---|---|
| k2 | INTEGER(0..32) |

OPTIONAL, -- Need S

| | |
|---|---|
| mappingType | ENUMERATED {typeA, |

typeB},

| | |
|---|---|
| startSymbolAndLength | INTEGER (0..127) |

}

The base station may notify the UE of one of the entries in the table for the time domain resource assignment information through L1 signaling (e.g., DCI) (for example, may be indicated by field “time domain resource assignment” in DCI). The UE may obtain time domain resource assignment information for the PDSCH or PUSCH based on the DCI received from the base station.

Next, a frequency domain resource assignment method for a data channel in the 5G wireless communication system will be described.

The 5G wireless communication system supports two types of schemes for indicating frequency domain resource assignment information for a downlink data channel (physical downlink shared channel, PDSCH) and uplink data channel (physical uplink shared channel, PUSCH): resource allocation type 0 and resource allocation type 1.

### Resource Allocation Type 0

RB allocation information may be notified from the base station to the UE in the form of a bitmap for a resource block group (RBG). Here, the RBG may be composed of a set of consecutive virtual RBs (VRBs), and the size P of the RBG may be determined on the basis of a value set by a higher layer parameter (rbg-Size) and the BWP size as defined in the following table.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

A total number (N_{RBG}) of RBGs of bandwidth part i having a size of N_{BWP,i}^{size} may be defined as follows.

N_{RBG}=┌(N_{BWP,i}^{size}+(N_{BWP,i}^{start} mod P))/P┐, where
the size of the first RBG is RBG₀^{size}=P−N_{BWP,i}^{start} mod P,
the size of last RBG is RBGₗₐₛₜ^{size}=(N_{BWP,i}^{start}+N_{BWP,i}^{size})mod P if (N_{BWP,i}^{start}+N_{BWP,i}^{size})mod P>0 and P otherwise,
the size of all other RBGs is P.
Each bit of a bitmap having a size of N_{RBG} bits may correspond to one RBG. RBGs may be assigned indexes according to a sequence in which the frequency increases from the lowest frequency position of a bandwidth part. For N_{RBG} RBGs in a bandwidth part, RBG #0 to RBG #(N_{RBG}−1) may be mapped from the MSB to the LSB of an RBG bitmap. When a particular bit value in a bitmap is 1, the UE may determine that an RBG corresponding to the bit value has been allocated, and when a particular bit value in a bitmap is 0, the UE may determine that an RBG corresponding to the bit value has not been allocated.

### Resource Allocation Type 1

RB allocation information may be notified from the base station to the UE as information relating to the start position and length of consecutively allocated VRBs. Here, interleaving or non-interleaving may be additionally applied to the consecutively allocated VRBs. A resource allocation field of resource allocation type 1 may be composed of a resource indication value (RIV), and the RIV may be composed of the start point (RBₛₜₐᵣₜ) of a VRB and the length (L_{RBs}) of consecutively allocated RBs. More specifically, the RIV of a BWP having a size of N_{BWP}^{size} may be defined as follows.
if (L_{RBs}−1)≤└N_{BWP}^{size}/2┘ then
   RIV=N_{BWP}^{size}(L_{RBs}−1)+RBₛₜₐᵣₜ
else
   RIV=N_{BWP}^{size}(N_{BWP}^{size}−L_{RBs}+1)+(N_{BWP}^{size}−1−RBₛₜₐᵣₜ)
where L_{RBs}≥1 and shall not exceed N_{BWP}^{size}−RBₛₜₐᵣₜ.

The base station may configure the UE with a resource allocation type through higher layer signaling (e.g., a higher layer parameter resourceAllocation may be set to one value among resourceAllocationType0, resourceAllocationType1, or dynamicSwitch). If both resource allocation types 0 and 1 are configured to the UE (or in the same way, the higher layer parameter resourceAllocation is set to dynamicSwitch), a bit corresponding to the most significant bit (MSB) in a resource allocation indication field in the DCI format indicating scheduling may indicate resource allocation type 0 or 1. Additionally, resource allocation information may be indicated through the remaining bits except for the bit corresponding to the MSB on the basis of the indicated resource allocation type, and the UE may interpret resource allocation field information of the DCI field based thereon. If one of resource allocation type 0 or 1 is configured to the UE (or in the same way, the higher layer parameter resourceAllocation is set to resourceAllocationType0 or resourceAllocationType1), a resource allocation indication field in the DCI format indicating scheduling may indicate resource allocation information, based on the configured resource allocation type, and the UE may interpret resource allocation field information of the DCI field based thereon.

### [PDSCH: TCI State Activation MAC CE]

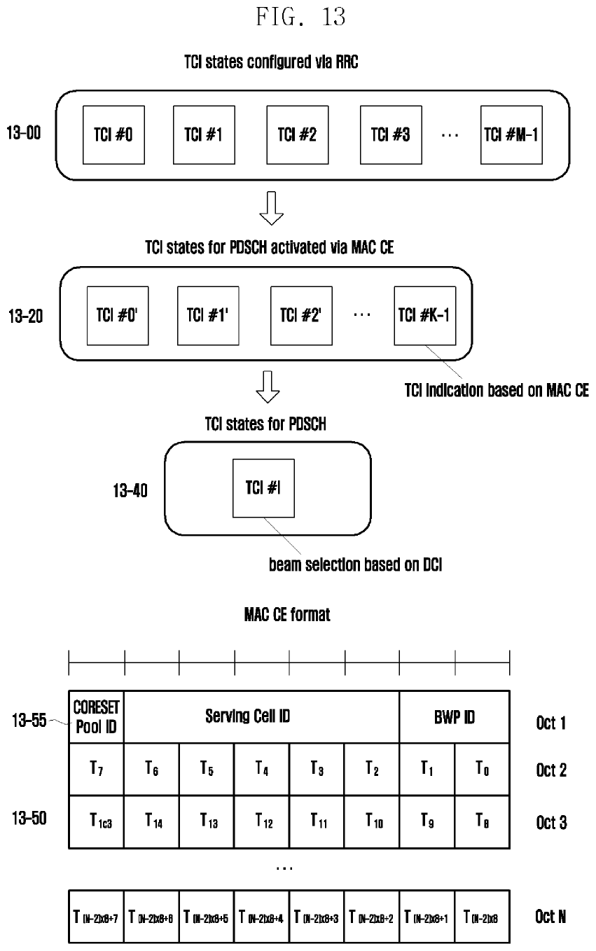

Next, a beam configuration method for the PDSCH will be described. FIG. 13 illustrates a process for beam configuration and activation for the PDSCH. A list of TCI states for the PDSCH may be indicated through a higher layer list such as RRC or the like (13-00). The list of TCI states may be indicated by, for example, tci-States ToAddModList and/or tci-StatesToReleaseList in the PDSCH-Config IE for each BWP. Thereafter, some of the TCI states in the list may be activated through a MAC CE (13-20). Then, some of the TCI states activated through the MAC CE may be selected via the DCI (13-40). The maximum number of activated TCI states may be determined according to the capability reported by the UE. Indicia 13-50 shows an example of a MAC CE format for PDSCH TCI state activation/deactivation.

The meaning of each field in the MAC CE and the values that may be set for each field are as follows.
Serving Cell ID (serving cell identifier): This field indicates the identity of the Serving Cell for which the MAC CE applies. The length of the field is 5 bits. If the indicated Serving Cell is configured as part of a simultaneousTCI-UpdateList1 or simultaneousTCI-UpdateList2 as specified in TS 38.331 [5], this MAC CE applies to all the Serving Cells configured in the set simultaneousTCI-UpdateList1 or simultaneousTCI-UpdateList2, respectively;
BWP ID (bandwidth part identifier): This field indicates a DL BWP for which the MAC CE applies as the codepoint of the DCI bandwidth part indicator field as specified in TS 38.212 [9]. The length of the BWP ID field is 2 bits. This field is ignored if this MAC CE applies to a set of Serving Cells;
Tᵢ (TCI state identifier): If there is a TCI state with TCI-StateId i as specified in TS 38.331 [5], this field indicates the activation/deactivation status of the TCI state with TCI-Stated i, otherwise MAC entity shall ignore the Ti field. The Ti field is set to 1 to indicate that the TCI state with TCI-StateId i shall be activated and mapped to the codepoint of the DCI Transmission Configuration Indication field, as specified in TS 38.214 [7]. The Ti field is set to 0 to indicate that the TCI state with TCI-StateId i shall be deactivated and is not mapped to the codepoint of the DCI Transmission Configuration Indication field. The codepoint to which the TCI State is mapped is determined by its ordinal position among all the TCI States with Ti field set to 1, i.e. the first TCI State with Ti field set to 1 shall be mapped to the codepoint value 0, second TCI State with Ti field set to 1 shall be mapped to the codepoint value 1 and so on. The maximum number of activated TCI states is 8;
CORESET Pool ID (CORESET pool identifier) (13-55): This field indicates that mapping between the activated TCI states and the codepoint of the DCI Transmission Configuration Indication set by field Ti is specific to the ControlResourceSetId configured with CORESET Pool ID as specified in TS 38.331 [5]. This field set to 1 indicates that this MAC CE shall be applied for the DL transmission scheduled by CORESET with the CORESET pool ID equal to 1, otherwise, this MAC CE shall be applied for the DL transmission scheduled by CORESET pool ID equal to 0. If the coresetPoolIndex is not configured for any CORESET, MAC entity shall ignore the CORESET Pool ID field in this MAC CE when receiving the MAC CE. If the Serving Cell in the MAC CE is configured in a cell list that contains more than one Serving Cell, the CORESET Pool ID field shall be ignored when receiving the MAC CE.

### [PUSCH: Transmission Scheme Related]

Next, a scheduling method for PUSCH transmission will be described. PUSCH transmission may be dynamically scheduled by a UL grant in the DCI, or may be operated by configured grant Type 1 or Type 2. Dynamic scheduling indication for PUSCH transmission may be performed through DCI format 0_0 or 0_1.

PUSCH transmission of configured grant Type 1 may be semi-statically configured by reception of configuredGrantConfig including rrc-ConfiguredUplinkGrant shown in Table 20 through higher layer signaling, without receiving a UL grant via the DCI. PUSCH transmission of configured grant Type 2 may be semi-persistently scheduled by a UL grant in DCI after reception of configuredGrantConfig not including rrc-ConfiguredUplinkGrant shown in Table 20 through higher layer signaling. In the case where PUSCH transmission is operated by a configured grant, parameters applied to PUSCH transmission may be applied through higher layer signaling configuredGrantConfig shown in Table 20, except for dataScramblingIdentityPUSCH, txConfig, codebookSubset, maxRank, and scaling of UCI-OnPUSCH, which are provided through higher layer signaling pusch-Config shown in Table 21. If the UE is provided with transformPrecoder in configuredGrantConfig shown in Table 20 through higher layer signaling, the UE applies tp-pi2BPSK in pusch-Config of Table 21 to PUSCH transmission operated by a configured grant.

TABLE 20

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED |

{ resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3- |
| 0000} | OPTIONAL, -- Need R |
| periodicity | ENUMERATED { |
| | sym2, sym7, sym1x14, |

sym2x14, sym4x14, sym5x14, sym8x14, sym10x14, sym16x14, sym20x14,

sym32x14, sym40x14,

sym64x14, sym80x14, sym128x14, sym160x14, sym256x14, sym320x14, sym512x14,

sym640x14, sym1024x14,

sym1280x14, sym2560x14, sym5120x14,

sym6, sym1x12, sym2x12,

sym4x12, sym5x12, sym8x12, sym10x12, sym16x12, sym20x12, sym32x12,

sym40x12, sym64x12,

sym80x12, sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks−1) | OPTIONAL, -- Need R |
| pathlossReferenceIndex | INTEGER (0..maxNrofPUSCH- |

```
PathlossReferenceRSs−1),
    ...
  }
OPTIONAL, -- Need R
  ...
}
```

Next, a PUSCH transmission method will be described. The DMRS antenna port for PUSCH transmission is the same as the antenna port for SRS transmission. PUSCH transmission may be performed using a codebook-based transmission method or a non-codebook-based transmission method depending on whether the value of txConfig in higher layer signaling pusch-Config of Table 21 is “codebook” or “nonCodebook”. As described above, PUSCH transmission may be dynamically scheduled through DCI format 0_0 or 0_1, and may be semi-statically configured by a configured grant. If the UE is notified of scheduling of PUSCH transmission by DCI format 0_0, the UE performs beam configuration for PUSCH transmission by using pucch-spatialRelationInfoID associated with a UE-specific PUCCH resource corresponding to the minimum ID in the uplink BWP activated in the serving cell, and PUSCH transmission is based on a single antenna port in this case. The UE does not expect scheduling for PUSCH transmission through DCI format 0_0 in the BWP where a PUCCH resource including pucch-spatialRelationInfo is not configured. If the UE is not configured with txConfig in pusch-Config shown in Table 21, the UE does not expect scheduling through DCI format 0_1.

TABLE 21

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, |
| interSlot} | OPTIONAL, -- Need S |
| frequencyHoppingOffsetLists | SEQUENCE (SIZE (1..4)) OF |

```
    INTEGER (1..maxNrofPhysicalResourceBlocks−1)
    OPTIONAL, -- Need M
```

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED |

{fullyAndPartialAndNonCoherent, partialAndNonCoherent, nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission will be described. Codebook-based PUSCH transmission may be dynamically scheduled through DCI format 0_0 or 0_1, and may be operated semi-statically by a configured grant. If a codebook-based PUSCH is dynamically scheduled by DCI format 0_1 or is semi-statically configured by a configured grant, the UE determines a precoder for PUSCH transmission based on an SRS resource indicator (SRI), a transmission precoding matrix indicator (TPMI), and a transmission rank (the number of PUSCH transmission layers).

Here, the SRI may be given through a SRS resource indicator field in DCI or may be configured through higher layer signaling srs-ResourceIndicator. The UE may be configured with at least one SRS resource during codebook-based PUSCH transmission, and may be configured with up to two SRS resources. When the UE is provided with the SRI through DCI, the SRS resource indicated by the SRI indicates an SRS resource corresponding to the SRI among the SRS resources transmitted prior to the PDCCH including the SRI. Additionally, the TPMI and the transmission rank may be given through a field of precoding information and number of layers in DCI, or may be configured through higher layer signaling precodingAndNumberOfLayers. The TPMI is used to indicate a precoder applied to PUSCH transmission. When the UE is configured with one SRS resource, the TPMI is used to indicate the precoder to be applied in the configured SRS resource. When the UE is configured with a plurality of SRS resources, the TPMI is used to indicate a precoder to be applied in the SRS resource indicated by the SRI.

The precoder to be used for PUSCH transmission is selected from an uplink codebook having the same number of antenna ports as the value of nrofSRS-Ports in higher layer signaling SRS-Config. In codebook-based PUSCH transmission, the UE determines a codebook subset based on the TPMI and codebookSubset in higher layer signaling pusch-Config. CodebookSubset in higher layer signaling pusch-Config may be set to one of “fully AndPartialAndNonCoherent”, “partialAndNonCoherent”, and “noncoherent” on the basis of the UE capability reported by the UE to the base station. If the UE has reported “partial AndNonCoherent” as UE capability, the UE does not expect that the value of higher layer signaling codebookSubset is set to “fully AndPartialAndNonCoherent”. In addition, if the UE has reported “noncoherent” as UE capability, the UE does not expect that the value of higher layer signaling codebookSubset set to “fully AndPartialAndNonCoherent” or “partial AndNonCoherent”. If nrofSRS-Ports in higher layer signaling SRS-ResourceSet indicates two SRS antenna ports, the UE does not expect that the value of higher layer signaling codebookSubset is set to “partialAndNonCoherent”.

The UE may be configured with one SRS resource set in which the value of usage in higher layer signaling SRS-ResourceSet is set to “codebook”, and one SRS resource in the corresponding SRS resource set may be indicated by the SRI. If several SRS resources are configured in the SRS resource in which the value of usage in higher layer signaling SRS-ResourceSet is set to “codebook”, the UE expects that nrofSRS-Ports in higher layer signaling SRS-Resource is set to the same value for all the SRS resources. The UE transmits, to the base station, one or multiple SRS resources included in the SRS resource set in which the value of usage is set to “codebook” according to higher layer signaling, and the base station selects one of the SRS resources transmitted by the UE and instructs the UE to perform PUSCH transmission by using transmit beam information of the selected SRS resource. Here, in codebook-based PUSCH transmission, the SRI may be used as information for selecting the index of one SRS resource and may be included in the DCI. Additionally, the base station includes information indicating the TPMI and rank to be used by the UE for PUSCH transmission in the DCI. The UE may use the SRS resource indicated by the SRI to perform PUSCH transmission by applying the rank indicated based on the transmit beam of the SRS resource and the precoder indicated by the TPMI.

Next, non-codebook-based PUSCH transmission will be described. Non-codebook-based PUSCH transmission may be dynamically scheduled through DCI format 0_0 or 0_1 and may be semi-statically operated by a configured grant. If at least one SRS resource is configured in the SRS resource set in which the value of usage in higher layer signaling SRS-ResourceSet is set to “nonCodebook”, the UE may be scheduled with non-codebook-based PUSCH transmission through DCI format 0_1.

The UE may be configured with one NZP CSI-RS resource (non-zero power CSI-RS) associated to the SRS resource set in which the value of usage in SRS-ResourceSet is set to “nonCodebook” through higher layer signaling. The UE may perform a calculation on the precoder for SRS transmission by measuring the NZP CSI-RS resource associated with the SRS resource set. If the difference between the last received symbol of the aperiodic NZP CSI-RS resource associated with the SRS resource set and the first symbol of aperiodic SRS transmission in the UE is less than 42 symbols, the UE does not expect that the information on the precoder for SRS transmission will be updated.

If the value of resourceType in higher layer signaling SRS-ResourceSet is set to “aperiodic”, the associated NZP CSI-RS is indicated by a SRS request being a field in DCI format 0_1 or 1_1. In this case, if the associated NZP CSI-RS resource is an aperiodic NZP CSI-RS resource and the value of the SRS request field in DCI format 0_1 or 1_1 is not ‘00’, this may indicate that there is an NZP CSI-RS associated to the SRS resource set. Here, the corresponding DCI should not indicate cross carrier or cross BWP scheduling. Additionally, if the value of the SRS request indicates the presence of an NZP CSI-RS, the corresponding NZP CSI-RS is positioned in the slot in which the PDCCH including the SRS request field is transmitted. Here, the TCI state configured in the scheduled subcarrier is not configured as QCL-TypeD.

If a periodic or semi-persistent SRS resource set is configured, an associated NZP CSI-RS may be indicated by associatedCSI-RS in higher layer signaling SRS-ResourceSet. For non-codebook-based transmission, the UE does not expect that both spatialRelationInfo being higher layer signaling for the SRS resource and associatedCSI-RS in higher layer signaling SRS-ResourceSet are configured together. If the UE is configured with plural SRS resources, it may determine the precoder and transmission rank to be applied to PUSCH transmission based on the SRI indicated by the base station. Here, the SRI may be indicated through a SRS resource indicator field in DCI or may be configured through higher layer signaling srs-ResourceIndicator. Like codebook-based PUSCH transmission described above, if the UE is provided with the SRI through DCI, the SRS resource indicated by the SRI indicates the SRS resource corresponding to the SRI among the SRS resources transmitted prior to the PDCCH including the SRI. The UE may use one or multiple SRS resources for SRS transmission, and the maximum number of SRS resources and the maximum number of SRS resources that can be simultaneously transmitted at the same symbol in one SRS resource set are determined by the UE capability reported by the UE to the base station. Here, the SRS resources simultaneously transmitted by the UE occupy the same RB. The UE configures one SRS port for each SRS resource. Only one SRS resource set in which the value of usage in higher layer signaling SRS-ResourceSet is set to “nonCodebook” may be configured, and up to four SRS resources may be configured for non-codebook-based PUSCH transmission.

The base station transmits one NZP-CSI-RS associated with the SRS resource set to the UE, and the UE calculates a precoder to be used for transmission of one or multiple SRS resources in the corresponding SRS resource set based on measurement results obtained upon receiving the NZP-CSI-RS. The UE applies the calculated precoder when transmitting one or multiple SRS resources in the SRS resource set in which the usage is set to “nonCodebook” to the base station, and the base station selects one or more of the received one or multiple SRS resources. Here, in non-codebook-based PUSCH transmission, the SRI indicates an index capable of representing one SRS resource or a combination of plural SRS resources, and this SRI is included in the DCI. In this case, the number of SRS resources indicated by the SRI transmitted by the base station may be the number of transmission layers of the PUSCH, and the UE performs PUSCH transmission by applying the precoder applied to SRS resource transmission to each layer.

### [PUSCH: Preparation Procedure Time]

Next, the PUSCH preparation procedure time will be described. In the case where the base station schedules the UE to transmit a PUSCH by using DCI format 0_0 or DCI format 0_1, the UE may require a PUSCH preparation procedure time for transmitting a PUSCH by applying the transmission method indicated by the DCI (transmission precoding scheme for SRS resources, number of transmission layers, and spatial domain transmission filter). In NR, a PUSCH preparation procedure time is defined in consideration of this. The PUSCH preparation procedure time of the UE may follow Equation 2 below.

$${T}_{proc , 2} = max ( ( {N}_{2} + {d}_{2 , 1} + {d}_{2} ) ( 2048 + 144 ) {κ2}^{- μ} {T}_{c} + {T}_{ext} + {T}_{switch} , {d}_{2 , 2} ) \qquad [ Equation 2 ]$$

Variables in T_{proc,2} described above may have the following meanings.
N₂: the number of symbols determined based on UE processing capability 1 or 2 according to the UE capability and numerology μ. It may have the values shown in Table 22 in the case where UE processing capability 1 is reported according to the UE capability report, and may have the values shown in Table 23 in the case where UE processing capability 2 is reported and the availability of UE processing capability 2 is set through higher layer signaling.

TABLE 22

| | PUSCH preparation time N₂ |
|---|---|
| μ | [symbols] |
| 0 | 10 |
| 1 | 12 |
| 2 | 23 |
| 3 | 36 |

TABLE 23

| | PUSCH preparation time N₂ |
|---|---|
| μ | [symbols] |
| 0 | 5 |
| 1 | 5.5 |
| 2 | 11 for frequency range 1 |

d_{2,1}: the number of symbols determined to be ‘0’ if all resource elements of the first OFDM symbol of PUSCH transmission are composed of only DM-RSs, otherwise determined to be ‘1’.
κ: 64
μ: it follows one of μ_{DL} and μ_{UL} that makes T_{proc,2} larger. μ_{DL} indicates the numerology of a downlink in which the PDCCH including the DCI scheduling the PUSCH is transmitted, and μ_{UL} indicates the numerology of an uplink in which the PUSCH is transmitted.
T_{c}: it has 1/(Δfₘₐₓ·N_{f}), where Δfₘₐₓ=480·10³ Hz and N_{f}=4096.
d_{2,2}: it follows a BWP switching time if the DCI scheduling the PUSCH indicates BWP switching, otherwise it is ‘0’.
d₂: if OFDM symbols of the PUCCH, the PUSCH having a high priority index, and the PUCCH having a low priority index overlap in time, the value d₂ of the PUSCH having a high priority index is used. Otherwise, d₂ is ‘0’.
Tₑₓₜ: if the UE uses a shared spectrum channel access scheme, the UE may calculate Tₑₓₜ and apply it to the PUSCH preparation procedure time. Otherwise, Tₑₓₜ is assumed to be ‘0’.
T_{switch}: if an uplink switching interval is triggered, T_{switch} is assumed to be a switching interval time. Otherwise, it is assumed to be ‘0’.

Considering time domain resource mapping information of the PUSCH scheduled through the DCI and the influence of a timing advance (TA) between uplink and downlink, if the first symbol of the PUSCH starts earlier than the first uplink symbol at which CP starts after T_{proc,2} from the last symbol of the PDCCH including the DCI having scheduled the PUSCH, the base station and the UE determine that the PUSCH preparation procedure time is not sufficient. Otherwise, the base station and the UE determine that the PUSCH preparation procedure time is sufficient. The UE may transmit the PUSCH only if the PUSCH preparation procedure time is sufficient, and may ignore the DCI having scheduled the PUSCH if the PUSCH preparation procedure time is not sufficient.

Next, repetitive PUSCH transmission will be described. When the UE is scheduled with PUSCH transmission via DCI format 0_1 in the PDCCH including a CRC scrambled with C-RNTI, MCS-C-RNTI or CS-RNTI, and if the UE is configured with higher layer signaling pusch-AggregationFactor, the same symbol assignment is applied in consecutive slots as many as pusch-AggregationFactor, and the PUSCH transmission is limited to single-rank transmission. For example, the UE should repeat the same TB in consecutive slots as many as pusch-AggregationFactor, and should apply the same symbol assignment in each slot. Table 24 shows the redundancy version applied to repetitive PUSCH transmission in each slot. If the UE is scheduled with DCI format 0_1 for repetitive PUSCH transmission in multiple slots, and at least one symbol among the slots in which repetitive PUSCH transmission is performed is indicated as a downlink symbol according to information of tdd-UL-DL-ConfigurationCommon or tdd-UL-DL-ConfigurationDedicated being higher layer signaling, the UE does not perform PUSCH transmission in the slot in which the corresponding symbol is positioned.

TABLE 24

| rv_{id} indicated | rv_{id} to be applied to n^{th} transmission occasion | | | |
|---|---|---|---|---|
| by the DCI scheduling | n mod | n mod | n mod | n mod |
| the PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

### [PUSCH: Repetitive Transmission Related]

Next, repetitive transmission of an uplink data channel in a 5G system will be described in detail. As repetitive transmission methods of an uplink data channel, the 5G system supports two types, i.e., PUSCH repetition type A and PUSCH repetition type B. The UE may be configured with one of PUSCH repetition type A and PUSCH repetition type B through higher layer signaling.

### Pusch Repetition Type A

As described above, the symbol length of an uplink data channel and the position of a start symbol thereof may be determined in one slot by a time domain resource assignment method, and the base station may notify the UE of the number of repetitions through higher layer signaling (e.g., RRC signaling) or L1 signaling (e.g., DCI).
The UE may repeatedly transmit the same uplink data channel in consecutive slots of the repetitive transmission section identified according to the length of the uplink data channel set based on the start symbol and the number of repetitions. At this time, if there is a slot configured by the base station to the UE as downlink in the repetitive transmission section, or at least one symbol configured as downlink among the symbols of the uplink data channel configured to the UE, the UE omits uplink data channel transmission in the corresponding slot or symbol but counts the number of repetitions for the uplink data channel.

PUSCH repetition type B
As described above, the symbol length of an uplink data channel and the position of a start symbol thereof may be determined in one slot by a time domain resource assignment method, and the base station may notify the UE of the number of repetitions numberofrepetitions through higher layer signaling (e.g., RRC signaling) or L1 signaling (e.g., DCI).
First, based on the start symbol and length of the configured uplink data channel, the nominal repetition of the uplink data channel is determined as follows. The slot where the n^{th} nominal repetition starts is given by

$${K}_{s} + ⌊ \frac{S + n \cdot L}{{N}_{symb}^{slot}} ⌋$$

and the symbol starting in that slot is given by mod(S+n·L,N_{symb}^{slot}). The slot where the n^{th} nominal repetition ends is given by

$${K}_{s} + ⌊ \frac{S + ( n + 1 ) \cdot L - 1}{{N}_{symb}^{slot}} ⌋$$

and the symbol ending in that slot is given by mod(S+(n+1)·L−1,N_{symb}^{slot}). Here, n=0, . . . , numberofrepetitions-1, S indicates the start symbol of the configured uplink data channel, and L indicates the symbol length of the configured uplink data channel. Kₛ indicates the slot where PUSCH transmission starts, and N_{symb}^{slot} indicates the number of symbols per slot.
For PUSCH repetition type B, the UE may determine a specific OFDM symbol as an invalid symbol in the following cases.

1. The symbol configured as downlink by tdd-UL-DL-ConfigurationCommon or tdd-UL-DL-ConfigurationDedicated may be determined as an invalid symbol for PUSCH repetition type B.

2. In unpaired spectrum (TDD spectrum), symbols indicated for SSB reception by ssb-PositionsInBurst in SIB1 or ssb-PositionsInBurst in ServingCellConfigCommon being higher layer signaling may be determined as an invalid symbol for PUSCH repetition type B.

3. In unpaired spectrum (TDD spectrum), symbols indicated through pdcch-ConfigSIBI in the MIB to transmit a control resource set associated with Type0-PDCCH CSS set may be determined as an invalid symbol for PUSCH repetition type B.

4. In unpaired spectrum (TDD spectrum), if higher layer signaling numberOfInvalidSymbolsForDL-UL-Switching is configured, the symbol duration from the symbol configured as downlink by tdd-UL-DL-ConfigurationCommon or tdd-UL-DL-ConfigurationDedicated as many as numberOfInvalidSymbolsForDL-UL-Switching may be determined as invalid symbols.
Additionally, invalid symbols may be configured by a higher layer parameter (e.g., InvalidSymbolPattern). A higher layer parameter (e.g. InvalidSymbolPattern) may provide a symbol-level bitmap spanning one or two slots so as to configure invalid symbols. In the bitmap, ‘1’ indicates an invalid symbol. Additionally, the periodicity and pattern of the bitmap may be configured via a higher layer parameter (e.g., periodicity AndPattern). When the higher layer parameter (e.g. InvalidSymbolPattern) is configured, if parameter InvalidSymbolPatternIndicator-ForDCIFormat0_1 or

InvalidSymbolPatternIndicator-ForDCIFormat0_2 indicates ‘1’, the UE applies the invalid symbol pattern, and if the parameter indicates ‘0’, the UE does not apply the invalid symbol pattern. When the higher layer parameter (e.g. InvalidSymbolPattern) is configured, if parameter InvalidSymbolPatternIndicator-ForDCIFormat0_1 or InvalidSymbolPatternIndicator-ForDCIFormat0_2 is not configured, the UE applies the invalid symbol pattern.

After the invalid symbol is determined, for each nominal repetition, the UE may consider symbols other than the invalid symbol as valid symbols. If one or more valid symbols are included in each nominal repetition, the nominal repetition may include one or more actual repetitions. Here, each of the actual repetitions includes a set of consecutive valid symbols in one slot that may be used for PUSCH repetition type B. When the OFDM symbol length of the nominal repetition is not 1, if the length of the actual repetition is 1, the UE may ignore the transmission for the corresponding actual repetition.

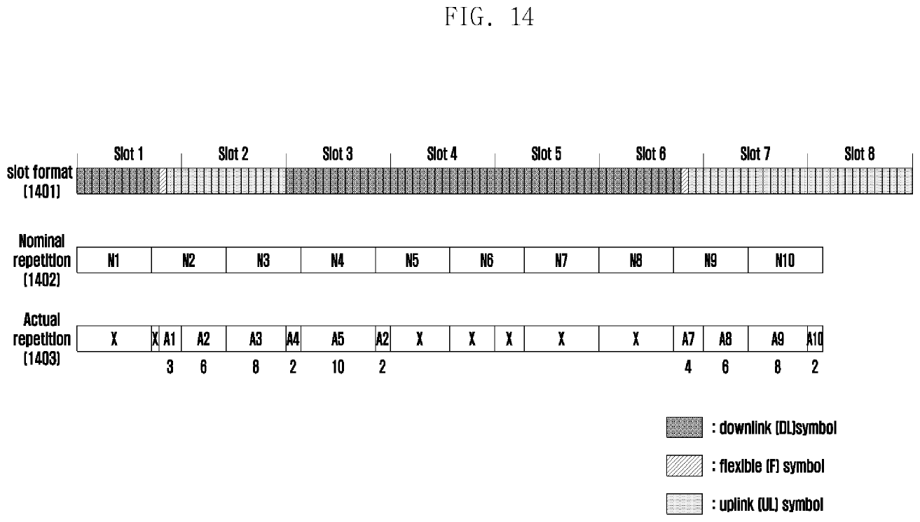

FIG. 14 illustrates an example of PUSCH repetition type B according to an embodiment of the disclosure.

In FIG. 14, the UE is configured for the nominal repetition with transmission start symbol S set to 0, transmission symbol length L set to 10, and number of repetitions set to 10, which may be represented as N1 to N10 in the drawing (1402). Here, the UE may identify invalid symbols with reference to the slot format 1401 to determine the actual repetition, which may be represented as A1 to A10 in the drawing (1403). At this time, according to the method for determining invalid symbols and actual repetitions described above, PUSCH repetition type B is not performed at a symbol that is configured as downlink (DL) by the slot format, and if there is a slot boundary within a nominal repetition, the nominal repetition may be divided into two actual repetitions for transmission based on the slot boundary. For example, the first actual repetition denoted by A1 may be composed of 3 OFDM symbols, and the actual repetition denoted by A2, which may be transmitted next, may be composed of 6 OFDM symbols.

In addition, for repetitive PUSCH transmission, in NR Release 16, the following methods may be further defined for UL grant-based PUSCH transmission and configured grant-based PUSCH transmission across a slot boundary.
Method 1 (mini-slot level repetition): two or more repetitive PUSCH transmissions are scheduled within one slot or across the boundaries of consecutive slots via one UL grant. In addition, for method 1, the time domain resource assignment information in DCI indicates the resource of the first repetitive transmission. In addition, time domain resource information of the remaining repetitive transmissions may be determined according to the time domain resource information of the first repetitive transmission and the uplink or downlink direction set for each symbol in each slot. Each repetitive transmission occupies consecutive symbols.
Method 2 (multi-segment transmission): two or more repetitive PUSCH transmissions are scheduled in consecutive slots via one UL grant. In this case, one transmission is designated for each slot, and the individual transmissions may have different start points or different repetition lengths. Additionally, in method 2, the time domain resource assignment information in the DCI indicates the start point and repetition length of all repetitive transmissions. Additionally, in the case of performing repetitive transmission in a single slot by using method 2, if there are multiple bundles of consecutive uplink symbols in the corresponding slot, repetitive transmission is performed for each bundle of uplink symbols. If there is a single bundle of consecutive uplink symbols in the corresponding slot, repetitive PUSCH transmission is performed once according to the method of NR Release 15.
Method 3: two or more repetitive PUSCH transmissions are scheduled in consecutive slots via two or more UL grants. In this case, one transmission is designated for each slot, and the n^{th} UL grant may be received before PUSCH transmission scheduled by the (n−1)^{th} UL grant is finished.
Method 4: one or multiple repetitive PUSCH transmissions in a single slot, or two or more repetitive PUSCH transmissions across the boundaries of consecutive slots may be supported through one UL grant or one configured grant. The number of repetitions indicated by the base station to the UE is simply a nominal value, and the number of repetitive PUSCH transmissions actually performed by the UE may be greater than the nominal number of repetitions. The time domain resource assignment information in the DCI or in the configured grant indicates the resource of the first repetitive transmission indicated by the base station. The time domain resource information of the remaining repetitive transmissions may be determined with reference to at least the resource information of the first repetitive transmission and the uplink or downlink directions of the symbols. If the time domain resource information of the repetitive transmission indicated by the base station crosses the slot boundary or includes an uplink/downlink switch point, this repetitive transmission may be divided into a plurality of repetitive transmissions. Here, one repetitive transmission may be included in one slot for each uplink period.

### [Rate Matching for UCI Multiplexed on PUSCH]

Next, rate matching for uplink control information (UCI) in the 5G system will be described in detail. First, before explaining rate matching for UCI, a description is given of the cases where UCI is multiplexed on the PUSCH. If the PUCCH and the PUSCH overlap and the timeline condition for UCI multiplexing is satisfied, the UE may multiplex HARQ-ACK and/or CSI information included in the PUCCH on the PUSCH according to the UCI information included in the PUSCH and may not transmit the PUCCH. Here, for the timeline condition for UCI multiplexing, reference may be made to clause 9.2.5 of 3GPP specification TS 38.213. As an example of a timeline condition for UCI multiplexing, when one of PUCCH transmission and PUSCH transmission is scheduled via the DCI, the UE may perform UCI multiplexing only if the first symbol S₀ of the earliest one among the PUCCH and the PUSCH overlapping in a slot satisfies the following condition:
S₀ is not a symbol that is transmitted earlier than a symbol including a CP starting after T_{proc,1}^{mux} from the last symbol of the corresponding PDSCH. Here, T_{proc,1}^{mux} is the maximum value among {T_{proc,1}^{mux,1}, . . . T_{proc,1}^{mux,i}, . . . } for the i^{th} PDSCH associated with the HARQ-ACK transmitted on the PUCCH in the overlapping PUCCH and PUSCH group. T_{proc,1}^{mux,1} is the processing procedure time for the i^{th} PDSCH and is defined as T_{proc,1}^{mux,i}=(N₁+d_{1,1})·(2048+14)·κ·2^{-μ}·T_{c}. Here, d_{1,1} is a value determined for the i^{th} PDSCH with reference to clause 5.3 of 3GPP specification TS 38.214, and N1 is a PDSCH processing time value according to the PDSCH processing capability. Additionally, μ is the smallest subcarrier configuration value among all PUSCHs such as the PDCCH scheduling the i^{th} PDSCH, the i^{th} PDSCH, the PUCCH including HARQ-ACK for the i^{th} PDSCH, and the overlapping PUCCH and PUSCH group. T_{c} is 1/(Δfₘₐₓ·N_{f}) where Δfₘₐₓ=480·10³ Hz and N_{f}4096, and κ is 64.

This is a part of the timeline condition for UCI multiplexing, and when all conditions are satisfied with reference to clause 9.2.5 of 3GPP specification TS 38.213, the UE can perform UCI multiplexing on the PUSCH.

If the PUCCH and the PUSCH overlap, the timeline condition for UCI multiplexing is satisfied, and the UE has determined to multiplex the UCI included in the PUCCH on the PUSCH, the UE performs UCI rate matching for UCI multiplexing. UCI multiplexing is performed in the order of HARQ-ACK and CG-UCI (configured grant uplink control information), CSI part 1, and CSI part 2. The UE performs rate matching in consideration of the UCI multiplexing order. Hence, the UE calculates the coded modulation symbols per layer for HARQ-ACK and CG-UCI, and then calculates the coded modulation symbols per layer for CSI part 1 in consideration of them. Thereafter, the UE calculates the coded modulation symbols per layer for CSI part 2 by considering the coded modulation symbols per layer for HARQ-ACK, CG-UCI, and CSI part 1. When performing rate matching according to each UCI type, the method for calculating the number of coded modulation symbols per layer is different depending on the type of repetitive transmission of the PUSCH on which the UCI is multiplexed and whether uplink data (uplink shared channel, hereinafter referred to as UL-SCH) is present. For example, when performing rate matching for HARQ-ACK, the coded modulation symbols per layer according to the PUSCH on which the UCI is multiplexed may be calculated by using the following equations.

$${Q}_{ACK}^{′} = \qquad [ Equation 3 ]$$

$$min \{ ⌈ \frac{( {O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \}$$

$${Q}_{ACK}^{′} = \qquad [ Equation 4 ]$$

$$min \{ ⌈ \frac{( {O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ , {\sum }_{l = 0}^{{N}_{symb , actual}^{PUSCH} - 1} {M}_{sc , actual}^{UCI} ( l ) \}$$

$${Q}_{ACK}^{′} = \qquad [ Equation 5 ]$$

$$min \{ ⌈ \frac{( {O}_{ACK} + {L}_{ACK} ) \cdot {β}_{offset}^{PUSCH}}{R \cdot {Q}_{m}} ⌉ , ⌈ α \cdot {\sum }_{l = {l}_{0}}^{{N}_{symb , all}^{PUSCH} - 1} {M}_{sc}^{UCI} ( l ) ⌉ \}$$

Equation 3 is used for calculating the coded modulation symbols per layer for HARQ-ACK multiplexed on the PUSCH of non repetition type B with UL-SCH, and Equation 4 is used for calculating the coded modulation symbols per layer for HARQ-ACK multiplexed on the PUSCH of repetition type B with UL-SCH. Equation 5 is used for calculating the coded modulation symbols per layer for HARQ-ACK multiplexed on the PUSCH without UL-SCH. In Equation 3, O_{ACK} is the number of HARQ-ACK bits. L_{ACK} is the number of CRC bits for HARQ-ACK. β_{offset}^{PUSCH} is the beta offset for HARQ-ACK and is equal to β_{offset}^{HARQ-ACK}. C_{UL-SCH} is the number of code blocks of UL-SCH for PUSCH transmission, and Kᵣ is the code block size of the r^{th} code block. M_{sc}^{UCI}(l) means the number of resource elements that may be used for UCI transmission in symbol [symbol] , and the number is determined depending on whether DMRS and PTRS are present in symbol [symbol] . If symbol [symbol] includes DMRS, M_{sc}^{UCI}(l)=0. For symbol [symbol] not including DMRS, M_{sc}^{UCI}(l)=M_{sc}^{PUSCH}−M_{SC}^{PT-RS}(l). M_{sc}^{PUSCH} is the number of subcarriers in the scheduled bandwidth for PUSCH transmission, and M_{sc}^{PT-RS}(l) is the number of subcarriers including PTRS in symbol [symbol] . N_{symb,all}^{PUSCH} represents the total number of symbols of the PUSCH. [symbol] is given by higher layer parameter scaling, and means the ratio of resources for UCI multiplexing to the resources for the entire PUSCH transmission. [symbol] _{O} indicates the index of the first symbol that does not include DMRS after the first DMRS. In Equation 4, M_{sc,nominal}^{UCI}(l) indicates the number of resource elements that may be used for UCI transmission with nominal repetition, and is 0 for a symbol including DMRS and is M_{sc,nominal}^{UCI}(l)=M_{sc}^{PUSCH}−M_{sc,nominal}^{PT-RS}(l) for a symbol not including DMRS, where M_{sc,nominal}^{PT-RS}(l) is the number of subcarriers that include PTRS in symbol [symbol] for the PUSCH assuming nominal repetition. N_{symb,nominal}^{PUSCH} denotes the total number of symbols in a nominal repetition of the PUSCH. M_{sc,actual}^{UCI}(l) indicates the number of resource elements that may be used for UCI transmission in the actual repetition, and is 0 for a symbol including DMRS and is M_{sc,actual}^{UCI}(l)=M_{sc}^{PUSCH}−M_{sc,actual}^{PT-RS}(l) for a symbol not including DMRS, where M_{sc,actual}^{PT-RS}(l) is the number of subcarriers containing PTRS in symbol [symbol] for the actual repetition of the PUSCH. N_{symb,actual}^{PUSCH} smactual represents the total number of symbols for the actual repetition of the PUSCH. In Equation 5, R is the code rate of the PUSCH and Qₘ is the modulation order of the PUSCH. The number of coded modulation symbols per layer for performing rate matching of CSI part 1 may be calculated similarly to HARQ-ACK, but the maximum number of allocable resources among the total resources is reduced to the value excluding the number of coded modulation symbols for HARQ-ACK/CG-UCI. The coded modulation symbols per layer for CSI part 1 may be calculated by using Equation 6, Equation 7, Equation 8, or Equation 9 depending on the PUSCH repetition type and whether UL-SCH is present.

$${Q}_{CSI - 1}^{′} = \qquad [ Equation 6 ]$$

$$min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$$

$${Q}_{CSI - 1}^{′} = \qquad [ Equation 7 ]$$

$$min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} \}$$

$${Q}_{CSI - 1}^{′} = \qquad [ Equation 8 ]$$

$$min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$$

$${Q}_{CSI - 1}^{′} = {\sum }_{l = 0}^{{N}_{symb , all}^{PUSCH} - 1} {M}_{sc}^{UCI} ( l ) - {Q}_{ACK}^{′} \qquad [ Equation 9 ]$$

Equation 6 is used for calculating the coded modulation symbols per layer for CSI part 1 multiplexed on the PUSCH of non repetition type B with UL-SCH, Equation 7 is used for calculating the coded modulation symbols per layer for CSI part 1 multiplexed on the PUSCH of repetition type B with UL-SCH. Equation 8 is used for calculating the coded modulation symbols per layer for CSI part 1 when CSI part 1 and CSI part 2 are multiplexed on the PUSCH without UL-SCH. Equation 9 is used for calculating the coded modulation symbols per layer for CSI part 1 multiplexed on the PUSCH without UL-SCH when CSI part 2 is not multiplexed. In Equation 6, O_{CSI-1} and L_{CSI-1} represent the number of bits for CSI part 1 and the number of CRC bits for CSI part 1, respectively. β_{offset}^{PUSCH} is the beta offset for CSI part 1 and is equal to β_{offset}^{CSI-part1}. Q_{ACK/CG-UCI} is the number of coded modulation symbols per layer calculated for HARQ-ACK and/or CG-UCI. The other parameters are the same as those required to calculate the number of coded modulation symbols per layer for HARQ-ACK. The number of coded modulation symbols per layer for performing rate matching of CSI part 2 may be calculated similarly to CSI part 1, but the maximum number of allocable resources among the total resources is reduced to the value excluding the number of coded modulation symbols for HARQ-ACK/CG-UCI and the number of coded modulation symbols for CSI part 2. The coded modulation symbols per layer for CSI part 1 may be calculated by using Equation 10, Equation 11, or Equation 12 depending on the PUSCH repetition type and whether UL-SCH is present.

$${Q}_{CSI - 2}^{′} = \qquad [ Equation 10 ]$$

$$min \{ ⌈ \frac{( {O}_{CSI - 1} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$$

$${Q}_{CSI - 2}^{′} = \qquad [ Equation 11 ]$$

$$min ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} , \\ {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$$

$${Q}_{CSI - 2}^{′} = {\sum }_{l = 0}^{{N}_{symb , all}^{PUSCH} - 1} {M}_{sc}^{UCI} ( l ) - {Q}_{ACK}^{′} - {Q}_{CSI - 1}^{′} \qquad [ Equation 12 ]$$

Equation 10 is used for calculating the coded modulation symbols per layer for CSI part 2 multiplexed on the PUSCH of non repetition type B with UL-SCH, Equation 11 is used for calculating the coded modulation symbols per layer for CSI part 2 multiplexed on the PUSCH of repetition type B with UL-SCH. Equation 12 is used for calculating the coded modulation symbols per layer for CSI part 2 multiplexed on the PUSCH without UL-SCH. In Equation 10, O_{CSI-2} and L_{CSI-2} represent the number of bits for CSI part 2 and the number of CRC bits for CSI part 2, respectively. β_{offset}^{PUSCH} is the beta offset for CSI part 2 and is the same as β_{offset}^{CSI-part2}. The other parameters are the same as those required to calculate the number of coded modulation symbols per layer for HARQ-ACK and CSI part 1.

The number of coded modulation symbols per layer for performing rate matching for CG-UCI may also be calculated similarly to the case of HARQ-ACK. The coded modulation symbols per layer for CG-UCI multiplexed on the PUSCH with UL-SCH may be calculated by using Equation 13.

$${Q}_{CG - UCI}^{′} = \qquad [ Equation 13 ]$$

$$min \{ ⌈ \frac{( {O}_{CG - UCI} + {L}_{CG - UCI} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \}$$

In Equation 13, O_{CG-UCI} and L_{CG-UCI} represent the number of bits of CG-UCI and the number of CRC bits for CG-UCI, respectively. β_{offset}^{PUSCH} is the beta offset for CG-UCI and is the same as β_{offset}^{CG-CCI}. The other parameters are the same as those required to calculate the number of coded modulation symbols per layer for HARQ-ACK

When HARQ-ACK and CG-UCI are multiplexed on the PUSCH with UL-SCH, the number of coded modulation symbols per layer for performing rate matching of HARQ-ACK and CG-UCI may be calculated by using Equation 14.

$${Q}_{CG - UCI}^{′} = \qquad [ Equation 14 ]$$

$$min \{ ⌈ \frac{( {O}_{ACK} + {O}_{CG - UCI} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , \\ ⌈ α \cdot {\sum }_{l = {l}_{0}}^{{N}_{symb , all}^{PUSCH} - 1} {M}_{sc}^{UCI} ( l ) ⌉ \}$$

In Equation 14, β_{offset}^{PUSCH} is the beta offset for HARQ-ACK and is the same as β_{offset}^{HARQ-ACK}, and the other parameters are the same as those required to calculate the number of coded modulation symbols per layer for HARQ-ACK.

### [CSI Measurement and Reporting Related]

Next, a detailed description will be given of a method for measuring and reporting channel states in the 5G communication system.

Channel state information (CSI) may include a channel quality indicator (CQI), a precoding matrix indicator (PMI), a CSI-RS resource indicator (CRI), a synchronization signal/physical broadcast channel (SS/PBCH) block resource indicator (SSBRI), a layer indicator (LI), a rank indicator (RI), and/or a L1-RSRP (reference signal received power). The base station may control time and frequency resources for CSI measurement and reporting of the UE.

For CSI measurement and reporting described above, the UE may be configured with at least one of configuration information CSI-ReportConfig for N (≥1) CSI reports, configuration information CSI-ResourceConfig for M (≥1) RS transmission resources, or trigger state lists CSI-AperiodicTriggerStateList and CSI-SemiPersistentOnPUSCH-TriggerStateList through higher layer signaling.

The aforementioned configuration information for CSI measurement and reporting may be more specifically described as in Tables 25 to 31 below.

TABLE 25
The IE CSI-ReportConfig is used to configure a periodic or semi-persistent
report sent on PUCCH on the cell in which the CSI-ReportConfig is included,
or to configure a semi-persistent or aperiodic report sent on PUSCH triggered
by DCI received on the cell in which the CSI-ReportConfig is included (in
this case, the cell on which the report is sent is determined by the
received DCI). See TS 38.214 [19], clause 5.2.1.
CSI-ReportConfig information element

```
      -- ASN1START
      -- TAG-CSI-REPORTCONFIG-START
```

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

```
      (1..maxNrofBWPs)) OF PUCCH-CSI-Resource
        },
```

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

```
      (1..maxNrofBWPs)) OF PUCCH-CSI-Resource
        },
```

| | |
|---|---|
| semiPersistentOnPUSCH | SEQUENCE { |
| reportSlotConfig | ENUMERATED {sl5, sl10, |

sl20, sl40, sl80, sl160, sl320},

| | |
|---|---|
| reportSlotOffsetList | SEQUENCE (SIZE (1.. |

maxNrofUL-Allocations)) OF INTEGER (0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE |

```
      (1..maxNrofUL-Allocations)) OF INTEGER (0..32)
        }
        },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

```
      OPTIONAL -- Need S
        },
```

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, |
| subbandCQI } | OPTIONAL, -- Need R |
| pmi-FormatIndicator | ENUMERATED { widebandPMI, |
| subbandPMI } | OPTIONAL, -- Need R |
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(11)), |
| subbands12 | BIT STRING(SIZE(12)), |
| subbands13 | BIT STRING(SIZE(13)), |
| subbands14 | BIT STRING(SIZE(14)), |
| subbands15 | BIT STRING(SIZE(15)), |
| subbands16 | BIT STRING(SIZE(16)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

```
    } OPTIONAL -- Need S
  }
OPTIONAL, -- Need R
```

| | |
|---|---|
| timeRestrictionForChannelMeasurements | ENUMERATED |

{configured, notConfigured},

| | |
|---|---|
| timeRestrictionForInterferenceMeasurements | ENUMERATED |

{configured, notConfigured},

| | |
|---|---|
| codebookConfig | CodebookConfig |

OPTIONAL, -- Need R

| | |
|---|---|
| dummy | ENUMERATED {n1, n2} |

OPTIONAL, -- Need R

| | |
|---|---|
| groupBasedBeamReporting | CHOICE { |
| enabled | NULL, |
| disabled | SEQUENCE { |
| nrofReportedRS | ENUMERATED {n1, n2, n3, |
| n4} | OPTIONAL -- Need S |

```
    }
  },
```

| | |
|---|---|
| cgi-Table | ENUMERATED {table1, table2, table3, |
| spare1} | OPTIONAL, -- Need R |
| subbandSize | ENUMERATED {value1, value2}, |
| non-PMI-PortIndication | SEQUENCE (SIZE (1..maxNrofNZP- |

```
CSI-RS-ResourcesPerConfig)) OF PortIndexFor8Ranks OPTIONAL, -- Need
R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

```
  }
OPTIONAL -- Need R
  ]]
}
CSI-ReportPeriodicityAndOffset ::= CHOICE {
```

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| | |
|---|---|
| PortIndexFor8Ranks ::= | CHOICE { |
| portIndex8 | SEQUENCE { |
| rank1-8 | PortIndex8 |

OPTIONAL, -- Need R

| | |
|---|---|
| rank2-8 | SEQUENCE(SIZE(2)) OF PortIndex8 |

OPTIONAL, -- Need R

| | |
|---|---|
| rank3-8 | SEQUENCE(SIZE(3)) OF PortIndex8 |

OPTIONAL, -- Need R

| | |
|---|---|
| rank4-8 | SEQUENCE(SIZE(4)) OF PortIndex8 |

OPTIONAL, -- Need R

| | |
|---|---|
| rank5-8 | SEQUENCE(SIZE(5)) OF PortIndex8 |

OPTIONAL, -- Need R

| | |
|---|---|
| rank6-8 | SEQUENCE(SIZE(6)) OF PortIndex8 |

OPTIONAL, -- Need R

| | |
|---|---|
| rank7-8 | SEQUENCE(SIZE(7)) OF PortIndex8 |

OPTIONAL, -- Need R

| | |
|---|---|
| rank8-8 | SEQUENCE(SIZE(8)) OF PortIndex8 |

OPTIONAL -- Need R
},

| | |
|---|---|
| portIndex4 | SEQUENCE{ |
| rank1-4 | PortIndex4 |

OPTIONAL, -- Need R

| | |
|---|---|
| rank2-4 | SEQUENCE(SIZE(2)) OF PortIndex4 |

OPTIONAL, -- Need R

| | |
|---|---|
| rank3-4 | SEQUENCE(SIZE(3)) OF PortIndex4 |

OPTIONAL, -- Need R

| | |
|---|---|
| rank4-4 | SEQUENCE(SIZE(4)) OF PortIndex4 |

OPTIONAL -- Need R
},

| | |
|---|---|
| portIndex2 | SEQUENCE{ |
| rank1-2 | PortIndex2 |

OPTIONAL, -- Need R

| | |
|---|---|
| rank2-2 | SEQUENCE(SIZE(2)) OF PortIndex2 |

OPTIONAL -- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

|CSI-ReportConfig field descriptions
carrier
Indicates in which serving cell the CSI-ResourceConfig indicated below are to be found. If the field
is absent, the resources are on the same serving cell as this report configuration.
codebookConfig
Codebook configuration for Type-1 or Type-II including codebook subset restriction.
cqi-FormatIndicator
Indicates whether the UE shall report a single (wideband) or multiple (subband) CQI. (see TS
38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-ResourceConfig
included in the configuration of the serving cell indicated with the field “carrier” above. The CSI-
ResourceConfig indicated here contains only CSI-IM resources. The bwp-Id in that CSI-
ResourceConfig is the same value as the bwp-Id in the CSI-ResourceConfig indicated by
resourcesForChannelMeasurement.
csi-ReportingBand
Indicates a contiguous or non-contiguous subset of subbands in the bandwidth part which CSI
shall be reported for. Each bit in the bit-string represents one subband. The right-most bit in the bit
string represents the lowest subband in the BWP. The choice determines the number of subbands
(subbands3 for 3 subbands, subbands4 for 4 subbands, and so on) (see TS 38.214 [19], clause
5.2.1.4). This field is absent if there are less than 24 PRBs (no sub band) and present otherwise,
the number of sub bands can be from 3 (24 PRBs, sub band size 8) to 18 (72 PRBs, sub band
size 4).
dummy
This field is not used in the specification. If received it shall be ignored by the UE.
groupBasedBeamReporting
Turning on/off group beam based reporting (see TS 38.214 [19], clause 5.2.1.4)
non-PMI-PortIndication
Port indication for RI/CQI calculation. For each CSI-RS resource in the linked ResourceConfig for
channel measurement, a port indication for each rank R, indicating which R ports to use.
Applicable only for non-PMI feedback (see TS 38.214 [19], clause 5.2.1.4.2).
The first entry in non-PMI-PortIndication corresponds to the NZP-CSI-RS-Resource indicated by
the first entry in nzp-CSI-RS-Resources in the NZP-CSI-RS-ResourceSet indicated in the first
entry of nzp-CSI-RS-ResourceSetList of the CSI-ResourceConfig whose CSI-ResourceConfigId is
indicated in a CSI-MeasId together with the above CSI-ReportConfigId; the second entry in non-
PMI-PortIndication corresponds to the NZP-CSI-RS-Resource indicated by the second entry in
nzp-CSI-RS-Resources in the NZP-CSI-RS-ResourceSet indicated in the first entry of nzp-CSI-
RS-ResourceSetList of the same CSI-ResourceConfig, and so on until the NZP-CSI-RS-Resource
indicated by the last entry in nzp-CSI-RS-Resources in the in the NZP-CSI-RS-ResourceSet
indicated in the first entry of nzp-CSI-RS-ResourceSetList of the same CSI-ResourceConfig. Then
the next entry corresponds to the NZP-CSI-RS-Resource indicated by the first entry in nzp-CSI-
RS-Resources in the NZP-CSI-RS-ResourceSet indicated in the second entry of nzp-CSI-RS-
ResourceSetList of the same CSI-ResourceConfig and so on.
nrofReportedRS
The number (N) of measured RS resources to be reported per report setting in a non-group-based
report. N <= N_max, where N_max is either 2 or 4 depending on UE capability.
(see TS 38.214 [19], clause 5.2.1.4) When the field is absent the UE applies the value 1
nzp-CSI-RS-ResourcesForInterference
NZP CSI RS resources for interference measurement. csi-ResourceConfigId of a CSI-
ResourceConfig included in the configuration of the serving cell indicated with the field “carrier”
above. The CSI-ResourceConfig indicated here contains only NZP-CSI-RS resources. The bwp-Id
in that CSI-ResourceConfig is the same value as the bwp-Id in the CSI-ResourceConfig indicated
by resourcesForChannelMeasurement.
p0alpha
Index of the p0-alpha set determining the power control for this CSI report transmission (see TS
38.214 [19], clause 6.2.1.2).
pdsch-BundleSizeForCSI
PRB bundling size to assume for CQI calculation when reportQuantity is CRI/RI/i1/CQI. If the field
is absent, the UE assumes that no PRB bundling is applied (see TS 38.214 [19], clause 5.2.1.4.2).
pmi-FormatIndicator
Indicates whether the UE shall report a single (wideband) or multiple (subband) PMI. (see TS
38.214 [19], clause 5.2.1.4).
pucch-CSI-ResourceList
Indicates which PUCCH resource to use for reporting on PUCCH.
reportConfigType
Time domain behavior of reporting configuration
reportFreqConfiguration
Reporting configuration in the frequency domain. (see TS 38.214 [19], clause 5.2.1.4).
reportQuantity
The CSI related quantities to report. Corresponds to L1 parameter ‘ReportQuantity’ (see TS
38.214 [19], clause 5.2.1).
reportSlotConfig
Periodicity and slot offset (see TS 38.214 [19], clause 5.2.1.4) .
reportSlotConfig-v1530
Extended value range for reportSlotConfig for semi-persistent CSI on PUSCH. If the field is
present, the UE shall ignore the value provided in the legacy field
(semiPersistentOnPUSCH.reportSlotConfig).
reportSlotOffsetList
Timing offset Y for semi persistent reporting using PUSCH. This field lists the allowed offset
values. This list must have the same number of entries as the pusch-TimeDomainAllocationList in
PUSCH-Config. A particular value is indicated in DCI. The network indicates in the DCI field of the
UL grant, which of the configured report slot offsets the UE shall apply. The DCI value 0
corresponds to the first report slot offset in this list, the DCI value 1 corresponds to the second
report slot offset in this list, and so on. The first report is transmitted in slot n+Y, second report in
n+Y+P, where P is the configured periodicity.
Timing offset Y for aperiodic reporting using PUSCH. This field lists the allowed offset values. This
list must have the same number of entries as the pusch-TimeDomainAllocationList in PUSCH-
Config. A particular value is indicated in DCI. The network indicates in the DCI field of the UL
grant, which of the configured report slot offsets the UE shall apply. The DCI value 0 corresponds
to the first report slot offset in this list, the DCI value 1 corresponds to the second report slot offset
in this list, and so on (see TS 38.214 [19], clause 5.2.3).
resourcesForChannelMeasurement
Resources for channel measurement. csi-ResourceConfigId of a CSI-ResourceConfig included in
the configuration of the serving cell indicated with the field “carrier” above. The CSI-
ResourceConfig indicated here contains only NZP-CSI-RS resources and/or SSB resources. This
CSI-ReportConfig is associated with the DL BWP indicated by bwp-Id in that CSI-ResourceConfig.
subbandSize
Indicates one out of two possible BWP-dependent values for the subband size as indicated in TS
38.214 [19], table 5.2.1.4-2 . If csi-ReportingBand is absent, the UE shall ignore this field.
timeRestrictionForChannelMeasurements
Time domain measurement restriction for the channel (signal) measurements (see TS 38.214 [19],
clause 5.2.1.1)
timeRestrictionForInterferenceMeasurements
Time domain measurement restriction for interference measurements (see TS 38.214 [19], clause
5.2.1.1)

TABLE 26
The IE CSI-ResourceConfig defines a group of one or more NZP-
CSI-RS-ResourceSet, CSI-IM-ResourceSet and/or CSI-SSB-ResourceSet.
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP- |

CSI-RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI- |

SSB-ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, |

periodic },
...
}
-- TAG-CSI-RESOURCECONFIG-STOP
-- ASN1STOP
CSI-ResourceConfig field descriptions
bwp-Id
The DL BWP which the CSI-RS associated with this CSI-ResourceConfig are located in (see TS
38.214 [19], clause 5.2.1.2
csi-ResourceConfigId
Used in CSI-ReportConfig to refer to an instance of CSI-ResourceConfig
csi-RS-ResourceSetList
Contains up to maxNrofNZP-CSI-RS-ResourceSetsPerConfig resource sets if ResourceConfigType is
‘aperiodic’ and 1 otherwise (see TS 38.214 [19], clause 5.2.1.2)
csi-SSB-ResourceSetList
List of SSB resources used for beam measurement and reporting in a resource set (see TS 38.214
[19], section FFS Section)
resourceType
Time domain behavior of resource configuration (see TS 38.214 [19], clause 5.2.1.2). It does not apply
to resources provided in the csi-SSB-ResourceSetList.

TABLE 27
The IE NZP-CSI-RS-ResourceSet is a set of Non-Zero-Power
(NZP) CSI-RS resources (their IDs) and set-specific parameters.
NZP-CSI-RS-ResourceSet information element

| -- ASN1START | |
|---|---|
| -- TAG-N2P-CSI-RS-RESOURCESET-START | |
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP- |
| CSI-RS-ResourcesPerSet)) OF NZP-CSI-RS-ResourceId, | |
| repetition | ENUMERATED { on, off } |
| OPTIONAL, -- Need S | |
| aperiodicTriggeringOffset | INTEGER (0..6) |
| OPTIONAL, -- Need S | |
| trs-Info | ENUMERATED {true} |

OPTIONAL, -- Need R
...
}
-- TAG-NZP-CSI-RS-RESOURCESET-STOP
-- ASN1STOP

NZP-CSI-RS-ResourceSet field descriptions
aperiodicTriggeringOffset
Offset X between the slot containing the DCI that triggers a set of aperiodic NZP CSI-RS
resources and the slot in which the CSI-RS resource set is transmitted. The value 0 corresponds
to 0 slots, value 1 corresponds to 1 slot, value 2 corresponds to 2 slots, value 3 corresponds to 3
slots, value 4 corresponds to 4 slots, value 5 corresponds to 16 slots, value 6 corresponds to 24
slots. When the field is absent the UE applies the value 0.
nzp-CSI-RS-Resources
NZP-CSI-RS-Resources associated with this NZP-CSI-RS resource set (see TS 38.214 [19],
clause 5.2). For CSI, there are at most 8 NZP CSI RS resources per resource set
repetition
Indicates whether repetition is on/off. If the field is set to ‘OFF’ or if the field is absent, the UE
may not assume that the NZP-CSI-RS resources within the resource set are transmitted with the
same downlink spatial domain transmission filter and with same NrofPorts in every symbol (see
TS 38.214 [19], clauses 5.2.2.3.1 and 5.1.6.1.2). Can only be configured for CSI-RS resource
sets which are associated with CSI-ReportConfig with report of L1 RSRP or “no report”
trs-Info
Indicates that the antenna port for all NZP-CSI-RS resources in the CSI-RS resource set is
same. If the field is absent or released the UE applies the value “false” (see TS 38.214 [19],
clause 5.2.2.3.1).

TABLE 28
The IE CSI-SSB-ResourceSet is used to configure one SS/PBCH
block resource set which refers to SS/PBCH as indicated in
ServingCellConfigCommon.
CSI-SSB-ResourceSet information element

-- ASN1START
-- TAG-CSI-SSB-RESOURCESET-START

| | |
|---|---|
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE(1..maxNrofCSI-SSB- |

ResourcePerSet)) OF SSB-Index,
...
}
-- TAG-CSI-SSB-RESOURCESET-STOP
-- ASN1STOP

TABLE 29
The IE CSI-IM-ResourceSet is used to configure a set of one or more CSI
Interference Management (IM) resources (their IDs) and set-specific parameters.
CSI-IM-ResourceSet information element

-- ASN1START
-- TAG-CSI-IM-RESOURCESET-START

| | |
|---|---|
| CSI-IM-ResourceSet ::= | SEQUENCE { |
| csi-IM-ResourceSetId | CSI-IM-ResourceSetId, |
| csi-IM-Resources | SEQUENCE (SIZE(1..maxNrofCSI-IM-ResourcesPerSet)) |

OF CSI-IM-ResourceId,
...
}
-- TAG-CSI-IM-RESOURCESET-STOP
-- ASN1STOP
CSI-IM-ResourceSet field descriptions
csi-IM-Resources
CSI-IM-Resources associated with this CSI-IM-ResourceSet (see TS 38.214 [19], clause 5.2)

TABLE 30
The CSI-AperiodicTriggerStateList IE is used to configure the UE with a
list of aperiodic trigger states. Each codepoint of the DCI field “CSI
request” is associated with one trigger state. Upon reception of the
value associated with a trigger state, the UE will perform measurement
of CSI-RS (reference signals) and aperiodic reporting on LI according
to all entries in the associatedReportConfigInfoList for that trigger state.
CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI- |

AperiodicTriggers)) OF CSI-AperiodicTriggerState

| | |
|---|---|
| CSI-AperiodicTriggerState ::= | SEQUENCE { |
| associatedReportConfigInfoList | SEQUENCE |

(SIZE(1..maxNrofReportConfigPerAperiodicTrigger)) OF CSI-
AssociatedReportConfigInfo,
...
}

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI- |

RS-ResourceSetsPerConfig),

| | |
|---|---|
| qcl-info | SEQUENCE (SIZE(1..maxNrofAP- |
| CSI-RS-ResourcesPerSet)) OF TCI-StateId | OPTIONAL -- Cond Aperiodic |

},

| | |
|---|---|
| csi-SSB-ResourceSet | INTEGER (1..maxNrofCSI-SSB- |

ResourceSetsPerConfig)
},

| | |
|---|---|
| csi-IM-ResourcesForInterference | INTEGER(1..maxNrofCSI-IM- |
| ResourceSetsPerConfig) | OPTIONAL, -- Cond CSI-IM-ForInterference |

nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP
CSI-AssociatedReportConfigInfo field descriptions
csi-IM-ResourcesForInterference
CSI-IM-ResourceSet for interference measurement. Entry number in csi-IM-ResourceSetList in
the CSI-ResourceConfig indicated by csi-IM-ResourcesForInterference in the CSI-ReportConfig
indicated by reportConfigId above (1 corresponds to the first entry, 2 to the second entry, and so
on). The indicated CSI-IM-ResourceSet should have exactly the same number of resources like
the NZP-CSI-RS-ResourceSet indicated in nzp-CSI-RS-ResourcesforChannel.
csi-SSB-ResourceSet
CSI-SSB-ResourceSet for channel measurements. Entry number in csi-SSB-ResourceSetList in
the CSI-ResourceConfig indicated by resourcesForChannelMeasurement in the CSI-
ReportConfig indicated by reportConfigId above (1 corresponds to the first entry, 2 to the second
entry, and so on).
nzp-CSI-RS-ResourcesForInterference
NZP-CSI-RS-ResourceSet for interference measurement. Entry number in nzp-CSI-RS-
ResourceSetList in the CSI-ResourceConfig indicated by nzp-CSI-RS-ResourcesForInterference
in the CSI-ReportConfig indicated by reportConfigId above (1 corresponds to the first entry, 2 to
the second entry, and so on).
qcl-info
List of references to TCI-States for providing the QCL source and QCL type for each NZP-CSI-
RS-Resource listed in nzp-CSI-RS-Resources of the NZP-CSI-RS-ResourceSet indicated by
nzp-CSI-RS-ResourcesforChannel. Each TCI-StateId refers to the TCI-State which has this
value for tci-StateId and is defined in tci-StatesToAddModList in the PDSCH-Config included in
the BWP-Downlink corresponding to the serving cell and to the DL BWP to which the
resourcesForChannelMeasurement (in the CSI-ReportConfig indicated by reportConfigId above)
belong to. First entry in qcl-info-forChannel corresponds to first entry in nzp-CSI-RS-Resources
of that NZP-CSI-RS-ResourceSet, second entry in qcl-info-forChannel corresponds to second
entry in nzp-CSI-RS-Resources, and so on (see TS 38.214 [19], clause 5.2.1.5.1)
reportConfigId
The reportConfigId of one of the CSI-ReportConfigToAddMod configured in CSI-MeasConfig
resourceSet
NZP-CSI-RS-ResourceSet for channel measurements. Entry number in nzp-CSI-RS-
ResourceSetList in the CSI-ResourceConfig indicated by resourcesForChannelMeasurement in
the CSI-ReportConfig indicated by reportConfigId above (1 corresponds to the first entry, 2 to
thesecond entry, and so on).

| Conditional | |
|---|---|
| Presence | Explanation |
| Aperiodic | The field is mandatory present if |
| | the NZP-CSI-RS-Resources in |
| | the associated resourceSet have the |
| | resourceType aperiodic. |
| | The field is absent otherwise. |
| CSI-IM- | This field is optional need M if the |
| ForInterference | CSI-ReportConfig identified by |
| | reportConfigId is configured with csi-IM- |
| | ResourcesForInterference; otherwise it is absent. |
| NZP-CSI-RS- | This field is optional need M if the |
| ForInterference | CSI-ReportConfig identified by |
| | reportConfigId is configured with nzp-CSI-RS- |
| | ResourcesForinterference; otherwise it is absent. |

TABLE 31
The CSI-SemiPersistentOnPUSCH-TriggerStateList IE is used to configure the
UE with list of trigger states for semi-persistent reporting of channel
state information on L1. See also TS 38.214 [19], clause 5.2.
CSI-SemiPersistentOnPUSCH-TriggerStateList information element

| -- ASN1START | |
|---|---|
| -- TAG-CSI-SEMIPERSISTENTONPUSCHTRIGGERSTATELIST-START | |
| CSI-SemiPersistentOnPUSCH-TriggerStateList ::= | SEQUENCE (SIZE |
| (1..maxNrOfSemiPersistentPUSCH-Triggers)) OF CSI- | |
| SemiPersistentOnPUSCH-TriggerState | |
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

Each reporting configuration CSI-ReportConfig may be associated with one downlink (DL) bandwidth part identified by bandwidth part identifier bwp-Id, which is a higher layer parameter given by the CSI resource configuration CSI-ResourceConfig associated with the corresponding reporting configuration. Time domain reporting for each reporting configuration CSI-ReportConfig supports “aperiodic”, “semi-persistent”, or “periodic” mode, which may be configured by the base station to the UE through higher layer parameter reportConfigType. Semi-persistent CSI reporting supports semi-persistent reporting on the PUCCH configured by semi-PersistentOnPUCCH and semi-persistent reporting on the PUSCH configured by semi-PersistentOnPUSCH. For periodic or semi-persistent CSI reporting, the UE may be configured by the base station with PUCCH or PUSCH resources to transmit the CSI, through higher layer signaling. The periodicity and slot offset for CSI transmission may be given as a numerology of the uplink (UL) bandwidth part configured to transmit the CSI report. For aperiodic CSI reporting, the UE may be scheduled by the base station with PUSCH resources for CSI transmission, through L1 signaling (e.g., DCI format 0_1).

For the above-mentioned CSI resource configuration CSI-ResourceConfig, each CSI resource configuration CSI-ReportConfig may include S (≥1) CSI resource sets (given by higher layer parameter csi-RS-ResourceSetList). The CSI resource set list may be composed of a non-zero power (NZP) CSI-RS resource set and a SS/PBCH block set, or may be composed of a CSI-interference measurement (CSI-IM) resource set. Each CSI resource configuration may be positioned in a downlink (DL) bandwidth part identified by higher layer parameter bwp-Id, and the CSI resource configuration may be associated to a CSI reporting configuration of the same downlink bandwidth part. The time domain behavior of CSI-RS resources in the CSI resource configuration may be set to one of “aperiodic”, “periodic”, or “semi-persistent” via higher layer parameter resourceType. For periodic or semi-persistent CSI resource configuration, the number of CSI-RS resource sets may be limited to S=1, and the configured periodicity and slot offset may be given by a numerology of the downlink bandwidth part identified by bwp-Id. The UE may be configured by the base station with one or more CSI resource configurations for channel or interference measurement through higher layer signaling, and for example, the CSI resource configuration may include at least one of the following resources.
CSI-IM resource for interference measurement
NZP CSI-RS resource for interference measurement
NZP CSI-RS resource for channel measurement

For CSI-RS resource sets associated with a resource configuration where higher layer parameter resourceType is set to “aperiodic”, “periodic”, or “semi-persistent”, the trigger state for a CSI reporting configuration where reportType is set to “aperiodic” and the resource configuration for channel or interference measurement of one or multiple component cells (CCs) may be configured via higher layer parameter CSI-AperiodicTriggerStateList.

Aperiodic CSI reporting of the UE may use the PUSCH; periodic CSI reporting may use the PUCCH; and semi-persistent CSI reporting may be performed using the PUSCH when triggered or activated by the DCI, and may be performed using the PUCCH after being activated by a MAC control element (MAC CE).

The CSI resource configuration may also be set to aperiodic, periodic, or semi-persistent. The combination between CSI reporting configurations and CSI resource configurations may be based on Table 32 below.

TABLE 32
Triggering/Activation of CSI Reporting for the possible CSI-RS Configurations.

| | Periodic CSI | Semi-Persistent CSI | Aperiodic CSI |
|---|---|---|---|
| CSI-RS Configuration | Reporting | Reporting | Reporting |
| Periodic CSI-RS | No dynamic | For reporting on | Triggered by DCI; |
| | triggering/activation | PUCCH, the UE | additionally, activation |
| | | receives an activation | command [10, TS |
| | | command [10, TS | 38.321] possible as |
| | | 38.321]; for reporting | defined in Subclause |
| | | on PUSCH, the UE | 5.2.1.5.1. |
| | | receives triggering on | |
| | | DCI | |
| Semi-Persistent CSI- | Not Supported | For reporting on | Triggered by DCI; |
| RS | | PUCCH, the UE | additionally, activation |
| | | receives an activation | command [10, TS |
| | | command [10, TS | 38.321] possible as |
| | | 38.321]; for reporting | defined in Subclause |
| | | on PUSCH, the UE | 5.2.1.5.1. |
| | | receives triggering on | |
| | | DCI | |
| Aperiodic CSI-RS | Not Supported | Not Supported | Triggered by DCI; |
| | | | additionally, activation |
| | | | command [10, TS |
| | | | 38.321] possible as |
| | | | defined in Subclause |
| | | | 5.2.1.5.1. |

Aperiodic CSI reporting may be triggered by, for example, a “CSI request” field in DCI format 0_1 corresponding to the scheduling DCI for the PUSCH. The UE may monitor the PDCCH to obtain DCI format 0_1, and may obtain resource allocation information for the PUSCH and the CSI request field from DCI format 0_1. The CSI request field may be set to have N_{TS} (=0, 1, 2, 3, 4, 5, or 6) bits, and N_{Ts} may be determined by higher layer parameter reportTriggerSize. Among one or multiple aperiodic CSI reporting trigger states that may be configured by higher layer parameter CSI-AperiodicTriggerStateList, one trigger state may be triggered by the CSI request field.
If all bits in the CSI request field are 0, this may mean that no CSI report is requested.
If the number of CSI trigger states (M) configured in CSI-AperiodicTriggerStateList is greater than 2^{N\hat{ }TS}−1, the M CSI trigger states may be mapped to 2^{N\hat{ }TS}−1 CSI trigger states according to a predefined mapping relationship, and one of the 2^{N\hat{ }TS}−1 trigger states may be indicated by the CSI request field.
If the number of CSI trigger states (M) configured in CSI-AperiodicTriggerStateList is less than or equal to 2^{N\hat{ }TS}−1, one of the M CSI trigger states may be indicated by the CSI request field.

Table 33 below shows an example of the relationship between the CSI request field and the CSI trigger states that may be indicated by it.

TABLE 33

| CSI request | CSI trigger | CSI- | CSI- |
|---|---|---|---|
| field | state | ReportConfigId | ResourceConfigId |
| 00 | no CSI request | N/A | N/A |
| 01 | CSI trigger | CSI report#1 | CSI resource#1, |
| | state#1 | CSI report#2 | CSI resource#2 |
| 10 | CSI trigger | CSI report#3 | CSI resource#3 |
| | state#2 | | |
| 11 | CSI trigger | CSI report#4 | CSI resource#4 |
| | state#3 | | |

The UE may perform measurement on the CSI resource in the CSI trigger state triggered by the CSI request field, and generate CSI (including at least one of CQI, PMI, CRI, SSBRI, LI, RI, or L1-RSRP) from the measurements. The UE may transmit the generated CSI by using the PUSCH scheduled by DCI format 0_1. If the 1-bit uplink shared channel indicator (UL-SCH indicator) in DCI format 0_1 is set to ‘1’, uplink data of the UL-SCH and the generated CSI may be multiplexed and transmitted on the PUSCH resource scheduled by DCI format 0_1. If the UL-SCH indicator in DCI format 0_1 is set to ‘0’, only CSI may be transmitted on the PUSCH resource scheduled by DCI format 0_1 without uplink data.

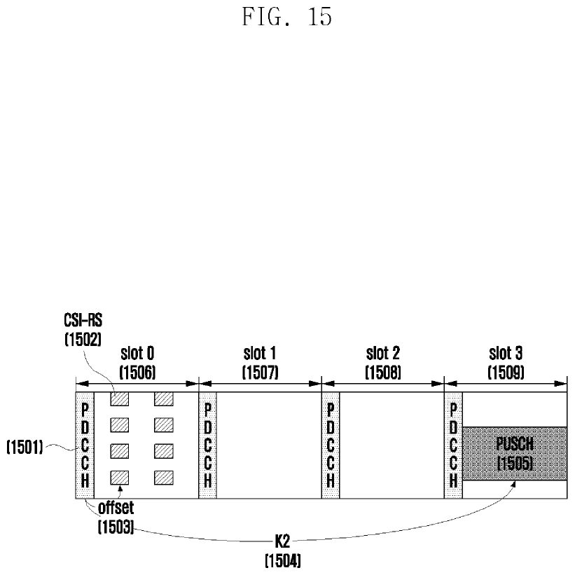

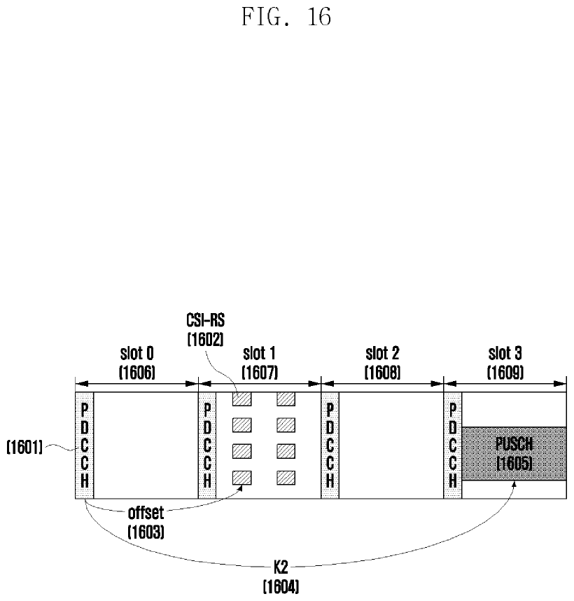

FIG. 15 and FIG. 16 are diagrams illustrating an example of aperiodic channel state reporting according to an embodiment of the disclosure.

With reference to FIG. 15, the UE may monitor the PDCCH 1500 to obtain DCI format 0_1, and may obtain scheduling information for the PUSCH 1508 and a CSI request field from DCI format 0_1. The CSI request field provides resource information about the CSI-RS 1502 to be measured by the UE. The UE may identify the measurement time for the resource of the CSI-RS 1502 based on the reception time of DCI format 0_1 and the CSI resource set configuration (e.g., aperiodicTriggeringOffset in NZP-CSI-RS-ResourceSet).

More specifically, the UE may obtain an offset value X (1504) according to parameter aperiodicTriggeringOffset in the NZP-CSI-RS resource set given by higher layer signaling from the base station. The offset value X (804) means the offset between the slot in which the DCI triggering aperiodic CSI reporting is received and the slot in which the CSI-RS resource is transmitted. For example, the value of aperiodic TriggeringOffset and the offset value X (1504) may have a mapping relationship as described in Table 34 below.

TABLE 34

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

FIG. 15 shows an example in which the offset value X (1504) is set to 0. In this case, the UE may receive CSI-RS 1502 in slot 0 (1510) where DCI format 0_1 triggering aperiodic CSI reporting is received.

The UE may obtain scheduling information (aforementioned resource assignment fields in DCI format 0_1) about the PUSCH 1508 for CSI reporting from DCI format 0_1. For example, the UE may obtain information about the slot where the PUSCH 1508 is to be transmitted from the time domain resource assignment field in DCI format 0_1. In the example of FIG. 15, the value of K2 (1506) corresponding to the PDCCH-to-PUSCH slot offset is 3, and hence the PUSCH 1508 including the CSI related to the CSI-RS 1502 may be transmitted in slot 3 (1512), which is 3 slots away from the time at which the PDCCH 1500 is received, i.e., slot 0 (1510).

With reference to FIG. 16, the UE may monitor the PDCCH 1600 to obtain DCI format 0_1, and may obtain scheduling information for the PUSCH 1608 and a CSI request field from DCI format 0_1. The CSI request field provides resource information about the CSI-RS 1602 to be measured by the UE. FIG. 16 shows an example in which the offset value X (1604) for CSI-RS is set to 1. In this case, the UE may receive the CSI-RS 1602 in slot 1 (1612), which is 1 slot away from slot 0 (1610) where DCI format 0_1 triggering aperiodic CSI reporting is received. In this illustrated example, the value of K2 (1606) corresponding to the PDCCH-to-PUSCH slot offset is set to 3 for the UE, so the PUSCH 1608 including the CSI related to the CSI-RS 1602 may be transmitted in slot 3 (1614), which is 3 slots away from the time at which the PDCCH 1600 is received, i.e., slot 0 (1610).

### [CSI: L1-RSRP Reporting Related]

Next, a detailed description will be given of L1-RSRP reporting in the 5G system. The UE may be configured with the CSI-RS and SSB for L1-RSRP calculation; for CSI-RS, up to 16 CSI-RS sets may be configured and up to 64 CSI-RSs per set may be configured, and the total cannot exceed 128. If higher layer parameter nrofReportedRS is set to 1, L1-RSRP is defined as a 7-bit value in the range [−140,−44] dBm with 1 dB step size. If nrofReportedRS is greater than 1, or if groupBasedBeamReporting is set to ‘enabled’, or if groupBasedBeamReporting-r17 is set to ‘enabled’, the UE may report differential L1-RSRP, which is the difference from the largest L1-RSRP. Differential L1-RSRP is defined as a 4-bit value with 2 dB step size. The UE may calculate and report L1-RSRP based on the NZP CSI-RS and SSB before the CSI reference resource if higher layer parameter timeRestrictionForChannelMeasurements is set to ‘notConfigured’, and may calculate and report L1-RSRP based on the most recent NZP CSI-RS or SSB before the CSI reference resource if it is set to ‘Configured’.

The disclosure provides, when the base station intends to operate multiple beams while reducing the amount of CSI-RS for beam operation, a method that enables the UE to receive CSI-RS and to report measured CSI. Specifically, if the beam set used by the base station for UE-specific PDSCH transmission is called Set A, and the beam set used for beam measurement and reporting to select the optimal beam for the UE is called Set B, in the related art, the UE selects the optimal beam by using the following methods.
Method 1. Set B is the same as Set A. The beams of Set B are mapped respectively to different SSBs or CSI-RSs. The UE may measure all SSBs or CSI-RSs mapped to the beams in Set B and report the index and L1-RSRP of the SSB or CSI-RS with the largest L1-RSRP. The base station may select a beam from Set A based on the UE's report and use it as a PDSCH transmit beam.
Method 2. Set B is different from Set A or is a subset of Set A. Set B may be divided into Set B1 and Set B2, and Set B1 may be composed of beams with a wide beam width, and Set B2 being a subset of Set A may be composed of beams with a smaller beam width than those of Set B1. The UE may measure all SSBs or CSI-RSs mapped to the beams of Set B1 and report the index and LI-RSRP of the SSB or CSI-RS with the largest L1-RSRP. The base station may select beams from Set B1 based on the UE's report and compose Set B2 with the selected beams. The UE may measure all CSI-RSs mapped to the beams of Set B2 and report the index and L1-RSRP of the CSI-RS with the largest L1-RSRP. The base station may select a beam from Set A based on the UE's report and use it as a PDSCH transmit beam.

To select a beam from Set A, the above related-art methods 1 and 2 both require at least that an optimal beam is present among the beams of Set B. Hence, a lot of beam sweeping may be needed to select the optimal beam from Set B, which has the disadvantage of increasing the overhead of DL-RS and increasing the latency of beam operation.

The base station may utilize a high-performance beam prediction algorithm and recent measurement data for Set B to select or predict the optimal beam that belongs to Set A and is not included in Set B. This high-performance beam prediction algorithm may be implemented with various beam prediction algorithms including AI (artificial intelligence)-based channel prediction algorithms, and the following advantages may be obtained therefrom.
Advantage 1: since the optimal beam in Set A does not need to be included in Set B, the overhead of the SSB or CSI-RS for measuring beams in Set B may be reduced. For example, to use a transmit beam with a smaller beam width than the beam mapped to the SSB, a transmit beam with a smaller beam width (and larger beam gain) may be mapped to the CSI-RS; but this requires configuring a CSI-RS to each UE, so if there are many beams in Set B, the amount of CSI-RS overhead may become very large when supporting many UEs.
Advantage 2: since the base station may predict a beam that is not measured and reported, it may predict a future beam to thereby reduce latency for beam operation and continuously maintain beam reception quality. For example, when beam switching is required, the optimal beam may be not received in time due to latency in beam sweeping and CSI reporting, or the optimal beam may be not received due to L1-RSRP aging. If predicting a future beam, the base station may instruct the UE to switch beams while reducing latency by predicting the optimal beam in advance before the time when beam switching is required.

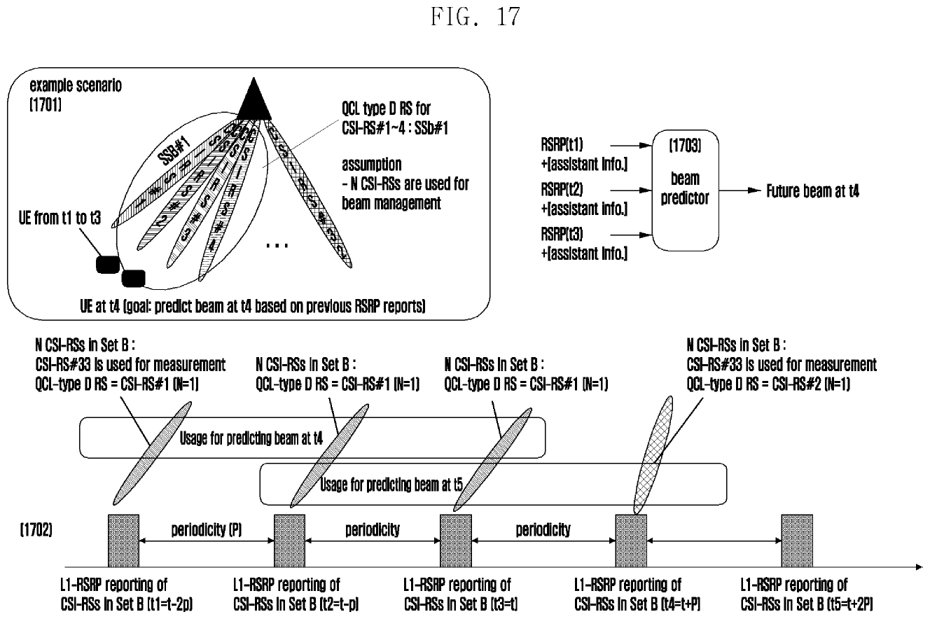

In the disclosure, for the purpose of explanation, it is assumed that the number of beams in Set A is M and the number of beams in Set B is N, and it is assumed that the beam width used for the CSI-RS is smaller than the beam width used for the SSB, but this does not limit the scope of the disclosure. For example, referring to FIG. 17, it is assumed that the UE is configured with M (=32) CSI-RSs to which a total of M transmit beams are mapped (1701). The UE may measure N(=1) beams at t1, t2, and t3, respectively, and report L1-RSRP (1702), and the base station may predict a beam at t4 by using reported L1-RSRP at t1, t2, and t3 and a high-performance beam prediction algorithm (1703). At this time, if the predicted transmit beam at t4 is a transmit beam not included in Set B and the base station does not indicate that the transmit beam in Set B has been changed, the UE cannot know the receive beam assumption when receiving the transmit beam in Set B to be measured at t4. The following embodiments disclose methods that indicate a changed transmit beam of Set B to the UE when the transmit beam in Set B is changed through beam prediction of the base station.

### First Embodiment: Method for CSI-RS Switching in CSI-RS Set for Beam Measurement

The first embodiment of the disclosure describes, when the transmit beam of the beam set (Set B) for beam measurement and reporting used to select an optimal beam of the UE is changed, a method for the UE to receive an indication of the changed transmit beam. Through the transmit beam indication method according to an embodiment of the disclosure, the UE may more accurately measure the CSI-RS of the beam set for beam measurement and reporting by using the spatial RX parameter (QCL type D) of the beam configured in the CSI-RS. Specifically, the UE may be configured with periodic CSI reports for beam measurement and reporting, and may expect to receive N periodic CSI-RSs for CSI reporting through CSI-RS IDs. That is, the beams of Set B may be configured through N periodic CSI-RSs, and the CSI-RSs in Set B may be switched through an indication from the base station. The method by which the UE receives an indication of the IDs of periodic CSI-RSs is described below.
Method 1: the UE may receive an indication of the CSI-RS ID via a DCI field. As an embodiment, the UE may receive an indication of a total of N CSI-RS IDs from the PeriodicCSIID field of the DCI. Various ways of designing the PeriodicCSIID field are described below.
Method 1-1: it may be designed in a way of setting N bits out of M bits to 1.
Method 1-2: it may be designed by dividing M CSI-RSs into K groups with N CSI-RSs and indicating the groups with log₂(K) bits. The K groups may be configured via higher layer parameter RRC.
Method 1-3: it may be designed by dividing M CSI-RSs into K equal groups, indicating the K^{th} group with log₂(K) bits, and setting N bits out of ┌M/K┐ bits to 1.
Method 1-4: it can be designed in a way of indicating only one CSI-RS out of N CSI-RSs. One CSI-RS ID among the N CSI-RS IDs previously indicated by log₂(N) bits may be switched to a CSI-RS ID newly indicated by log₂(M) bits.

Through method 1 of this embodiment, the UE may periodically perform beam measurement and reporting for N newly indicated CSI-RSs after Y+d symbols from the symbol at which the DCI is received. Here, Y may be set to beamSwitchTiming∈{14,28,48}, and d may be set to 0 if the subcarrier spacing of the PDCCH including the DCI is the same as the CSI-RS, otherwise d may be set to d=14·2^{μCSIRS}/2^{μPDCCH}.
Method 2: the UE may receive an indication of a CSI-RS ID via a MAC CE. As an embodiment, N CSI-RS IDs out of M CSI-RS IDs may be activated via a MAC CE. The UE may perform periodic CSI reporting by switching the existing N periodic CSI-RSs to N new periodic CSI-RSs activated through a MAC CE.
Method 3: if the UE is configured to reinterpret the existing aperiodic CSI report triggering scheme through a new field of DCI or a higher layer configuration, N periodic CSI-RSs for periodic CSI reporting may be switched. As an embodiment, the UE may refer to the CSI request field of DCI 0_1 to trigger one CSI-AperiodicTriggerState. The way of switching N CSI-RSs via triggered CSI-AperiodicTriggerState is described in detail below.
Method 3-1: the UE expects that there is one CSI-report config and one CSI-RS set in CSI-AperiodicTriggerState. The UE switches the CSI-RSs in the triggered CSI-RS set.
Method 3-2: the UE may be configured with multiple CSI-report configs in CSI-Aperiodic TriggerState and may also be configured with multiple CSI-RS sets. The UE switches the CSI-RSs with the N lowest IDs out of all CSI-RS IDs in the triggered CSI-RS sets.

Through method 3 of this embodiment, the UE may periodically perform beam measurement and reporting for N newly indicated CSI-RSs after Y+d symbols from the symbol at which the DCI is received. Here, Y may be set to beamSwitchTiming∈{14,28,48}, and d may be set to 0 if the subcarrier spacing of the PDCCH including the DCI is the same as the CSI-RS, otherwise d may be set to d=14·2^{μCSIRS}/2^{μPDCCH}. Above-described method 1 has the advantage of being able to dynamically indicate N CSI-RS IDs of various combinations via the DCI. Additionally, above-described method 2 has the advantage of being able to significantly reduce the overhead of the PDCCH. Finally, above-described method 3 has the advantage of being able to directly apply the existing mechanism of aperiodic CSI report triggering and may expect a lower PDCCH overhead than above-described method 1.

### Second Embodiment: Method for Updating QCL RS of CSI-RS Set for Beam Measurement

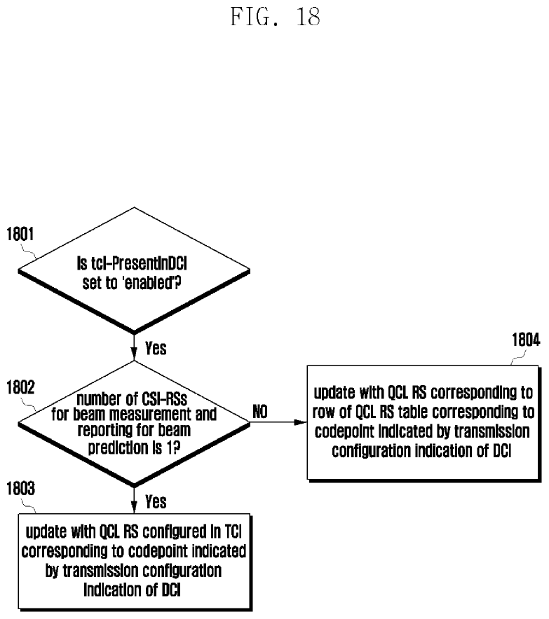

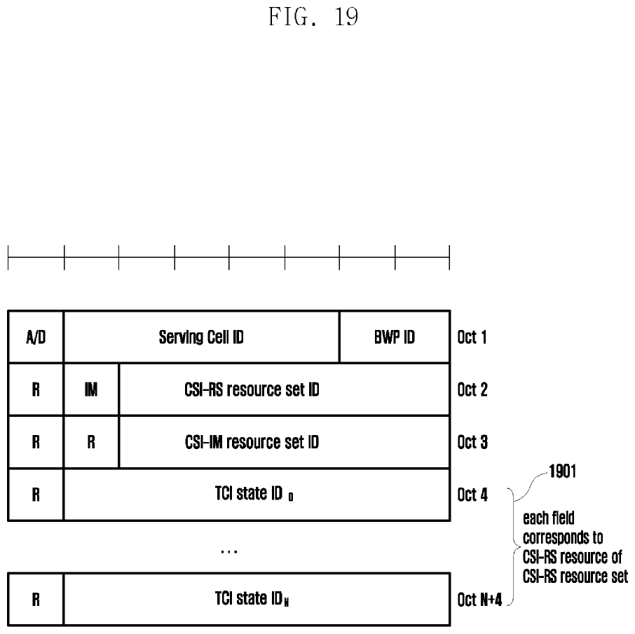

The second embodiment of the disclosure describes, when a transmit beam of a beam set (Set B) for beam measurement and reporting used to select an optimal beam of the UE is changed, a method for the UE to receive an indication of a QCL RS (reference signal) for the changed transmit beam. Through the transmit beam indication method according to an embodiment of the disclosure, the UE may more accurately measure the CSI-RS of the beam set for beam measurement and reporting by using the spatial RX parameter (QCL type D) of the indicated beam. Specifically, the UE may be configured with periodic CSI reports for beam measurement and reporting, and may expect to receive an indication of N periodic CSI-RSs for CSI reporting through CSI-RS IDs. That is, the beams of Set B may be configured through N periodic CSI-RSs, and the QCL RS of the CSI-RS in Set B may be updated through an indication from the base station. The method for the UE to receive an indication of updating the QCL RS of periodic CSI-RSs in various cases is described below.
Method 1: the UE may update the QCL RS of the CSI-RS of Set B to the QCL RS configured in the TCI of the PDSCH indicated by the DCI. Specifically, referring to FIG. 18, when higher layer parameter tci-PresentInDCI is set to ‘enabled’ (1801), if one of the active TCIs is indicated through a “transmission configuration indication” field of the DCI, the UE may update the QCL RS of the CSI-RS according to the following detailed methods.
Method 1-1: only when the number of CSI-RSs for beam measurement and reporting for beam prediction is 1 (i.e., N=1) (1802), the UE may be instructed to update the QCL RS (1803). To this end, when the UE updates the TCI of the PDSCH with the transmission configuration indication field of the DCI, the UE may be configured through an RRC parameter to update the QCL RS of the CSI-RS of Set B together based on the corresponding TCI.
Method 1-2: even when the number of CSI-RSs for beam measurement and reporting for beam prediction is greater than 1 (i.e., N>1) (1802), the UE may be instructed to update the QCL RS (1804). To this end, the UE may be configured with a table whose each row is composed of N CSI-RS QCL RSs through higher layer RRC. At this time, the codepoint of the transmission configuration indication of the DCI indicates a specified row of the configured table, and the UE may update the QCL RS of the CSI-RS with the QCL RS corresponding to the row indicated by the DCI (1804).
Method 2: when the UE is configured to reinterpret the existing MAC CE configuration through a new field of the DCI or a higher layer setting, the UE may expect that the active TCI of the PDSCH set by the MAC CE and the TCI of the CSI-RS of Set B are the same. That is, the QCL RS of the CSI-RS of Set B may be updated together when the active TCI of the PDSCH is updated by the MAC CE.
Method 3: the UE may update the TCI of the CSI-RS of Set B through the MAC CE. Specifically, referring to FIG. 19, octet fields of the MAC CE correspond respectively to the TCIs of CSI-RSs of the CSI-RS set configured as Set B (1901).
Method 4: the terminal may be configured with the QCL RS of the CSI-RS of Set B in advance in time order via RRC. As an embodiment, if the UE is configured with QCL RS in slot n and QCL RS in slot m (n<m), the UE may use QCL RS configured in slot n from slot n to slot m and update it to QCL RS configured in slot m from slot m.
Method 5: the QCL RS of Set B may be configured via a RRC parameter, and the UE may update the QCL RS of the CSI-RS of Set B through RRC reconfiguration.

Above-described method 1 has the advantage of being able to update the QCL RS of the CSI-RS of Set B together when updating the QCL of the PDSCH. Due to radio channel characteristics, when the QCL of the PDSCH is updated, the QCL of another downlink signal often also needs to be updated, so method 1 may have advantages in terms of overhead, delay, and simplicity of implementation. However, method 1 may be applied only when N=1, or in order to be applied to the case where N>1, the QCL of N CSI-RSs associated to the QCL of the PDSCH should be configured in advance through higher layer settings. Above-described method 2 has an advantage of being able to update together when the active TCI of the PDSCH is updated, similarly to method 1. Since the TCI of the PDSCH is likely to be selected as one of the active TCIs, the QCL RS of the CSI-RS may be updated together with the QCL RS of the active TCI, as in method 2. Method 2 has a constraint that the maximum value of N is 8. In addition, above-described methods 1 and 2 have the advantage of not requiring new L1/L2 signaling to update the QCL RS of the CSI-RS of Set B, while above-described method 3 requires a new MAC CE field dedicated to Set B. Above-described method 4 has the advantage of both not requiring L1/L2 signaling overhead for updating the QCL RS of the CSI-RS, and not requiring L1/L2 signaling overhead for updating the QCL RS of other signals including the PDSCH. However, it is suitable for a scenario where a high-performance beam prediction algorithm capable of predicting transmit beams across multiple slots is required, or a scenario where the UE is stationary or where the UE's movement path is predetermined like a train's CPE. Finally, above-described method 5 has the advantage of being able to utilize the existing CSI-RS QCL RS update as is, but requires overhead and delay for RRC reconfiguration. Methods 1 to 5 described above may be used alone or used together in various combinations.

### Third Embodiment: CSI Reporting Method of CSI-RS Set for Beam Measurement

Through the above-described first and second embodiments, the UE may receive an indication of the transmit beam of Set B from the base station and periodically report measurement data on the CSI-RS of Set B. Hence, the base station may utilize a high-performance beam prediction algorithm to select or predict the optimal beam that is in Set A and is not included in Set B on the basis of recent measurement data related to Set B, and may, when the transmit beam of Set B is changed according to the prediction result, effectively indicate the changed transmit beam to the UE. The optimal beam direction in the future time may be affected not only by the recent L1-RSRP, but also by changes in the position and velocity of the UE over time, changes in the receive beam direction due to the rotation of the UE, or changes in the cluster of radio channels. Therefore, it is necessary to support reporting on various CSI measurements in addition to existing L1-RSRP reporting of the CSI-RS. Various ways of CSI reporting are described in detail below.
Method 1: if the UE is configured to additionally report the RSRP via the higher layer, it may report assistance information of the RSRP through existing L1-RSRP. Various ways of assistance L1-RSRP reporting are described in detail below.
Method 1-1: the terminal may report the RSRP at a higher quantization level. Specifically, when reporting L1-RSRP for X.y dB, the UE may report X dB in the same way as existing L1-RSRP reporting without rounding up X.y dB, and may additionally report y dB. As an embodiment, the step size of y dB may be expected to be 0.1 dB.
Method 1-2: the UE may report the difference between the previously reported RSRP and the RSRP to be currently reported. The step size at the quantization level of the RSRP to be reported may be expected to be equal to or less than 1 dB. When method 1-2 is used alone, method 1-1 may be applied to the first report, and method 1-2 may be applied to the second and subsequent reports.
Method 2: the UE may report its velocity information as assistance information. As an embodiment, if higher layer parameter reportQuantity is set to ‘cri-RSRP-Doppler’, the UE may calculate and report the Doppler shift by using the CSI measurement value used in the previous CSI-RS report and the CSI measurement value to be reported currently. Various ways of reporting velocity assistance information are described in detail below.
Method 2-1: the UE quantizes the measured Doppler shift and reports the result.
Method 2-2: the UE calculates the difference between the measured Doppler shift and the Doppler shift measured in the previous report and reports the result. When method 2-2 is used alone, method 2-1 is applied to the first report, and method 2-2 may be applied to the second and subsequent reports.
Method 3: the UE can report, as assistance information, the direction information of the receive beam used to receive Set B. As an embodiment, higher layer parameter reportQuantity may be set to ‘cri-RSRP-RXangle’. Various ways of reporting receive beam direction information as assistance information are described in detail below.
Method 3-1: the UE quantizes receive beam direction information corresponding to cri and reports the result.
Method 3-2: the UE calculates the difference between the currently measured receive beam direction corresponding to cri and the previously measured receive beam direction corresponding to cri and reports the result. When method 3-2 is used alone, method 3-2 is applied to the first report, and method 3-2 may be applied to the second and subsequent reports.
Method 4: if the UE is configured with a PRS (positioning reference signal) for obtaining positioning information, it may report positioning information measured on the PRS together when reporting the CSI of Set B. As an embodiment, the reference signal time difference (RSTD) or the RX-TX time difference may be reported together. Above-described method 1 has the advantage that the UE may obtain high-resolution RSRP and thus report a RSRP resolution being higher than 1 dB to the base station. Above-described method 2 has the advantage that Doppler may be used not only for beam prediction algorithms, but also for future CSI prediction or Doppler-based Rel-18 codebooks. Above-described method 3 has the advantage of being able to help predict not only the transmit beam but also the information about the transmit/receive beam pairs. Above-described method 4 has the advantage of being able to reuse and apply existing NR positioning information, but has the disadvantage of having to additionally receive a PRB. Methods 1 to 4 described above may be used alone or used together in various combinations.

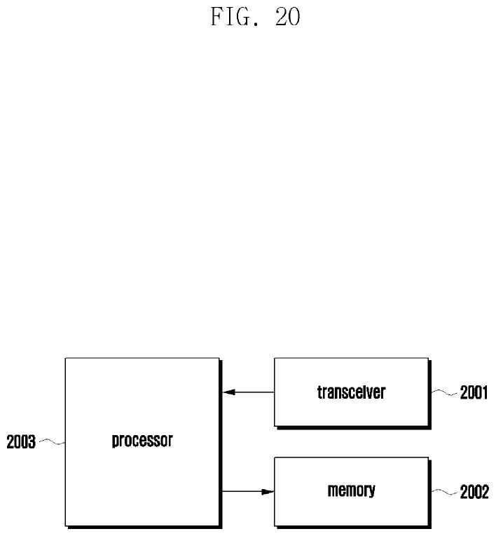

FIG. 20 is a block diagram illustrating the structure of a UE according to an embodiment of the disclosure.

With reference to FIG. 20, the UE may include a transceiver 2001, a memory 2002, and a processor 2003. However, the components of the UE are not limited to those described above. For example, the UE may include more or fewer components than the above-described components. Further, at least some or all of the transceiver 2001, the memory 2002, and the processor 2003 may be implemented in the form of a single chip. In an embodiment, the transceiver 2001 may transmit and receive signals to and from a base station. The signals may include control information, and data. To this end, the transceiver 2001 may be composed of an RF transmitter that up-converts the frequency of a signal to be transmitted and amplifies the signal, and an RF receiver that low-noise amplifies a received signal and down-converts the frequency thereof. Additionally, the transceiver 2001 may receive a signal through a radio channel and output it to the processor 2003, and transmit a signal output from the processor 2003 through a radio channel.

In an embodiment, the memory 2002 may store programs and data necessary for the operation of the UE. Additionally, the memory 2002 may store control information or data included in signals transmitted and received by the UE. The memory 2002 may be composed of a storage medium such as ROM, RAM, hard disk, CD-ROM, and DVD, or a combination of storage media. Additionally, the memory 2002 may be composed of a plurality of memories. According to an embodiment, the memory 2002 may store a program for executing a power saving operation of the UE.

In an embodiment, the processor 2003 may control a series of processes so that the UE can operate according to the above-described embodiments of the disclosure. In an embodiment, the processor 2003 may execute programs stored in the memory 2002 to thereby receive information such as CA configuration, bandwidth part configuration, SRS configuration, and PDCCH configuration from the base station, and control idle cell mode operations based on the configuration information.

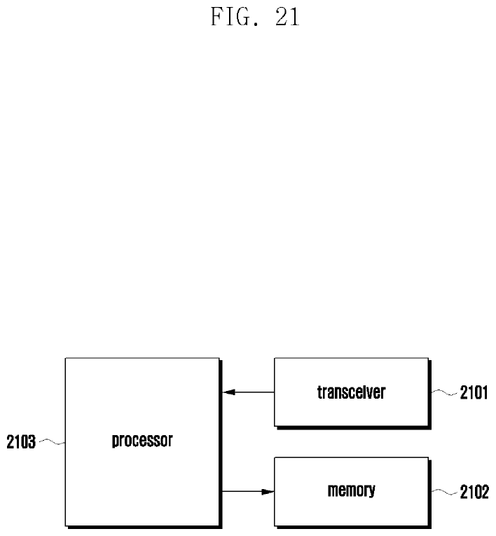

FIG. 21 is a block diagram illustrating the structure of a base station according to an embodiment of the disclosure.

With reference to FIG. 21, the base station may include a transceiver 2101, a memory 2102, and a processor 2103. However, the components of the base station are not limited to those described above. For example, the UE may include more or fewer components than the above-described components. Further, the transceiver 2101, the memory 2102, and the processor 2103 may be implemented in the form of a single chip.

In an embodiment, the transceiver 2101 may transmit and receive signals to and from a UE. The signals may include control information, and data. To this end, the transceiver 2101 may be composed of an RF transmitter that up-converts the frequency of a signal to be transmitted and amplifies the signal, and an RF receiver that low-noise amplifies a received signal and down-converts the frequency thereof. Additionally, the transceiver 2101 may receive a signal through a radio channel and output it to the processor 2103, and transmit a signal output from the processor 2103 through a radio channel.

In an embodiment, the memory 2102 may store programs and data necessary for the operation of the UE. Additionally, the memory 2102 may store control information or data included in signals transmitted and received by the UE. The memory 2102 may be composed of a storage medium such as ROM, RAM, hard disk, CD-ROM, and DVD, or a combination of storage media. Additionally, the memory 2102 may be composed of a plurality of memories. According to an embodiment, the memory 2102 may store a program for executing a power saving operation of the UE.

In an embodiment, the processor 2103 may control a series of processes so that the base station can operate according to the above-described embodiments of the disclosure. In an embodiment, the processor 2103 may execute programs stored in the memory 2102 to thereby transmit information such as CA configuration, bandwidth part configuration, SRS configuration, and PDCCH configuration to the UE, and control idle cell mode operations of the UE based on the configuration information.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or, such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that carries out an embodiment of the disclosure through an external port. In addition, a separate storage device on a communication network may access the device that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, the embodiments of the disclosure disclosed in the present specification and drawings are only provided as specific examples to easily explain the technical details of the disclosure and to aid understanding of the disclosure, and are not intended to limit the scope of the disclosure. That is, it will be apparent to those of ordinary skill in the art that other modifications based on the technical idea of the disclosure can be carried out. In addition, the individual embodiments may be combined with each other if necessary for operation. For example, some of the different embodiments of the disclosure may be combined with each other and applied to a base station and a terminal. Further, the embodiments of the disclosure can be applied to other communication systems, and other modifications based on the technical idea of the embodiments may also be carried out. For example, the embodiments can also be applied to LTE systems, or 5G or NR systems.

1. A method of a terminal in a communication system, the method comprising:
receiving periodic channel state information reference signal (CSI-RS) configuration information including IDs of N CSI-RSs from a base station;
determining a beam set for beam measurement and reporting as a first beam set based on the periodic CSI-RS configuration information;
receiving, from the base station, information indicating a change in at least a part of the beam set for beam measurement and reporting;
determining the beam set for beam measurement and reporting as a second beam set based on the information indicating a change in at least a part of the beam set; and
receiving a physical downlink shared channel (PDSCH) from the base station according to beam measurement and reporting based on the second beam set.

2. The method of claim 1, wherein:
the information indicating a change in at least a part of the beam set indicates IDs of N CSI-RSs associated with the second beam set; and
the IDs of N CSI-RSs associated with the second beam set correspond to IDs of N CSI-RSs indicated by downlink control information (DCI), IDs of N CSI-RSs indicated by a medium access control-control element (MAC CE), or IDs of N CSI-RSs that are configured through radio resource control (RRC) signaling and are triggered by DCI.

3. The method of claim 1, wherein:
the information indicating a change in at least a part of the beam set indicates a quasi-colocation reference signal (QCL RS) associated with at least one CSI-RS among the N CSI-RSs associated with the second beam set; and
the QCL RS associated with at least one CSI-RS corresponds to a QCL RS associated with a transmission configuration indication (TCI) state for a PDSCH indicated based on a TCI field of DCI, a QCL RS associated with a TCI state indicated based on a MAC CE, or a QCL RS configured based on RRC signaling.

4. The method of claim 3, wherein the QCL RS associated with at least one CSI-RS corresponds to a QCL RS associated with the at least one CSI-RS configured for each time period based on the RRC signaling.

5. The method of claim 1, further comprising transmitting CSI generated based on a CSI-RS associated with the second beam set to the base station, and wherein the CSI includes information on a difference value from a previously reported value.

6. A method of a base station in a communication system, the method comprising:
determining a beam set for beam measurement and reporting as a first beam set;
transmitting, to a terminal, periodic channel state information reference signal (CSI-RS) configuration information including IDs of N CSI-RSs associated with the first beam set;
determining the beam set for beam measurement and reporting as a second beam set;
transmitting, to the terminal, information indicating a change in at least a part of the beam set for beam measurement and reporting; and
transmitting a physical downlink shared channel (PDSCH) to the terminal according to beam measurement and reporting based on the second beam set.

7. The method of claim 6, wherein:
the information indicating a change in at least a part of the beam set indicates IDs of N CSI-RSs associated with the second beam set; and
the IDs of N CSI-RSs associated with the second beam set correspond to IDs of N CSI-RSs indicated by downlink control information (DCI), IDs of N CSI-RSs indicated by a medium access control-control element (MAC CE), or IDs of N CSI-RSs that are configured through radio resource control (RRC) signaling and are triggered by DCI.

8. The method of claim 6, wherein:
the information indicating a change in at least a part of the beam set indicates a quasi-colocation reference signal (QCL RS) associated with at least one CSI-RS among the N CSI-RSs associated with the second beam set; and
the QCL RS associated with at least one CSI-RS corresponds to a QCL RS associated with a transmission configuration indication (TCI) state for a PDSCH indicated based on a TCI field of DCI, a QCL RS associated with a TCI state indicated based on a MAC CE, or a QCL RS configured based on RRC signaling.

9. The method of claim 8, wherein the QCL RS associated with at least one CSI-RS corresponds to a QCL RS associated with the at least one CSI-RS configured for each time period based on the RRC signaling.

10. The method of claim 6, further comprising receiving CSI generated based on a CSI-RS associated with the second beam set from the terminal, and wherein the CSI includes information on a difference value from a previously reported value.

11. A terminal in a communication system, comprising:
a transceiver; and
a controller that is configured to:
receive periodic channel state information reference signal (CSI-RS) configuration information including IDs of N CSI-RSs from a base station;
determine a beam set for beam measurement and reporting as a first beam set based on the periodic CSI-RS configuration information;
receive, from the base station, information indicating a change in at least a part of the beam set for beam measurement and reporting;
determine the beam set for beam measurement and reporting as a second beam set based on the information indicating a change in at least a part of the beam set; and
receive a physical downlink shared channel (PDSCH) from the base station according to beam measurement and reporting based on the second beam set.

12. The terminal of claim 11, wherein:
the information indicating a change in at least a part of the beam set indicates IDs of N CSI-RSs associated with the second beam set; and
the IDs of N CSI-RSs associated with the second beam set correspond to IDs of N CSI-RSs indicated by downlink control information (DCI), IDs of N CSI-RSs indicated by a medium access control-control element (MAC CE), or IDs of N CSI-RSs that are configured through radio resource control (RRC) signaling and are triggered by DCI.

13. The terminal of claim 11, wherein:
the information indicating a change in at least a part of the beam set indicates a quasi-colocation reference signal (QCL RS) associated with at least one CSI-RS among the N CSI-RSs associated with the second beam set; and
the QCL RS associated with at least one CSI-RS corresponds to a QCL RS associated with a transmission configuration indication (TCI) state for a PDSCH indicated based on a TCI field of DCI, a QCL RS associated with a TCI state indicated based on a MAC CE, or a QCL RS configured based on RRC signaling.

14. The terminal of claim 13, wherein the QCL RS associated with at least one CSI-RS corresponds to a QCL RS associated with the at least one CSI-RS configured for each time period based on the RRC signaling.

15. A base station in a communication system, comprising:
a transceiver; and
a controller that is configured to:
determine a beam set for beam measurement and reporting as a first beam set;
transmit, to a terminal, periodic channel state information reference signal (CSI-RS) configuration information including IDs of N CSI-RSs associated with the first beam set;
determine the beam set for beam measurement and reporting as a second beam set;
transmit, to the terminal, information indicating a change in at least a part of the beam set for beam measurement and reporting; and
transmit a physical downlink shared channel (PDSCH) to the terminal according to beam measurement and reporting based on the second beam set.
